(19) United States
(12) Patent Application Publication
(10) Pub. No.: US 2010/0151789 A1
(43) Pub. Date: Jun. 17, 2010

(54) COMMUNICATION SYSTEM, WIRELESS COMMUNICATION TERMINAL DEVICE, POSITION ESTIMATION DEVICE, COMMUNICATION RELAY DEVICE AND CONNECTING STATION

(75) Inventors: Yoshihiro Suzuki, Tokyo (JP); Tetsuya Kawakami, Kanagawa (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/601,080

(22) PCT Filed: May 30, 2008
(86) PCT No.: PCT/JP2008/001378

§ 371 Date: Nov. 20, 2009

(30) Foreign Application Priority Data
Jun. 1, 2007 (JP) 2007-147283
Aug. 3, 2007 (JP) 2007-202544
Oct. 22, 2007 (JP) 2007-274158

(51) Int. Cl. H04B 7/00

(52) U.S. Cl. 455/41.2

(57) ABSTRACT

The present invention discloses a technique, according to which estimation of a position of a mobile wireless device can be accomplished in a simple system configuration by using short distance communication functions. A plurality of standard stations 110 and a plurality of connecting stations 120 are installed within a predetermined area. A mobile wireless device moving within the predetermined area has short distance wireless communication functions and receives a device ID of an opponent device (a correspondent device) each time it intersects another mobile wireless device or a standard station, and stores the device ID as an intersecting history data. When the mobile wireless device moves to a position where it can perform communication to and from a connecting station, which can make access to a position estimation device 150, the stored intersecting history data is uploaded to the position estimation device. The intersecting history data as uploaded from the mobile wireless device is stored in an intersecting history database 155. The position estimation device identifies positions of installation of all standard stations, and it estimates a moving route of the mobile communication device (for which the position is to be estimated) according to the intersecting history data directly uploaded from the mobile wireless device (for which the position is to be estimated) and a moving route of the mobile wireless device (for which the position is to be estimated) is estimated according to the intersecting history with the mobile wireless device (for which the position is to be estimated) as included in the intersecting history data of another mobile wireless device.

### TECHNICAL FIELD

The present invention relates to a communication system, a wireless communication terminal, and a position estimation device for estimating a position of a wireless communication terminal (a mobile wireless device) having functions to perform wireless communication. The invention also relates to a communication system, a wireless communication terminal, a communication relay device, and connecting stations having functions to perform wireless communication. In particular, the invention relates to a communication system, a wireless communication terminal, and a position estimation device for estimating a position of a short distance wireless device having functions to perform short distance wireless communication, and the invention also relates to a communication system, a wireless communication terminal, a communication relay device, and connecting stations, which form an ad hoc network where a short distance wireless device having functions for short distance wireless communication make up together an ad hoc network.

### BACKGROUND ART

At present, a method for specifying a position of a wireless communication terminal is known, according to which the position can be calculated by receiving GPS (Global Positioning System) signals via the wireless communication terminal, for instance.

On the other hand, in the Patent Document 1 as given below, for instance, a position estimation method is disclosed, according to which a position where a weighted position of a PHS (Personal Handyphone System) terminal is currently located is calculated by using the method of three-point surveying on the intensity of electric waves (electric field strength) received from a plurality of PHS base stations, and the calculated weighted position is estimated as a position where the PHS terminal is located at present.

The position estimation method as disclosed in the Patent Document 1 can also be applied to other wireless communication technique such as a wireless LAN (Local Area Network). In this case, the PHS terminal corresponds to a slave device (a slave set) of the wireless LAN, and the PHS base station corresponds to a master device (access point) of the wireless LAN.

Now, referring to FIG. 32, description will be given on the position estimation method based on a technique of three-point surveying in the prior art. FIG. 32 schematically shows a basic principle, which is used in the position estimation method in the prior art.

In the position estimation method using the technique of three-point surveying in the prior art, when a wireless communication terminal (for which the position is to be estimated) can receive electric waves from a plurality of base stations, and the position of the wireless communication terminal can be calculated from a position of each base station from field strength of electric waves received from each of the base stations and also from a position of each base station.

Specifically, in FIG. 32, a mobile terminal, which is located at a position where electric waves can be received from a plurality of base stations (e.g. three base stations 9001 to 9003), can calculate a position P0 of a mobile terminal 9000 by using positions P1 to P3 of the base stations 9001 to 9003 respectively. In this case, by using the equation as given below, for instance, it is possible to calculate the position P0 of the mobile terminal 9000:

P0=Σkj×Pj/Σkj

where the symbol “j” represents each of the base stations, and the symbol Σ denotes a sum of the base stations j.

Further, in the Patent Document 2 as given below, a technique is disclosed, which is used for controlling a position of each object or item at construction site by using IC (Integrated Circuit). According to this technique, an IC tag (fixed tag) is attached to a plurality of fixed positions at the construction site, and an IC tag (movable tag) is attached to each item or object, which is to be carried to the construction site. Also, each operator carries an IC tag reader terminal, which has the function to read identification information (tag ID) of the IC tag when the operator approaches to the IC tag. As a result, when the operator moves, the tag ID of the fixed tag or the movable tag is read by the IC tag reader terminal at the destination of moving. By sequentially uploading the result on a position information database, information of the tag IDs, i.e. the types of information on the fixed tag and the movable tag as read by the IC tag reader terminal are stored, and the position of the movable tag is calculated according to the tag ID of the fixed tag.

Currently, by using a short distance wireless device having a function to perform short distance wireless communication with other communication device, which is beyond the communicable range of its own capacity, a method is known for setting up an ad hoc communication route by forming an ad hoc network by a plurality of short distance wireless devices. According to this method, for instance, searching is made on a group of short distance wireless devices, which are distributed from the short distance wireless device of data transmission source to the short distance wireless device of data transmission destination. Then a series of “pairs of short distance wireless devices, being able to directly perform communication” are searched, which can mediate communication from the short distance wireless device of data transmission source to the short distance wireless device of data transmission destination.

On the other hand, in the Patent Document 3 as given below, a technique is disclosed, according to which a mobile wireless device located on an ad hoc network can estimate a position of wireless devices in the surrounding by specifying electric waves and can calculate an efficient communication route from the short distance wireless device of data transmission source to the short distance wireless device of data transmission destination.

[Patent Document 1] Japanese Patent Application Publication No. JP-A-10-239416

[Patent Document 2] Japanese Patent Application Publication No. JP-A-2005-314886

[Patent Document 3] Japanese Patent Application Publication No. JP-A-2005-76969

However, in the position estimation method using the technique of three-point surveying as described above, the wireless communication terminal (for which the position is to be estimated) must be at a position within a communication range (cell) of a plurality of base stations (or master devices). Further, the wireless communication terminal (for which the position is to be estimated) must have knowledge or must be able to identify positions of these base stations. Specifically, the position can be estimated only in case where there are a plurality of base stations, whose positions are already known to the wireless communication terminal (for which the position is to be estimated), and also only in case where the wireless communication terminal is located at a place where it can receive electric waves from these base stations at the same time. Otherwise, the position estimation cannot be accomplished.

When the wireless communication technique such as PHS is used, which can perform communication in wide area, there is a problem that error is increased in position estimation accuracy when the technique of three-point surveying is applied. Also, in case the wireless communication technique such as the wireless LAN is used, by which communication can be performed for short distance, master devices of the wireless LAN, for which the positions are already known, must be installed densely in order to cover the wide area.

The position estimation method in the prior art is to estimate the present position of the wireless communication terminal based on the current condition of a certain wireless communication terminal. Therefore, according to the position estimation method in the prior art, it is difficult to estimate the present position of a wireless communication terminal, which cannot perform communication at current moment. This also applies to the case where the wireless communication terminal has GPS function.

Also, when GPS is used, there is a problem in that the position cannot be specified at a place where GPS signals from GPS satellite cannot be received, e.g. in case of indoor operation. Further, the position identified by GPS is two-dimensional coordinates such as latitude and longitude, and there is also a problem in that it is difficult to identify at which height (i.e. at which storey of a building) the wireless communication terminal is located on the same latitude and the longitude.

When the technique disclosed in the Patent Document 2 is used, the operator must move by carrying the IC tag reader terminal provided with a wide area wireless device for uploading the tag ID to a position information database. Also, a multiple number of IC tag reader terminals must be used (i.e. a multiple number of operators, who carry these IC tag reader terminals, must be assigned). That is, according to the technique as disclosed in the Patent Document 2, the IC tag reader terminals provided with wide area wireless devices must be used, and many operators are needed, who carry these IC tag reader terminals. With the increase of the number of the IC tag reader terminals and the number of operators who carry the reader terminals, the system to be constructed must be extended to a larger scale, and this causes a problem that the cost required for the system is extensively increased.

In the prior art, when a distance from a short distance wireless device of data transmission source to the short distance wireless device of data transmission destination is very long in comparison with the communication range of each short distance wireless device, even when pairs of the short distance wireless devices are connected, a route cannot necessarily be set up from the short distance wireless device of data transmission source to the short distance wireless device of data transmission destination. In particular, in case a distance from the short distance wireless device of data transmission source to the short distance wireless device of data transmission destination is very long, there is no communication route via the ad hoc network in some cases. In such case, a problem may arise that data transmission cannot be carried out from the short distance wireless device of data transmission source to the short distance wireless device of data transmission destination.

### DISCLOSURE OF THE INVENTION

To overcome the above problems, it is an object of the present invention to provide a communication system, a wireless communication terminal, and a position estimation device, by which it is possible to accomplish position estimation by simple system configuration with short distance communication functions. Also, it is another object of the invention to provide a communication system, a wireless communication terminal, a communication relay device, and a connecting station, by which it is possible to improve the reliability of communication using short distance communication function by mobile wireless devices (wireless communication terminals) located on a wide area network.

To attain the above object, the present invention provides a communication system, provided with position estimation function to estimate a position of a wireless communication terminal according to history of receiving of information as transmitted from the wireless communication terminal having short distance wireless communication function while moving in a predetermined area.

By the arrangement as described above, it is possible to accomplish position estimation by a simple system configuration using short distance communication functions, and also to improve the reliability of communication using short distance communication functions by mobile wireless devices (wireless communication terminals) located on a wide area network.

Also, in addition to the arrangement as described above, the present invention provides the communication system as described above, wherein said communication system comprises a plurality of wireless communication terminals moving in said predetermined area, a plurality of standard stations fixedly installed within said predetermined area, connecting stations located within said predetermined area and connected to a predetermined network, and a position estimation device connected to said predetermined network, wherein said wireless communication terminal comprises:

short distance wireless communication means for performing communication with another wireless communication terminal located in the vicinity, and with said standard stations and said connecting stations;

device identification information storage means for storing device identification information specific to each wireless communication terminal;

device identification information transmitting means for transmitting said device identification information of own terminal to said another wireless communication terminal in case communication can be performed with said another wireless communication terminal via said short distance wireless communication means;

device identification information receiving means for receiving said device identification information of said another wireless communication terminal or said standard station from said another wireless communication terminal in case communication can be performed to and from said another wireless communication terminal or said standard station via said short distance wireless communication means;

timing means for outputting the current time information;

intersecting history data memorizing means for memorizing said device identification information of said another wireless communication terminal or said standard station as received by said device identification information receiving means by associating with said time information as outputted from said timing means as an intersecting history data; and

intersecting history data transmitting means for transmitting said intersecting history data to said position estimation device via said connecting station and said predetermined network in case it is possible to communicate with said connecting station via said short distance wireless communication means;

said standard station comprises:

short distance wireless communication means for performing communication to and from said wireless communication terminal located in the vicinity;

device identification information storage means for storing device identification information specific to each standard station; and

device identification information transmitting means for transmitting said device identification information of own station to said wireless communication terminal in case it is possible to perform communication to and from said wireless communication terminal via said short distance wireless communication means;

said connecting station comprises:

short distance wireless communication means for performing communication to and form said wireless communication terminal located in the vicinity;

a network interface connected to said predetermined network; and

intersecting history data transfer means for transferring said intersecting history data, received from said wireless communication terminal via said short distance wireless communication means, to said position estimation device via said network interface;

said position estimation device comprises:

a network interface connected to said predetermined network;

standard station position information storage means for storing standard station position information to indicate a position of installation of each of said standard stations;

intersecting history data receiving means for receiving said intersecting history data as transmitted from said wireless communication terminal via said network interface;

an intersecting history database for storing said intersecting history data received from each of a plurality of said wireless communication terminals; and

position estimation processing means for estimating position of any of said wireless communication terminal at an arbitrary time by using said intersecting history data stored in said intersecting history database.

With the arrangement as described above, it is possible to carry out position estimation with high accuracy by simple system configuration using short distance communication functions.

Further, in addition to the arrangement as described above, the present invention provides a communication system as described above, wherein said communication system comprises a plurality of wireless communication terminals moving in said predetermined area, a plurality of standard stations fixedly installed within said predetermined area, connecting stations located within said predetermined area and connected to a predetermined network, and a position estimation device connected to said predetermined network, wherein said wireless communication terminal comprises:

short distance wireless communication means for performing communication with another wireless communication terminal located in the vicinity, and with said standard stations and said connecting stations;

device identification information storage means for storing device identification information specific to each wireless communication terminal;

device identification information transmitting means for transmitting said device identification information of own terminal to said another wireless communication terminal in case communication can be performed with said another wireless communication terminal via said short distance wireless communication means;

device identification information receiving means for receiving said device identification information of said another wireless communication terminal or said standard station from said another wireless communication terminal in case communication can be performed to and from said another wireless communication terminal or said standard station via said short distance wireless communication means;

timing means for outputting the current time information;

moving distance information output means for outputting moving distance information to represent a distance of moving of own terminal;

intersecting history data memorizing means for memorizing said device identification information of said another wireless communication terminal or said standard station as received by said device identification information receiving means, by associating said device identification information with said moving distance information as outputted from said moving distance information output means and with said timing information as outputted from said timing means as an intersecting history data;

intersecting history data transmitting means for transmitting said intersecting history data to said position estimation device via said connecting station and said predetermined network in case it is possible to communicate with said connecting station via said short distance wireless communication means;

said standard station comprises:

short distance wireless communication means for performing communication to and from said wireless communication terminal located in the vicinity;

device identification information storage means for storing device identification information specific to each standard station; and

device identification information transmitting means for transmitting said device identification information of own station in case it is possible to perform communication to and from said wireless communication terminal via said short distance wireless communication means;

said connecting station comprises:

short distance wireless communication means for performing communication to and form said wireless communication terminal located in the vicinity;

a network interface connected to said predetermined network; and

intersecting history data transfer means for transferring said intersecting history data, received from said wireless communication terminal via said short distance wireless communication means, to said position estimation device via said network interface;

said position estimation device comprises:

a network interface connected to said predetermined network;

standard station position information storage means for storing standard station position information to indicate a position of installation of each of said standard stations;

intersecting history data receiving means for receiving said intersecting history data as transmitted from said wireless communication terminal via said network interface;

an intersecting history database for storing said intersecting history data received from each of a plurality of said wireless communication terminals; and

position estimation processing means for estimating position of any of said wireless communication terminal at an arbitrary time by using said intersecting history data stored in said intersecting history database.

With the arrangement as described above, it is possible to carry out position estimation with high accuracy by simple system configuration using short distance communication functions.

Also, in addition to the arrangement as described above, the present invention provides a communication system as described above, wherein said communication system comprises a plurality of said wireless communication terminals moving within said predetermined area, a plurality of standard stations fixedly installed within said predetermined area, wherein said wireless communication terminal comprises:

short distance wireless communication means for performing communication with another wireless communication terminal located in the vicinity and with said standard station;

standard station information receiving means for receiving position specifying information for specifying a position of said standard station from said standard station in case communication can be performed with said standard station via said short distance wireless communication means;

timing means for outputting the current time information;

intersecting history data memorizing means for memorizing an intersecting history data obtained by associating said position specifying information received at the standard station information received means with said timing information outputted from said timing means;

intersecting history data exchange means for transmitting said intersecting history data memorized in said intersecting history data memorizing means to said another wireless communication terminal and for receiving said intersecting history data of said another wireless communication terminal from said another wireless communication terminal; and

position estimation processing means for estimating a position where communication was performed with said another wireless communication terminal via said short distance wireless communication means by using said intersecting history data memorized in said intersecting history data memorizing means, said intersecting history data of said another wireless communication terminal received from said another wireless communication terminal, and the current time information as outputted from said timing means;

said standard station comprises:

short distance wireless communication means for performing communication with said wireless communication terminal located in the vicinity;

position specifying information storage means for storing position specifying information to specify a position of said standard station; and

position specifying information transmitting means for transmitting said position specifying information stored in said position specifying information storage means to said wireless communication terminal in case communication can be performed to and from said wireless communication terminal via said short distance wireless communication means.

With the arrangement as described above, it is possible to estimate a position where the wireless communication terminals intersect each other by simple system configuration using short distance communication functions.

Further, in addition to the arrangement as described above, the present invention provides the communication system as described above, wherein said communication system comprises a plurality of said wireless communication terminals moving within said predetermined area, a plurality of standard stations fixedly installed within said predetermined area, said wireless communication terminal comprises:

short distance wireless communication means for performing communication with another wireless communication terminal located in the vicinity and with said standard station;

standard station information receiving means for receiving position specifying information for specifying a position of said standard station from said standard station in case communication can be performed with said standard station via said short distance wireless communication means;

moving distance information output means for outputting moving distance information to give a moving distance of own terminal;

intersecting history data memorizing means for memorizing an intersecting history data obtained by associating said position specifying information as received by said standard station information receiving means with said moving distance information outputted from said moving distance information output means;

difference calculating means for calculating a difference between moving distance information at the current time moment as outputted from said moving distance information output means and said moving distance information of said intersecting history data as memorized in said intersecting history data memorizing means in case communication can be made with said another wireless communication terminal via said short distance wireless communication means by coming close to said another wireless communication terminal;

intersecting history data exchange means for transmitting said position specifying information of said intersecting history data as memorized in said intersecting history data memorizing means and said difference information calculated by said difference calculating means, and for receiving position specifying information of said another wireless communication terminal and the difference information from said another wireless communication terminal; and

position estimation processing means for estimating a position where communication has been performed to and from said another wireless communication terminal via said short distance wireless communication means by using said position specifying information of said intersecting history data memorized in said intersecting history data memorizing means and said difference information calculated by said difference calculating means, position specifying information and difference information of intersecting history data of said another wireless communication terminal as received from said another wireless communication terminal, and current moving distance information as outputted from said moving distance information output means;

said standard station comprises:

short distance wireless communication means for performing communication with said wireless communication terminal located in the vicinity;

position specifying information storage means for storing position specifying information to specify a position of said standard station; and

position specifying information transmitting means for transmitting said position specifying information stored in said position specifying information storage means to said wireless communication terminal in case communication can be performed to and from said wireless communication terminal via said short distance wireless communication means.

With the arrangement as described above, it is possible to estimate a position where the wireless communication terminals intersect each other by simple system configuration using short distance communication functions.

Also, the present invention provides a communication system as described above, wherein said communication system comprises a plurality of said wireless communication terminals moving within said predetermined area, a plurality of connecting stations located within said predetermined area and connected to a predetermined network, a communication relay device connected to said predetermined network, and a position estimation device connected to said predetermined network, wherein:

a wireless communication terminal of data transmission source to transmit a data packet to a wireless communication terminal of data transmission destination comprises:

short distance wireless communication means for performing communication to and from another wireless communication terminal and said connecting station located in the vicinity;

device identification information storage means for storing device identification information specific to each wireless communication terminal;

communication correspondent identification information storage means for storing device identification information of said wireless communication terminal of data transmission destination;

data packet generating means for generating said data packet to be sent to the wireless communication terminal of data transmission destination, and for adding the device identification information wireless communication terminal of data transmission destination to said data packet; and

data packet transmitting means for transmitting said data packet generated by said data packet generating means to said connecting station or said another wireless communication terminal, with which communication can be performed via said short distance wireless communication means;

a wireless communication terminal receiving said data packet from said wireless communication terminal of data transmission destination comprises:

short distance wireless communication means for performing communication to and from another wireless communication terminal and said connecting station located in the vicinity;

data packet holding means for temporarily holding said data packet; and

data packet transmitting means for transmitting said data packet as held by said data packet holding means to said connecting station in case communication can be performed to and from said connecting station via said short distance wireless communication means;

a connecting station receiving said data packet from said wireless communication terminal comprises:

short distance wireless communication means for performing communication to and from said wireless communication terminal located in the vicinity;

a network interface connected to said predetermined network; and

data packet transfer means for transferring said data packet received via said short distance wireless communication means to said communication relay device via said network interface;

said communication relay device comprises:

a network interface connected to said predetermined network;

device identification information extracting means for extracting device identification information of said wireless communication terminal of data transmission destination added to said data packet received from said connecting station;

position inquiring means for making inquiry on a position of said wireless communication terminal of data transmission destination by delivering the device identification information of said wireless communication terminal of data transmission destination to said position estimation device capable to estimate a position of a wireless communication terminal located within said predetermined area;

position estimation result receiving means for receiving estimation result of the current position of said wireless communication terminal of data transmission destination from said position management device as a response to said position inquiry by said position inquiring means; and

data packet transmitting means for transmitting said data packet to a connecting station estimated as located in the vicinity of said wireless communication terminal of data transmission destination as specified according to the result of position estimation on the current position of said wireless communication terminal of data transmission destination;

said position estimation device comprises:

information storage unit for holding information to estimate position information of each wireless communication terminal;

estimation means for estimating the current position of said wireless communication terminal of data transmission destination according to the information in said information storage unit in response to an inquiry of a position of said wireless communication terminal of data transmission destination from said communication relay device; and

position estimation result transmitting means for transmitting estimation result of the current position of said wireless communication terminal of data transmission destination to said communication relay device by said estimating means;

a connecting station receiving said data packet from said communication relay device comprises:

short distance wireless communication means for performing communication to and from said wireless communication terminal located in the vicinity;

a network interface connected to said predetermined network;

data packet transmitting means for transmitting said data packet received via said network interface to said wireless communication terminal capable to communicate via said short distance wireless communication means or to said wireless communication terminal of data transmission destination; and

a wireless communication terminal receiving said data packet from said connecting station comprises:

short distance wireless communication means for performing communication to and from another wireless communication terminal and said connecting station located in the vicinity;

data packet holding means for temporarily holding said data packet; and

data packet transmitting means for transmitting said data packet as held by said data packet holding means to said wireless communication terminal of data transmission destination in case communication can be made to and from said wireless communication terminal of data transmission destination via said short distance wireless communication means.

With the arrangement as described above, it is possible to improve the reliability of communication using short distance communication functions by mobile wireless device (wireless communication terminals) located on the wide area network.

Further, in addition to the arrangement as described above, the present invention provides the communication system as described above, wherein said wireless communication terminal of data transmission source comprises:

data packet copying means for copying said data packet generated by said data packet generating means and for preparing a plurality of data packets; and

transmission control means for controlling so that said plurality of data packets copied by said data packet copying means are transmitted to each of said different connecting stations or to said another wireless communication terminal in said data packet transmitting means.

With the above arrangement, the wireless communication terminal of data transmission source can transmit a plurality of the same packets to increase the reachability of the packets. This arrangement is effective in the situation where a network from the wireless communication terminal of data transmission source to the connecting station is in unstable condition.

Also, in addition to the arrangement as described above, the present invention provides a communication system as described above, wherein said communication relay device comprises:

data packet copying means for copying said data packet received from said connecting station and for preparing a plurality of data packets; and

transmission control means for controlling so that said plurality of data packets copied by the data packet copying means are transmitted to each of said different connecting stations in said data packet transmitting means.

With the arrangement as described above, the communication relay device can transfer a plurality of the same packets in order to improve the reachability of the packet. In particular, this arrangement is effective when it is not definitely known under which of the connecting stations the wireless communication terminal of data transmission destination is controlled.

Further, in addition to the arrangement as described above, the present invention provides a communication system as described above, wherein said connecting station receiving said data packet from said communication relay device comprises:

data packet copying means for copying said data packet received from said communication relay device and for preparing a plurality of data packets; and

transmission control means for controlling so that said plurality of data packets copied by said data packet copying means are transmitted to each of said another wireless communication terminal in said data packet transmitting means.

With the arrangement as described above, it is possible that the connecting station can transfer a plurality of the same packets in order to increase the reachability of the packets. This arrangement is effective when there is high possibility that the wireless communication terminal of data transmission destination is located in the vicinity of a specific connecting station.

Also, to attain the above object, the present invention provides a wireless communication terminal moving within a predetermined area, wherein said wireless communication terminal comprises:

short distance wireless communication means for performing communication with another wireless communication terminal located in the vicinity, with a standard station fixedly installed within said predetermined area, and with a connecting station located within said predetermined area and connected to said predetermined network;

device identification information storage means for storing device identification information specific to each wireless communication terminal;

device identification information transmitting means for transmitting said device identification information of own terminal to said another wireless communication terminal in case communication can be performed with said another wireless communication terminal via said short distance wireless communication means;

device identification information receiving means for receiving said device identification information of said another wireless communication terminal or said standard station from said another wireless communication terminal in case communication can be performed with said another wireless communication terminal or said standard station via said short distance wireless communication means;

timing means for outputting the current time information;

intersecting history data memorizing means for memorizing an intersecting history data obtained by associating said device identification information of said another wireless communication terminal or said standard station as received via the device identification information receiving means with said time information as outputted from said timing means; and

intersecting history data transmitting means for transmitting said intersecting history data to said position estimation device via said connecting station and via said predetermined network in case communication can be performed with said connecting station via said short distance wireless communication means.

With the arrangement as described above, it is possible to carry out position estimation with high accuracy by simple system configuration using short distance communication functions.

Further, to attain the above object, the present invention provides a wireless communication terminal moving within a predetermined area, wherein said wireless communication terminal comprises:

short distance wireless communication means for performing communication with another wireless communication terminal located in the vicinity, with a standard station fixedly installed within said predetermined area, and with a connecting station located within said predetermined area and connected to said predetermined network;

device identification information storage means for storing device identification information specific to each wireless communication terminal;

device identification information transmitting means for transmitting said device identification information of own terminal to said another wireless communication terminal in case communication can be performed with said another wireless communication terminal via said short distance wireless communication means;

device identification information receiving means for receiving said device identification information of said another wireless communication terminal or said standard station from said another wireless communication terminal in case communication can be performed with said another wireless communication terminal or said standard station via said short distance wireless communication means;

timing means for outputting the current time information;

moving distance information output means for outputting moving distance information to give a moving distance of own terminal;

intersecting history data memorizing means for memorizing an intersecting history data obtained by associating said device identification information of said another wireless communication terminal or said standard station as received via said device identification information receiving means with said timing information outputted from said moving distance information output means, and

intersecting history data transmitting means for transmitting said intersecting history data to said position estimation device via said connecting station and via said predetermined network in case communication can be performed with said connecting station via said short distance wireless communication means.

With the arrangement as described above, it is possible to carry out position estimation with high accuracy by simple system configuration using short distance communication functions.

Also, to attain the above object, the present invention provides a wireless communication terminal moving within a predetermined area, wherein said wireless communication terminal comprises:

short distance wireless communication means for performing communication to and from another wireless communication terminal located in the vicinity and said standard station fixedly installed within said predetermined area;

standard station information receiving means for receiving position specifying information for specifying a position of said standard station in case communication can be performed with said standard station via said short distance wireless communication means;

timing means for outputting the current time information;

intersecting history data memorizing means for memorizing said information specifying information received via said standard station information receiving means by associating with said time information as outputted from said timing information;

intersecting history data exchange means for transmitting said intersecting history data memorized in said intersecting history data memorizing means to said another wireless communication terminal and for receiving intersecting history data of said another wireless communication terminal from said another wireless communication terminal when it comes close to said another wireless communication terminal and in case communication can be performed with said another wireless communication terminal via said short distance wireless communication means; and

position estimation processing means for estimating a position where communication was performed with said another wireless communication terminal via said short distance wireless communication means by using said intersecting history data memorized in the intersecting history data memorizing means, said intersecting history data of said another wireless communication terminal received from said another wireless communication terminal, and the current time information as outputted from said timing means.

With the arrangement as described above, it is possible to estimate a position where the wireless communication terminals intersect each other by simple system configuration using short distance communication functions.

Further, in addition to the arrangement as described above, the present invention provides the wireless communication terminal as described above, wherein:

said position estimation processing means extracts position specifying information and a passing time of the standard station close nearby where said wireless communication terminal has passed from said intersecting history data memorized in said intersecting history data memorizing means, extracts position specifying information and its passing time of the standard station close nearby where said another wireless communication terminal has passed from said intersecting history data of said another wireless communication terminal, and by using a difference for each of said extracted two values of the passing time to the current time information, for approximately calculating a distance from two standard stations close nearby where each of said wireless communication terminal and said another wireless communication terminal have passed by.

With the arrangement as described above, it is possible to estimate a position where the wireless communication terminals intersect each other by simple system configuration using short distance communication functions.

Further, to attain the above object, the present invention provides a wireless communication terminal moving within a predetermined area, wherein said wireless communication terminal comprises:

short distance wireless communication means for performing communication with another wireless communication terminal located in the vicinity and with a standard station fixedly installed within said predetermined area;

standard station information receiving means for receiving position specifying information for specifying a position of said standard station in case communication can be performed to and from said standard station via said short distance wireless communication means;

moving distance information output means for outputting moving distance information to give a moving distance of own terminal;

intersecting history data memorizing means for memorizing said position specifying information received via the standard station information receiving means by associating with said moving distance information as outputted from said moving distance information output means;

difference calculating means for calculating a difference between a moving distance information at the present time point as outputted from said moving distance information output means and said moving distance information of said intersecting history data memorized in said intersecting history data memorizing means in case it comes close to said another wireless communication terminal and communication can be performed to and from said another wireless communication terminal via said short distance wireless communication means;

intersecting history data exchange means for transmitting said position specifying information of said intersecting history data memorized in said intersecting history data memorizing means and said difference information calculated by said difference calculating means to said another wireless communication terminal, and for receiving position specifying information of intersecting history of said another wireless communication terminal and difference information from said another wireless communication terminal; and

position estimation processing means for estimating a position where communication has been performed with said another wireless communication terminal via said short distance wireless communication means by using said position specifying information of said intersecting history data memorized by the intersecting history data memorizing means, by using position specifying information and difference information of intersecting history data of said another wireless communication terminal received from said another wireless communication terminal, and by using the current moving distance information as outputted from said moving distance information output means.

With the arrangement as described above, it is possible to estimate a position where the wireless communication terminals intersect each other by simple system configuration using short distance communication functions.

Also, in addition to the arrangement as described above, the present invention provides the wireless communication terminal as described above, wherein a position where communication was performed with said another wireless communication terminal via said short distance wireless communication means is estimated by using said difference information calculated by said difference calculating means and said difference information received from said another wireless communication terminal, and approximately calculating distances from two nearby standard stations where said wireless communication terminal and said another wireless communication terminal have passed by.

With the arrangement as described above, it is possible to estimate a position where the wireless communication terminals intersect each other by simple system configuration using short distance communication functions.

Further, the present invention provides a wireless communication terminal of data transmission source for transmitting a data packet to a wireless communication terminal of data transmission destination in a communication system, which comprises a wireless communication terminal moving within a predetermined area, a plurality of connecting stations located within said predetermined area and connected to a predetermined network, a communication relay device connected to said predetermined network, and a position estimation device connected to said predetermined network, wherein said wireless communication comprises:

short distance communication means for performing communication to and from another wireless communication terminal and to and from said connecting station located in the vicinity;

device identification information storage means for storing device identification information specific to each wireless communication terminal;

correspondent identification information storage means for storing device identification information of said wireless communication terminal device identification information of said wireless communication terminal of data transmission destination;

data packet generating means for generating said data packet to be transmitted to said wireless communication terminal of data transmission destination, and for adding device identification information of said wireless communication terminal of data transmission destination to said data packet; and

data packet transmitting means for transmitting said data packet generated by said data packet generating means to said connecting station or to said another wireless communication terminal communicable via said short distance wireless communication means.

With the arrangement as described above, it is possible to improve the reliability of communication using short distance communication functions by mobile wireless device (wireless communication terminals) located on the wide area network.

Also, in addition to the arrangement as described above, the present invention provides a communication system as described above, wherein said wireless communication terminal comprises:

data packet copying means for copying said data packet generated by said data packet generating means and for preparing a plurality of data packet; and

transmission control means for controlling so that said plurality of data packets copied by said data packet copying means are transmitted to each of difference connecting stations or to said another wireless communication terminal in said data packet transmitting means.

With the above arrangement, the wireless communication terminal of data transmission source can transmit a plurality of the same packets to increase the reachability of the packets. This arrangement is effective in the situation where a network from the wireless communication terminal of data transmission source to the connecting station is in unstable condition.

Further, to attain the above object, the present invention provides a wireless communication terminal receiving a data packet from a wireless communication terminal of data transmission source to transmit the data packet to a wireless communication terminal for data transmission destination in a communication system, which comprises a wireless communication terminal moving within a predetermined area, a plurality of connecting stations located within said predetermined area and connected to a predetermined network, a communication relay device connected to said predetermined network, and a position estimation device connected to said predetermined network, wherein said wireless communication terminal comprises:

short distance wireless communication means for performing communication to and from another wireless communication terminal and said connecting station located in the vicinity;

data packet holding means for temporarily holding said data packet; and

data packet transmitting means for transmitting said data packet held by said data packet holding means to said connecting station in case communication can be performed to and from said connecting means via said short distance wireless communication means.

With the arrangement as described above, it is possible to improve the reliability of communication, in which short distance communication functions are fulfilled by a mobile wireless device (a wireless communication terminal) on an ad hoc network.

Also, to attain the above object, the present invention provides a wireless communication terminal receiving a data packet transmitted from a wireless communication terminal of data transmission source to a wireless communication terminal of data transmission destination in a communication system, which comprises a wireless communication terminal moving within a predetermined area, a plurality of connecting stations located within said predetermined area and connected to a predetermined network, a communication relay device connected to said predetermined network, and a position estimation device connected to said predetermined network, wherein said wireless communication terminal comprises:

short distance wireless communication means for performing communication to and from another wireless communication terminal located in the vicinity and to and from said connecting station;

data packet holding means for temporarily holding said data packet; and

data packet transmitting means for transmitting said data packet held by said data packet holding means to said wireless communication terminal of data transmission destination in case communication can be performed to and from said wireless communication terminal of data transmission destination via said short distance wireless communication means.

With the arrangement as described above, it is possible to improve the reliability of communication using short distance communication functions by a mobile wireless device (a wireless communication terminal) located on a wide area network.

Further, to attain the above object, the present invention provides a position estimation device for estimating a position of a wireless communication terminal within a predetermined area at an arbitrary time, wherein said position estimation device comprises:

a network interface connected to a predetermined network;

standard station position information storage means for storing standard station position information to indicate a position of installation on each of the standard stations fixedly installed within said predetermined area;

intersecting history data receiving means for receiving an intersecting history data including device identification information received when said wireless communication terminal passes close by another wireless communication terminal or said standard station from said wireless communication terminal via said network interface;

an intersecting history database for storing said intersecting history data received from each of said plurality of wireless communication terminals; and

position estimation processing means for estimating a position of any one of said wireless communication terminals at an arbitrary time by using said intersecting history data stored in said intersecting history database.

With the arrangement as described above, it is possible to carry out position estimation with high accuracy by simple system configuration using short distance communication functions.

Also, in addition to the arrangement as described above, the present invention provides the position estimation device as described above, wherein said intersecting history data is a type of information where time information when said device identification information is received or a moving distance information to a position where the information is received is associated with said device identification information.

With the arrangement as described above, it is possible to carry out position estimation with high accuracy by simple system configuration using short distance communication functions.

Further, in addition to the arrangement as described above, the present invention provides the position estimation device as described above, wherein said position estimation processing means estimates a moving route of a wireless communication terminal (for which the position is to be estimated) by acquiring the intersecting history data received from the wireless communication terminal (for which the position is to be estimated) from said intersecting history database, by referring to the intersecting history data acquired and to said standard station position information, and by specifying a position of said standard station where the wireless communication terminal, for which the position is to be estimated, receives said device identification information.

With the arrangement as described above, it is possible to accomplish position estimation with high accuracy in relation to a wireless communication terminal (for which the position is to be estimated) by using an intersecting history data directly uploaded from the wireless communication terminal (for which the position is to be estimated).

Also, in addition to the arrangement as described above, the present invention provides the position estimation device as described above, wherein said position estimation processing means estimates a moving route of said wireless communication terminal (for which the position is to be estimated) by searching device identification information of said wireless communication terminal (which is an object of position estimation), by referring to the intersecting history data of another wireless communication terminal, and by specifying a position where said wireless communication terminal (which is an object of position estimation) has intersected another mobile wireless device in case the intersecting history data received from the wireless communication terminal for which the position is to be estimated) could not be acquired from said intersecting history database.

With the arrangement as described above, it is possible to accomplish position estimation with high accuracy on a wireless communication terminal (for which the position is to be estimated) by using an intersecting history data uploaded from another wireless communication terminal where intersecting phenomena with the wireless communication terminal (for which the position is to be estimated) is included.

Further, in addition to the arrangement as described above, the present invention provides the position estimation device as described above, wherein said position estimation processing means acquires an intersecting history data received from a wireless communication terminal (for which the position is to be estimated) from said intersecting history database, refers to the intersecting history data acquired and to said standard station position information, specifies a position of said standard station where said wireless communication terminal (which is an object of position estimation) received said device identification information, and estimates a moving route of the wireless communication terminal (which is the object of position estimation), and further, refers to an intersecting history data of another wireless communication terminal, retrieves device identification information of said wireless communication terminal (for which the position is to be estimated), specifies a position where said wireless communication terminal (which is an object of position estimation) from the result of the retrieval where said wireless communication terminal has intersected another mobile wireless device, and performs compensation on said moving route according to the position thus specified.

With the arrangement as described above, it is possible to accomplish position estimation with high accuracy on a wireless communication terminal (for which the position is to be estimated) by compensating the intersecting history data directly uploaded from the wireless communication terminal (for which the position is to be estimated) with the intersecting history data uploaded from another wireless communication terminal where intersecting phenomena with the wireless communication terminal (for which is the position is to be estimated) are included.

Also, to attain the above object, the present invention provides a communication relay device for receiving a data packet transmitted by a wireless communication terminal of data transmission source to a wireless communication terminal of data transmission destination in a communication system, which comprises a wireless communication terminal moving within a predetermined area, a plurality of connecting stations located within said predetermined area and connected to a predetermined network, a communication relay device connected to said predetermined network, and a position estimation device connected to said predetermined network, wherein said communication relay device comprises:

a network interface connected to said predetermined network;

device identification information extracting means for extracting device identification information of said wireless communication terminal of data transmission destination added to said data packet received from said connecting station;

position inquiring means for inquiring a position of said wireless communication terminal of data transmission destination by delivering device identification information of said wireless communication terminal of data transmission destination to said position estimation device capable to estimate a position of the wireless communication terminal located within said predetermined area;

position estimation result receiving means for receiving a result of estimation of a current position of said wireless communication terminal of data transmission destination as a response to said position inquiry by said position inquiring means; and

data packet transmitting means for transmitting said data packet to a connecting station as estimated to be located in the vicinity of said wireless communication terminal of data transmission destination as specified according to the result of estimation of a current position of said wireless communication terminal of data transmission destination.

With the arrangement as described above, it is possible to improve the reliability of communication using short distance communication functions by a mobile wireless device (a wireless communication terminal) located on a wide area network.

Also, in addition to the arrangement as described above, the present invention provides the communication relay device as described above, wherein said communication relay device comprises:

data packet copying means for copying said data packet received from said connecting station and for preparing a plurality of data packets; and

transmission control means for controlling so that said plurality of data packets copied by said data packet copying means are transmitted to each of said different connecting stations via said data packet transmitting means.

With the arrangement as described above, for the purpose of increasing the reachability of the packet, the communication relay device can transfer a plurality of the same packets. In particular, this arrangement is effective under the situation where it is not definitely known which of the connecting stations the wireless communication terminal of data transmission destination is under.

Further, to attain the above object, the present invention provides a connecting station, receiving a data packet transmitted by a wireless communication terminal of data transmission source to a wireless communication terminal of data transmission destination from said communication relay device in a communication system, which comprises a wireless communication terminal moving within a predetermined area, a plurality of connecting stations located within said predetermined area and connected to a predetermined network, a communication relay device connected to said predetermined network, and a position estimation device connected to said predetermined network, wherein said connecting station comprises:

short distance wireless communication means for performing communication to and from said wireless communication terminal located in the vicinity;

a network interface connected to said predetermined network; and

data packet transmitting means for transmitting said data packet received at said network interface to said wireless communication terminal capable to perform communication via said short distance wireless communication means or to said wireless communication terminal of data transmission destination.

With the arrangement as described above, it is possible to improve the reliability of communication using short distance communication functions by a mobile wireless device (a wireless communication terminal) located on a wide area network.

Also, in addition to the arrangement as described above, the present invention provides the connecting station as described above, wherein said connecting station comprises:

data packet copying means for copying said data packet received from said communication relay device and for preparing a plurality of data packet; and

transmission control means for controlling so that said plurality of data packets copied by said data packet copying means are transmitted to each of different wireless communication terminals by said data packet transmitting means.

With the arrangement as described above, for the purpose of increasing the reachability of the packet, the connecting station can transfer a plurality of the same packets. In particular, this arrangement is effective in the situation where there is high possibility that the wireless communication terminal of data transmission destination is located in the vicinity of a specific connecting station.

With the arrangement as described above, when the present invention is applied, it is possible to accomplish position estimation with high accuracy by simple system configuration using short distance communication functions. Also, according to the present invention, the position estimation with high accuracy can be achieved by utilizing bidirectionality of communication using short distance wireless devices.

### BRIEF DESCRIPTION OF THE DRAWINGS

FIG. 1 is a schematical drawing to show a system configuration common to first and second embodiments of the present invention;

FIG. 2 is a block diagram to show an example of an arrangement of a mobile wireless device in the first embodiment of the invention;

FIG. 3 is a flowchart to show an example of operation of the mobile wireless device in the first embodiment of the invention;

FIG. 4A is a table to show an example of intersecting history data as obtained in the first embodiment of the invention;

FIG. 4B is a table to show another example of intersecting history data as obtained in the first embodiment of the invention;

FIG. 5 is a block diagram to show an example of an arrangement of a position estimation device in the first embodiment of the invention;

FIG. 6 is a table to show an example of standard station position information used in the first embodiment of the invention;

FIG. 7 is a drawing to show general features of a position estimation method by a position estimation device in the first embodiment of the invention;

FIG. 8A is a table to show another example of the intersection history data obtained in the first embodiment of the invention;

FIG. 8B is a table to show an example of the intersecting history data obtained in the first embodiment of the invention and shows an example of intersecting data to be used as a compensation data of the intersecting history data of FIG. 8A;

FIG. 9 is a block diagram to show an example of an arrangement of a mobile wireless device in a second embodiment of the invention;

FIG. 10 is a flowchart to show an example of operation of a mobile wireless device in the second embodiment of the invention;

FIG. 11 is a drawing to schematically show a system configuration common to a third and fourth embodiments of the invention;

FIG. 12 is a block diagram to show an example of an arrangement of a mobile wireless device in the third embodiment of the invention;

FIG. 13 is a flowchart to show an example of operation of the mobile wireless device in the third embodiment of the invention;

FIG. 14A is a table to show an example of intersecting history data of the mobile wireless device in the third embodiment of the invention;

FIG. 14B is a table to show another example of intersecting history data of the mobile wireless device in the third embodiment of the invention;

FIG. 15A is a drawing to show a condition where two mobile wireless devices located at separated positions move and intersect each other in the third embodiment of the invention, showing the initial condition;

FIG. 15B is a drawing to show a condition where two mobile wireless devices located at separated positions move and intersect each other in the third embodiment of the invention, showing a condition where one of the mobile wireless devices is located at a position near a standard station;

FIG. 15C is a drawing to show a condition where two mobile wireless devices located at separated positions move and intersect each other in the third embodiment of the invention, showing a condition where the other of the mobile wireless devices is located at a position near a standard station;

FIG. 15D is a drawing to show a condition where two mobile wireless devices located at separated positions move and intersect each other in the third embodiment of the invention, showing a condition where two mobile wireless devices intersect each other;

FIG. 16 is a block diagram to show an example of an arrangement of a mobile wireless device in a fourth embodiment of the invention;

FIG. 17 is a flowchart to show an example of operation of a mobile wireless device in the fourth embodiment of the invention;

FIG. 18 is a drawing to schematically show a system configuration in a fifth embodiment of the invention;

FIG. 19 is a block diagram to show an example of an arrangement of a mobile wireless device in the fifth embodiment of the invention;

FIG. 20 is a flowchart to show an example of position registering operation of the mobile wireless device in the fifth embodiment of the invention;

FIG. 21A is a table to show an example of intersecting history data in the fifth embodiment of the invention;

FIG. 21B is a table to show another example of intersecting history data in the fifth embodiment of the invention;

FIG. 22 shows an example of an arrangement of the position estimation device in the fifth embodiment of the invention;

FIG. 23 is a table to show an example of standard station position information to be used in the fifth embodiment of the invention;

FIG. 24 is a drawing to show general features of a position estimation method by the position estimation device in the fifth embodiment of the invention;

FIG. 25A is a table to show another example of the intersecting history data in the fifth embodiment of the invention;

FIG. 25B is a table to show an example of the intersecting history data to be obtained in the fifth embodiment of the invention, showing an example of intersecting data to be used as a compensation data for the intersecting history data of FIG. 8A;

FIG. 26 is a drawing to show an example of an arrangement of a communication relay device in the fifth embodiment of the invention;

FIG. 27 is a sequence chart to show an example of basic operation in packet transmitting operation in the fifth embodiment of the invention;

FIG. 28 is a sequence chart to show a first application example of packet transmitting operation in the fifth embodiment of the invention;

FIG. 29 is a sequence chart to show a second application example of packet transmitting operation in the fifth embodiment of the invention;

FIG. 30 is a sequence chart to show a third application example of packet transmitting operation in the fifth embodiment of the invention;

FIG. 31 is a drawing to schematically show another example of system configuration in the fifth embodiment of the invention; and

FIG. 32 is a drawing to show general features of a method of three-point surveying in the prior art.

### BEST MODE FOR CARRYING OUT THE INVENTION

Description will be given below on the first to the fifth embodiments of the invention by referring to the attached drawings.

First, description will be given on the first and the second embodiments of the invention.

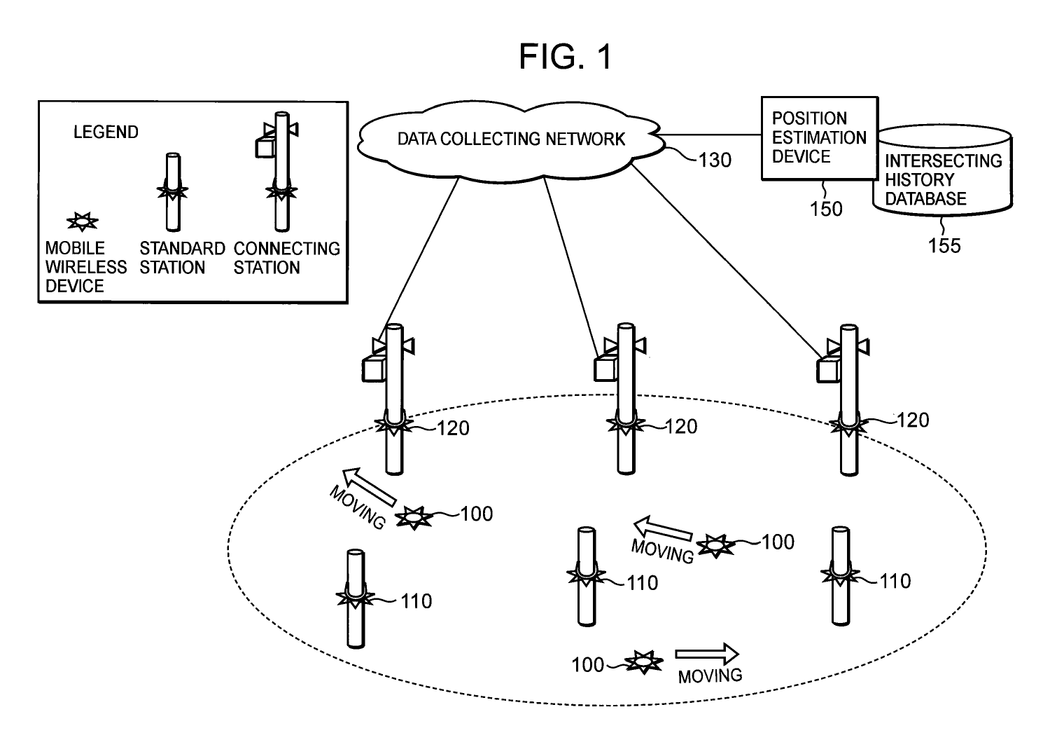

Referring to FIG. 1, description will be given on a system configuration, which is common to the first and the second embodiments of the invention. FIG. 1 is a schematical drawing to show a system configuration common to the first and the second embodiments of the invention.

FIG. 1 shows a plurality of mobile wireless devices (portable type mobile wireless devices) 100, a plurality of standard stations 110, a plurality of connecting stations 120, a data-connecting network 130, a position estimation device 150, and an intersecting history database 155.

The mobile wireless device 100 has the function to perform short distance wireless communication and exchange a device ID (identification information to identify own device) to and from an opponent device (the other wireless device). Specifically, the mobile wireless device 100 can transmit its own device ID to an opponent device and can receive a device ID of the opponent device and store it. The mobile wireless device 100 can move together with a human operator or a moving object (such as a vehicle) and can exchange the device ID to and from other mobile wireless device 110 passing each other at mobile destination, and to and from the standard station 110, and the connecting stations 120 which it intersects. Further, when it is possible to perform communication with the connecting station 120, the mobile wireless device 100 fulfills the function to upload intersecting history data including the intersecting history with other wireless device to a position estimation device 150 on a data collecting network 130, to which it can gain access via the connecting station 120.

The standard station 110 is a device, which is fixedly installed at a predetermined place. The standard station 110 has the function to transmit its own device ID at least to an opponent device (a mobile wireless device 100 passing in the neighborhood). Further, it may be so designed that, similarly to the case of the mobile wireless device 100, it can receive and store the device ID of the opponent device (a mobile wireless device 100 passing nearby). An operator for controlling the entire system must be able to identify the installation places where all of the standard stations 110 are installed. At the installation places of the standard stations 110, as a position data or any form of data such as two-dimensional coordinates (e.g. latitude and longitude), three-dimensional coordinates, etc., the data are stored in a standard station position information storage unit 153 of the position estimation device 150. Also, the standard stations need not be installed densely so that the communication ranges are overlapped each other, and it may be arranged at places with a predetermined area (a range where positions of the mobile wireless devices 100 can be estimated) in the condition that communication ranges are separated from each other (in sparse condition).

The connecting station 120 are the devices, which are connected to a predetermined external network (In FIG. 1, it is shown as a data collecting network 130), and it has a function as a relay device when the mobile wireless device 100 uploads data to the position estimation device 150 on the data collecting network 130. The connecting station 120 not only has the function as a gateway to the data collecting network 130 but also it may fulfill the function as a standard station to transmit its own device ID (and to receive and store the device ID from an opponent device).

The position estimation device 150 has the function to receive the data transferred from the connecting station 120 via the data collecting network 130, to store the received data in the intersecting history database 155, and, if necessary, to perform position estimation processing by using the data stored in the intersection history database 155. The data collecting network 130 can use any arbitrary network such as a special purpose network or a public network (e.g. Internet).

As described above, according to the present invention, standard stations 110 for transmitting own device ID (the place to be installed is fixed and known) are installed within a predetermined area, and connecting stations 120 are connected to a data collecting network 130, which can communicate with the position estimation device 150. On the other hand, the mobile wireless devices 100 moving in the predetermined area exchange own device ID to and from other mobile wireless devices 100, with which it intersects. In case it passes near the standard station 110, it stores the device ID of the other mobile wireless device 100 passing each other by receiving and storing the device ID of the standard station 110 when it passes near the standard station 110.

When the mobile wireless device 100 passes near the connecting station 120, by uploading the intersecting history data to the position estimation device 150 via the connecting station 120, the intersecting history data of a plurality of the mobile wireless devices 100 moving in the predetermined area are stored in the intersecting history database 155 of the position estimation device 150, and by using the intersecting history data, a position of the mobile wireless device 100 moving in the predetermined area can be estimated.

Based on the system configuration as described above, description will be given below on each of the first and the second embodiments of the invention.

### The First Embodiment

First, description will be given on a first embodiment of the invention. In the first embodiment of the invention, description will be given on a case where the device ID to be stored is associated with time information.

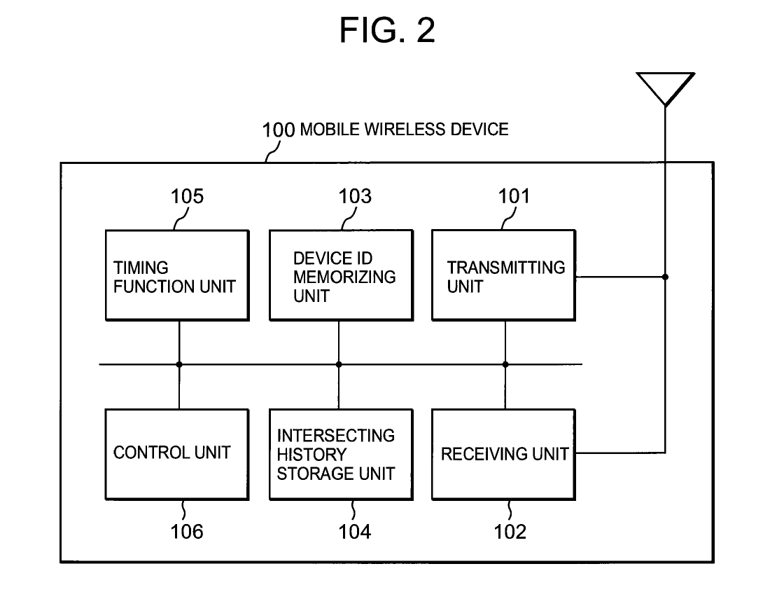

FIG. 2 is a block diagram to show an example of an arrangement of the mobile wireless device 100 in the first embodiment of the invention. The mobile wireless device 100 as shown in FIG. 2 comprises a transmitting unit 101, a receiving unit 102, a device ID memorizing unit 103, an intersecting history storage unit 104, a timing function unit 105, and a control unit 106. FIG. 2 shows a condition where these functional blocks are connected with each other via an internal bus.

The transmitting unit 101 and the receiving unit 102 have the functions to perform wireless communication with other wireless devices (i.e. other mobile wireless devices 100, standard stations 110, and the connecting stations 120). According to the present invention, short distance wireless communication is applied as wireless communication technique to be used at the transmitting unit 101 and the receiving unit 102. The short distance wireless communication is a type of wireless communication with communication range of short-distance of about several tens of centimeters to several meters. For instance, the communication technique of RFID (Radio Frequency Identification) can be used.

In the device ID memorizing unit 103, a device ID (identification information) specific to the mobile wireless device 100 for identifying the mobile wireless device 100 is kept in memory in advance.

The intersecting history storage unit 104 fulfills the function to store a device ID received from another mobile device 100 passing nearby or a device ID received from the standard station 110. In the first embodiment of the invention, these device IDs are stored by associating them with time information, which is obtained from the timing function unit 105.

The timing function unit 105 has the function to output the present time as time information. The time information as outputted from the timing function unit 105 is associated with the device ID, which is received from the other mobile wireless device 100 passing nearby or the device ID received from the standard station 110.

The control unit 106 has the function to control the processing of the mobile wireless device 100. More concretely, the control unit 106 controls various types of processing such as: a processing to transmit the device ID to outside (to other wireless devices) from the transmitting unit 101, a processing to store the device ID received from the other wireless device by associating it with the time information outputted from the timing function unit 105, a processing to transmit the intersecting history data to the position estimation device 150 via the connecting station 120 when it is possible to perform communication with the connecting station 120.

The standard station 110 in the first embodiment of the invention has at least the function to transmit the device ID as given to this standard station 110 to the mobile wireless device 100, which passes nearby. Similarly to the mobile wireless device 100, the standard station 110 may receive and store the device ID from the mobile wireless device 100 passing nearby. As a result, the passing history of the mobile wireless device 100 passing nearby remains at the standard station 110.

The connecting station 120 in the first embodiment of the invention has at least the function to relay the intersecting history data to be transmitted from the mobile wireless device 100 located nearby to the position estimation device 150 on the data collecting network 130. The connecting station 120 may have the same function as that of the standard station 110. That is, the connecting station 120 may have the function to transmit its own device ID, and further, it has the function to receive the device ID from the mobile wireless device 100 and to store it. When the connecting station 120 transmits its own device ID similarly to the case of the standard station 110, the place where the connecting station 120 is installed must be identified and known at the position estimation device 150.

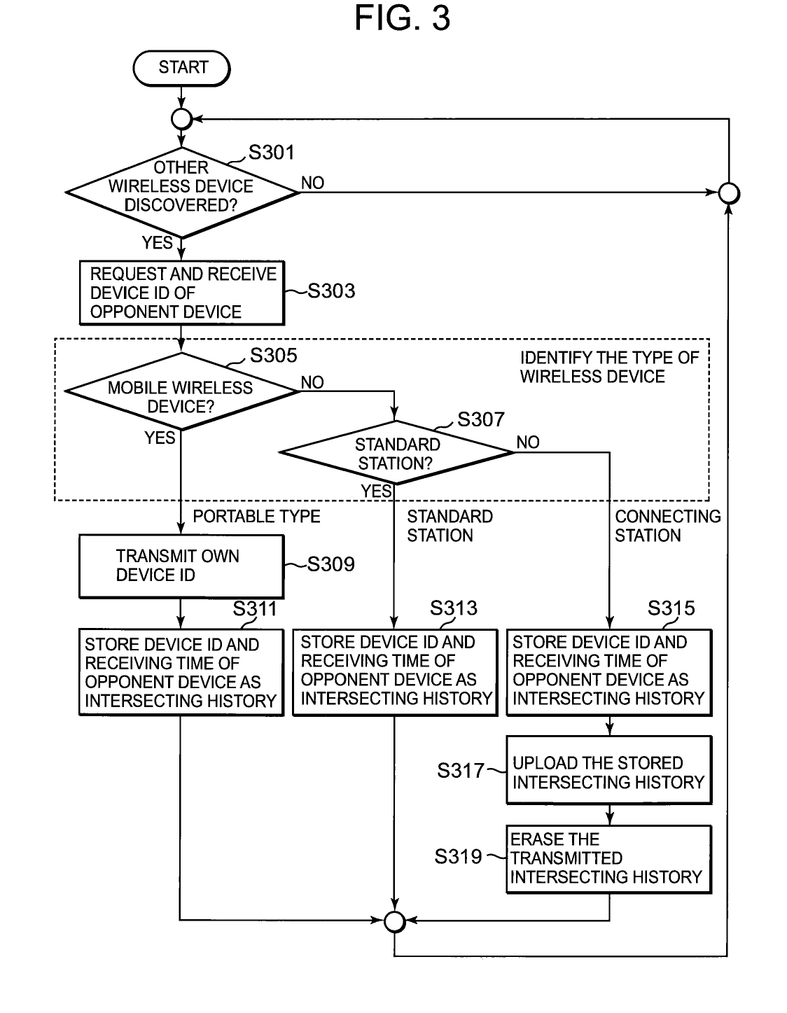

Next, referring to FIG. 3, description will be given on an example of operation of the mobile wireless device 100 in the first embodiment of the invention. FIG. 3 is a flowchart to show an example of operation of the mobile wireless device 100 in the first embodiment of the invention.

In FIG. 3, the mobile wireless device 100 monitors whether other wireless device (the other mobile wireless device 100, the standard station 110, or the connecting station 120) can be found or not (Step S301). Then, in case the mobile wireless device 100 moves and comes to a point where it is possible to communicate with the other wireless device, or in case it does not move and remains at the former position while another mobile wireless device 100 has moved up to the point where communication can be made, the mobile wireless device 100 discovers the other wireless device and requests the device ID to this wireless device and receives the device ID of the opponent device (i.e. the wireless device discovered) (Step S303).

The mobile wireless device 100 identifies the type of the wireless device, which has moved to a point where communication can be made. That is, the mobile wireless device 100 identifies as to which category the opponent device falls under: i.e. the portable type mobile wireless device 100, the standard station 110, or the connecting station 120 (Steps S305 and S307). To identify the type of the opponent device, any method may be adopted. For instance, it may be so arranged that a code to indicate the type of the mobile wireless device 100, the standard station 110, or the connecting station 120 is included in the device ID so that the type can be identified from the device ID received in Step S303.

In case the opponent device is a portable type, the mobile wireless device 100 transmits its own device ID to the opponent device (Step S309). Then, the mobile wireless device 100 associates the device ID received in Step S303 with the time of receiving (i.e. the current time information as outputted from the timing function unit 105), and it is stored in the intersecting history storage unit 104 as an intersecting history (Step S311).

In case the opponent device is the standard station 110, the mobile wireless device 100 associates the device ID received in Step S303 with the receiving time (i.e. the current time information as outputted from the timing function unit 105), and it is stored in the intersecting history storage unit 104 as an intersecting history (Step S313).

When the opponent device is the connecting station 120, the mobile wireless device 100 associates the device ID received in Step S303 with the receiving time (i.e. the current time information as outputted from the timing function unit 105), and it is stored in the intersecting history storage unit 104 as an intersecting history (Step S315). Further, the mobile wireless device 100 uploads the intersecting history data stored in the intersecting history storage unit 104 (Step S317) and erases the intersecting history data uploaded and transmitted from the intersecting history storage unit 104 (Step S319).

When the processing of Steps S311, S313 or S319 as described above has been completed, the mobile wireless device 100 returns to the condition to monitor the other wireless devices again (the monitoring in Step S301).

Here, description has been given on a case where the mobile wireless device 100 does not transmit the device ID to the standard station 110 or to the connecting station 120, while it may be so arranged that the mobile wireless device 100 performs the processing similar to that of Step S309 and may transmit its own ID to the standard station 110 or to the connecting station 120. In this case, the standard station 110 or the connecting station 120 stores the received device ID and the receiving time as an intersecting history, and the history of the mobile wireless device 100, which has passed near the standard station 110 or the connecting station 120, will be stored. The connecting station 120 may transmit the stored intersecting history data to the position estimation device 150 at any timing. The processing to transmit own device ID by the mobile wireless device 100 (Step S309) may be carried out before or after the processing to request and receive the opponent device ID (Step S303).

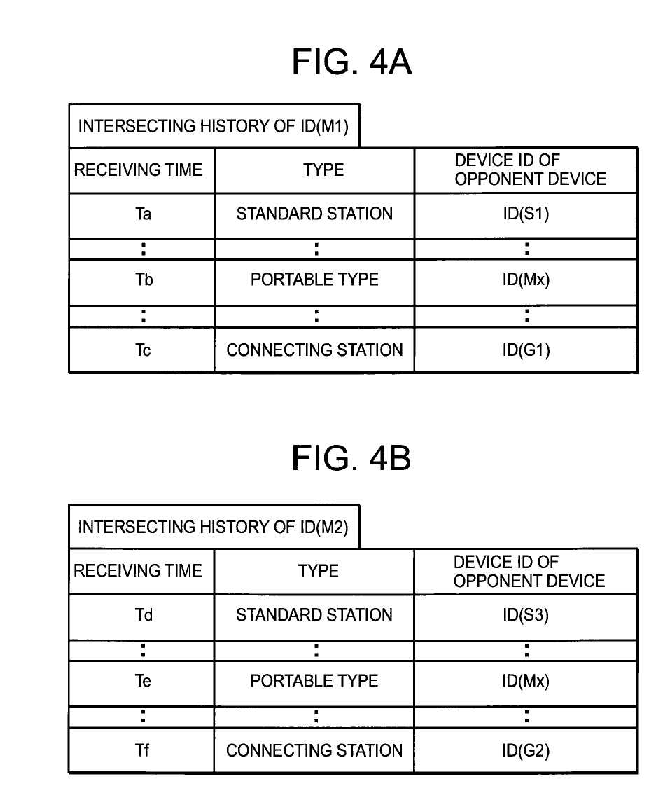

In the intersecting history data, which is uploaded from the mobile wireless device 100 to the position estimation device 150 in Step S317, information elements as shown in FIG. 4A or FIG. 4B are included. FIG. 4A and FIG. 4B are tables, showing a first example and a second example of the intersecting history data respectively, which the position estimation device receives from the mobile wireless device in the first embodiment of the invention.

FIG. 4A shows the intersecting history data of the mobile wireless device 100 (which has ID (M1) as the device ID). According to the mobile history as shown in FIG. 4A, the mobile wireless device 100 (which has ID (M1) as the device ID) has passed near the standard station 110 (which has ID (S1) as the device ID), and has received the device ID. Then, it is found that it has passed each other with the mobile wireless device (portable type) (which has ID (Mx) as the device ID), and received the device ID, and that it has passed near the connecting station 120 (which has ID (G1) as the device ID) at the time Tc and has received the device ID. It is also found that it has uploaded the intersecting history data via the connecting station 120.

FIG. 4B shows the intersecting history data of the mobile wireless device 100 (which has ID (M2) as the device ID). According to the mobile history as shown in FIG. 4B, it is found that the mobile wireless device 100 (which has ID (M2) as the device ID) has passed near the standard station 110 (which has ID (S3) as the device ID), and has received the device ID, and that it has intersected the mobile wireless device (portable type) 100 (which has ID (Mx) as the device ID) and has received the device ID. It is also found that it has passed near the connecting station 120 (which has ID (G2) as the device ID) and has received the device ID, and also that it has uploaded the intersecting history data via the connecting station 120.

In FIG. 4A and FIG. 4B, the items for the types are also given to facilitate explanation, while, in the first embodiment of the invention, it would suffice if the receiving time and the device ID of the opponent device are included in the intersecting history data. Also, it may be so arranged that the type may be represented by a part of the device ID by including the code to indicate the type in the device ID as described above.

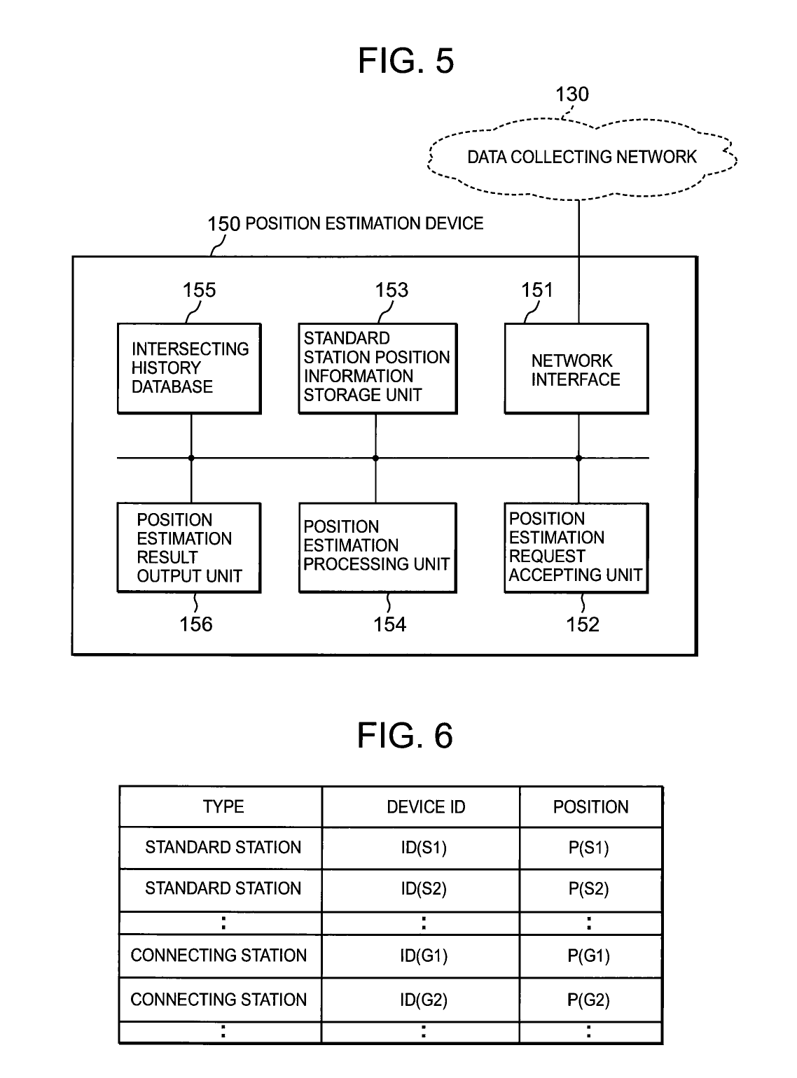

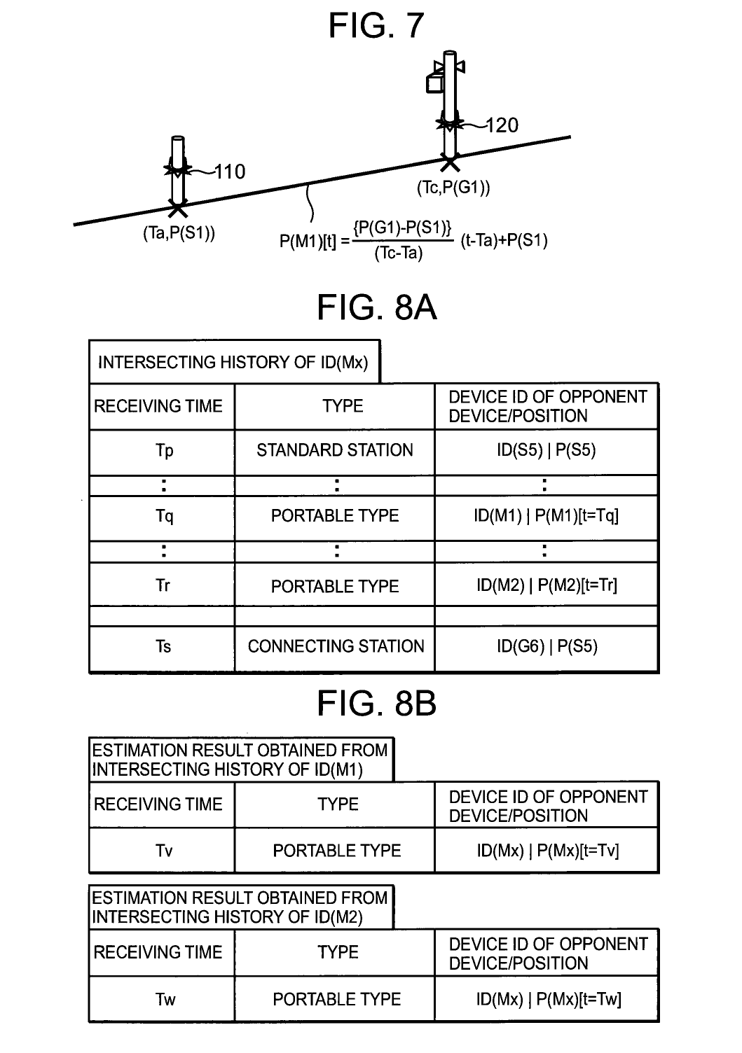

Next, referring to FIG. 5, description will be given on an arrangement of the position estimation device in the first embodiment of the invention. FIG. 5 shows an example of an arrangement of the position estimation device 150 in the first embodiment of the invention. The position estimation device 150 shown in FIG. 5 comprises a network interface 151, a position estimation request accepting unit 152, a standard station position information storage unit 153, a position estimation processing unit 154, an intersecting history database 155, and a position estimation result outputting unit 156. FIG. 5 schematically shows a condition where these functional blocks are connected via internal bus.

The network interface 151 has the communication functions to connect the position estimation device 150 to the data collecting network 130 and to receive the intersecting history data as transmitted from the mobile wireless device 100 via the data collecting network 130.

The position estimation request accepting unit 152 has the function to accept the request of position estimation. For instance, the request of position estimation may be inputted by using an operation interface such as a mouse or a keyboard by an operator, who can operate the position estimation device 150, and it may be inputted via a network (e.g. the data collecting network 130) from an arbitrary device.

When position estimation is requested, the mobile wireless device 100 (for which the position is to be estimated) must be specified, and it is desirable that the time when the position relating to the mobile wireless device 100 (which is an object of position estimation) is to be estimated (i.e. any of the current time, or time in the past or in future).

In the standard station position information storage unit 153, information relating to the installation places of all of the standard stations 110 as installed in the predetermined area (i.e. standard station position information) are stored in advance. The connecting station 120 has not only the function to relay the intersecting history data to be uploaded to the position estimation device 150 from the mobile wireless device 100 but also it has the function to control position information of the connecting station 120 in the standard station position information to be stored in the standard station position information storage unit 153.

The position estimation processing unit 154 has the function to calculate an estimated position at a specific time of the mobile wireless device 110 (for which the position is to be estimated) by referring to the standard station position information in the standard station position information storage unit 153 or also to the intersecting history data in the intersecting history database 155 when position estimation relating to a certain mobile wireless device 100 is received. The position estimation processing unit 154 can estimate the present position of the mobile wireless device (for which the position is to be estimated), and also, it can estimate the position at any time in the past or in future.

The intersecting history database 155 has the function to store the intersecting history data, which are uploaded from each of the mobile wireless devices 100 as described above.

The position estimation result output unit 156 has the function to output the result of position estimation as calculated at the position estimation processing unit 154 to outside. For instance, the position estimation result output unit 156 may output the result of position estimation on a display screen, which can be inspected by an operator of the position estimation device 150. In case a request of position estimation is received via a network, the result of position estimation may be transmitted to a device, which requested the position estimation, via the network interface 151.

FIG. 6 shows an example of the standard station position information as stored in the standard station position information storage unit 153. According to the standard station position information as shown in FIG. 6, it is seen that a standard station 110, which has ID (51) as the device ID, is at a position P (S1), and a standard station 110, which has ID (S2) as the device ID is placed at a position P (S2). Further, a connecting station 120, which has ID (G1) as the device ID, is placed at a position P (G1), and that the connecting station 120, which has ID (G2) as the device ID, is placed at a position P (G2).

In FIG. 6, the items for the types are also given to facilitate explanation, while it would suffice if information to associate the device ID of the standard station (and the connecting station) with the position where the device is installed is included in the standard station position information. Also, it may be so designed that the type is indicated by a part of the device ID by including a code to indicate the type in the device ID as described above. Although it is not shown in FIG. 6, the device ID and the position of each of the standard stations (or, connecting stations 120) installed in the predetermined area are included in the standard station position information.

Next, description will be given on position estimation processing, which is to be carried out at the position estimation device 150 in the first embodiment of the invention. The position estimation device 150 can calculate, for instance, an approximate position of the mobile wireless device 100 at any time as desired from the intersecting history data of a specific mobile wireless device 100 stored in the intersecting history database 155.

For instance, when a request of position estimation at the time Tz of the mobile wireless device 100 is received, for which the position is to be estimated, the position estimation device 150 refers to the intersecting history data of the mobile wireless device 100 and selects at least two standard stations 110, and the receiving time when the mobile wireless device 100 has received the device ID from these standard stations 110 (i.e. the time when it passed near the standard station) is extracted. Also, by referring to the standard station position information storage unit 153, the installation position information of the standard station 110 selected is acquired. Then, from the information of time and position of each of these two standard stations 110, time and position of the mobile wireless device 100, which has passed between these two standard stations 110, are estimated. For instance, by assuming that the mobile wireless device 100 moves at equal velocity along a straight line, which connects these two standard stations 110, from the information of time and position relating to each of these two standard stations 110, it is possible to identify an approximate position of the mobile wireless device 100, for which the position is to be estimated, at an arbitrary time.

Detailed description will be given below on a case where a position at an arbitrary time of the mobile wireless device 100 (which has ID (M1) as the device ID) by using intersecting history data shown in FIG. 4A and a standard station position information shown in FIG. 6.

In case a request on position estimation at the time Tx of the mobile wireless device 100 (which has ID (M1) as the device ID) is received, the position estimation device 150 refers to the intersecting history data (the intersection history data as shown in FIG. 4A). From the intersecting history data as shown in FIG. 4A, it is seen that the connecting station 120 (which has ID (G1) as the device ID) also has the function of the standard station 110.

Then, the position estimation device 150 selects the standard station 110 (which has ID (S1) as the device ID) (i.e. the time Ta when it has passed near the standard station 110) and the connecting station 120 (which has ID (G1) as the device ID) (i.e. the time Tc when it has passed near the connecting station 120), and by referring to the standard station position information in the standard station position information storage unit 153, the position P (S1) of the standard station 110 (which has ID (S1) as the device ID) and the position P (G1) of the connecting station 120 (which has ID (G1) as the device ID) are identified.

Then, by obtaining a straight line, which connects coordinates (Ta, P (S1)) relating to the standard station 110 with coordinates (Tc, P (G1)) relating to the connecting station 120, calculation is made by the following equation (1), which indicates the position P (M1) [t] of the mobile wireless device 100 at the time t.

P(M1)[t]={P(G1)−P(S1)}×(t−Ta)/(Tc−Ta)+P(S1) Equation (1)

Then, by substituting the time Tx of position estimation to the time “t” in the above equation, an estimated position at the time Tz of the mobile wireless device 100, for which the position is to be estimated, can be calculated.

In the equation (1) as given above, the time Tz of the position estimation may be limited to the range of: Ta≦Tz≦Tc, while it is also possible to apply to position estimation of the mobile wireless device 100 in the range of Tz<Ta and in the range of Tz>Tc.

In the equation (1) as given above, it is assumed that the mobile wireless device 100 (which has ID (M1) as the device ID) moves at equal velocity along a straight line, which connects positions of the two standard stations 110 (and the connecting station 120) included in the intersecting history data of the mobile wireless device 100, while a locus to indicate the position of the mobile wireless device 100 at an arbitrary time “t” may be obtained by applying the method of multivariate analysis, for instance, on the position of three or more standard stations 110 (and the connecting stations 120). Also, consideration may be given on map data including various types of information such as roads, facilities, etc., and it may be so designed that the moving route of the mobile wireless device 100 is not represented by a mere straight line but the moving route of the mobile wireless device 100 will be consistent with the road or the passage, which connects between the standard stations 110 (and the connecting stations 120).

In case the position estimation device 150 can find the intersection history data of the mobile wireless device 100 (for which the position is to be estimated) in the intersecting history database 155, it is possible to estimate the position based on the intersecting history data of the mobile wireless device 110 (for which the position is to be estimated) as described above.

However, there may be a case where the intersecting history data of the mobile wireless device 100 (for which the position is to be estimated) is not found in the intersecting history database 155 or a case where the data is present but the information is merely an old information (information from the past). Such situation may occur when the mobile wireless device 100 (for which the position is to be estimated) has not uploaded the intersecting history data to the position estimation device 150 via the connecting station 120—not even once or for long time.

As described above, even in a case where the effective intersecting history data directly uploaded by the mobile wireless device 100 (for which the position is to be estimated) cannot be discovered in the intersecting history database 155, the position estimation device 150 may be able to estimate the position of the mobile wireless device 100, for which the position is to be estimated.

In case the effective intersecting history data as directly uploaded by the mobile wireless device 100 cannot be found in the intersecting history database 155, the position estimation device 150 retrieves as to whether or not there is the information on the exchange of the device ID with the mobile wireless device 100 (for which the position is to be estimated) from the intersecting history data of the other mobile wireless device 100.

For instance, it is supposed here that the mobile wireless device 100, whose position is to be estimated, is a mobile wireless device 100 (which has ID (Mx) as the device ID). In case the effective intersecting history data of the mobile wireless device 100 (which has ID (Mx) as the device ID) could not be found, the position estimation device 150 checks whether the mobile wireless device 100 (which has ID (Mx) as the device ID) is included as an opponent device, which has exchanged the device ID, in the intersecting history data of the other mobile wireless device 100 (i.e. in the intersecting history data of the mobile wireless device 100 (which has ID (M1) as the device ID) as shown in FIG. 4A, or in the intersecting history data of the mobile wireless device 100 (which has ID (M2) as the device ID) as shown in FIG. 4B).

As a result, the position estimation device 150 can acquire the information that the mobile wireless device 100 (which has ID (M1) as the device ID) has intersected the mobile wireless device 100 (which has ID (Mx) as the device ID) at the time Tb. In this case, by using algorithm based on the above equation (1), it is possible to calculate the position P (M1) [t=Tb] at the time Tb. The position P (M1) [t=Tb] is an estimated position where the mobile wireless device 100 (which has ID (M1) as the device ID) is present at the time Tb, and also, it is a point where it has intersected the mobile wireless device 100 (which has ID (Mx) as the device ID). That is, it is an estimated position where the mobile wireless device 100 (which has ID (Mx) as the device ID) was present at the time Tb.

From the intersecting history data of the mobile wireless device 100 (which has ID (M2) as the device ID), the position estimation device 150 can acquire information that the mobile wireless device 100 (which has ID (M2) as the device ID) has intersected the mobile wireless device 100 (which has ID (Mx) as the device ID) at the time Te. In this case also, an estimated position P (M2) [t=Te] where the mobile wireless device 100 (which has ID (Mx) as the device ID) was present at the time Te can be calculated. As a result, regardless of the fact that the effective intersecting history data is not received from the mobile wireless device 100 itself (which has ID (Mx) as the device ID), the position estimation device 150 can identify the position where the mobile wireless device 100 (which has ID (Mx) as the device ID) was present.

As described above, from the intersecting history data of the mobile wireless device 100 (which has ID (M1) or ID (M2) as the device ID), it is possible to estimate the intersecting history data of the mobile wireless device 100 (which has ID (Mx) as the device ID) (i.e. time and position where it has intersected the mobile wireless device 100, which has ID (M1) or ID (M2) as the device ID).

Further, even in case the intersecting history data directly uploaded from the mobile wireless device 110 (for which the position is to be estimated) (i.e. the mobile wireless device 100 (which has ID (Mx) as the device ID) has been found, the position estimation device 150 can acquire information of the time and the position where it has intersected from the intersecting history data of the other mobile wireless device 100, which has intersected the mobile wireless device 100 (which has ID (Mx) as the device ID), and also can use the intersecting history data of the other mobile wireless device 100 as secondary data (data for compensation).

For instance, it is supposed here that the mobile wireless device 100 (for which the position is to be estimated), is the mobile wireless device 100 (which has ID (Mx) as the device ID). The position estimation device 150 reads the effective intersecting history data directly uploaded for the mobile wireless device 100 (which has ID (Mx) as the device ID) from the intersecting history database, and as a result, it acquires intersecting history with the standard station 110 or the connecting station 120 as shown in FIG. 8A of intersecting history with the mobile wireless device 100 (which has ID (M1) or ID (M2) as the device ID). Although the position where it has intersected is shown in FIG. 8A, this position can be obtained from the result of calculation by multivariate analysis (in case of the mobile wireless device 100) from the standard station position information (in case of the standard station 110). According to the example shown in FIG. 8A, it is seen that the mobile wireless device 100 (which has ID (Mx) as the device ID) has intersected the mobile wireless device 100 (which has ID (M1) as the device ID) at the time Tq and at the position P (M1) [t=Tq] and has intersected the mobile wireless device 100 (which has ID (M2) as the device ID) at the time Tr and at the position P (M2) [t=Tr].

On the other hand, the position estimation device 150 estimates the intersecting history data of the mobile wireless device 100 (which has ID (Mx) as the device ID) (i.e. the data of time and position where it has intersected the mobile wireless device 100 (which has ID (M1) or ID (M2) as the device ID) from the intersecting history data of the mobile wireless device 100 which has ID (M1) or ID (M2) as the device ID). By this operation, as shown in FIG. 8B, it is possible to obtain such information that the mobile wireless device 100 (which has ID (M1) as the device ID) has intersected the mobile wireless device 100 (which has ID (Mx) as the device ID) at the time Tv and at the position P (Mx) [t=Tv], and the mobile wireless device 100 (which has ID (M2) as the device ID) has intersected the mobile wireless device 100 (which has ID (Mx) as the device ID) at the time Tw and at the position P (Mx) [t=Tw].

Then, the position estimation device 150 can perform position estimation more adequately by carrying out compensation based on the data obtained from the intersecting history data of the mobile wireless device 100 (which has ID (M1) or ID (M2) as the device ID) with respect to the effective intersecting history data, which is directly uploaded from the mobile wireless device 100 (which has ID (Mx) as the device ID). More concretely, the position P (M1) [t=tq] and the position P (Mx) [t=Tv] are originally the same while these data may be deviated due to error or stirring inherent in the estimation method. Therefore, it is possible to carry out compensation by compensating the position P (M1) [t=Tq] to a position P (Mx) [t=Tv], for instance, by determining a position half-way between two positions as the intersecting position. It is also possible to perform compensation on a position P (M2) [t=Tr] and a position P (Mx) [t=Tw].

As described above, according to the first embodiment of the invention, the position estimation device 150 can estimate a position at an arbitrary time of each mobile wireless device 100 by uploading identification information of the opponent wireless device, which has intersected the mobile wireless device 100 at a predetermined passing point or at a passing time as the intersecting history data of each mobile wireless device 100.

Also, when the mobile wireless devices 100 exchange own device IDs with each other, the event (occurrence) of intersecting each other of the mobile wireless devices 100 can remain as the intersecting history of both sides. The intersecting history that a first mobile wireless device 100 has intersected a second mobile wireless device 100 is recorded in the intersecting history data of both of the first and the second mobile wireless devices 100. By compensating the intersecting history data of one wireless device by the intersecting history data of the other wireless device, the time and the position of the same intersecting event (occurrence) can be identified by using two intersecting history data.

### The Second Embodiment

Next, description will be given on the second embodiment of the invention. In the second embodiment, description will be given on a case where a device ID to be kept in memory is associated with information on the number of strides (or moving distance information).

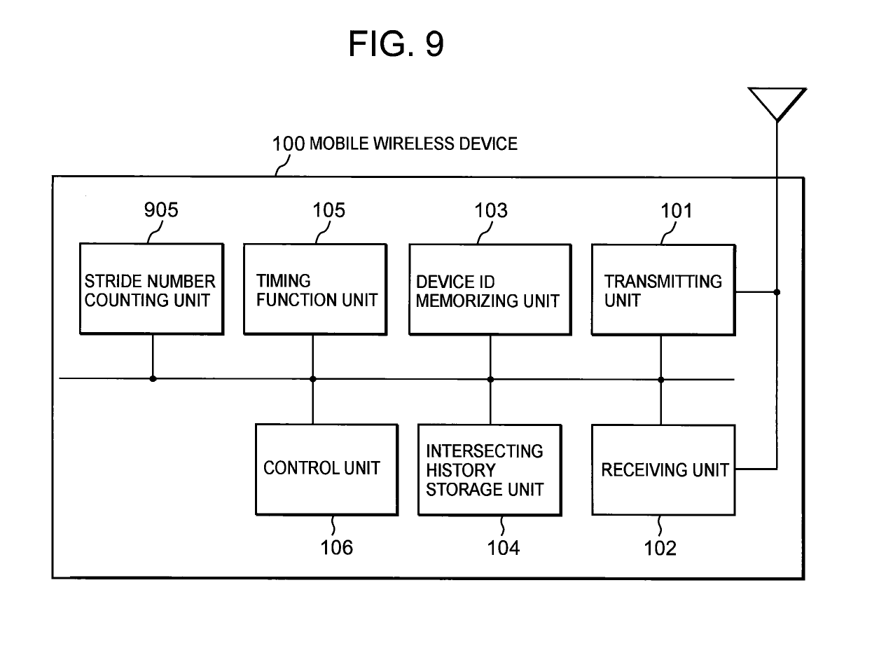

FIG. 9 shows an example of an arrangement of a mobile wireless device 100 in the second embodiment of the invention. The mobile wireless device 100 as shown in FIG. 9 comprises a transmitting unit 101, a receiving unit 102, a device ID memorizing unit 103, an intersecting history storage unit, a timing function unit 105, a control unit 106, an a stride number counting unit 905. FIG. 9 schematically shows a condition where these functional blocks are connected via internal bus.

As it is evident from the comparison with the arrangement shown in FIG. 2, the mobile wireless device 100 in the second embodiment of the invention has such an arrangement that a stride number counting unit 905 is added to the mobile wireless device 100 in the first embodiment of the invention. The stride number counting unit 905 has the function to count the number of strides of a person, who moves by carrying the mobile wireless device 100. Approximate moving distance can be calculated by adding up average length of stride (walking pace) of a person to the number of strides counted. The number of steps (strides) (corresponding to the moving distance) as counted by the stride number counting unit 905 is used when the intersecting history is recorded. Specifically, in the second embodiment of the invention, the number of strides (or the moving distance) is used together with the time (the time of receiving) as the information to be recorded by associating with the device ID received from the other mobile wireless device 100.

As the function to obtain the moving distance, the stride number counting unit 905 is used in this case, which is simple in arrangement and easy to use. Thus, it is possible to provide any function as desired to determine the moving distance. For instance, for the measurement of the moving distance, a device with the function to measure walking distance as installed on a vehicle can be used.

The component elements as shown in FIG. 9 (i.e. the transmitting unit 101, the receiving unit 102, the device ID memorizing unit 103, the intersecting history storage unit 104, the timing function unit 105, and the control unit 106) have basically the same functions as those shown in FIG. 2, and detailed description is not given here.

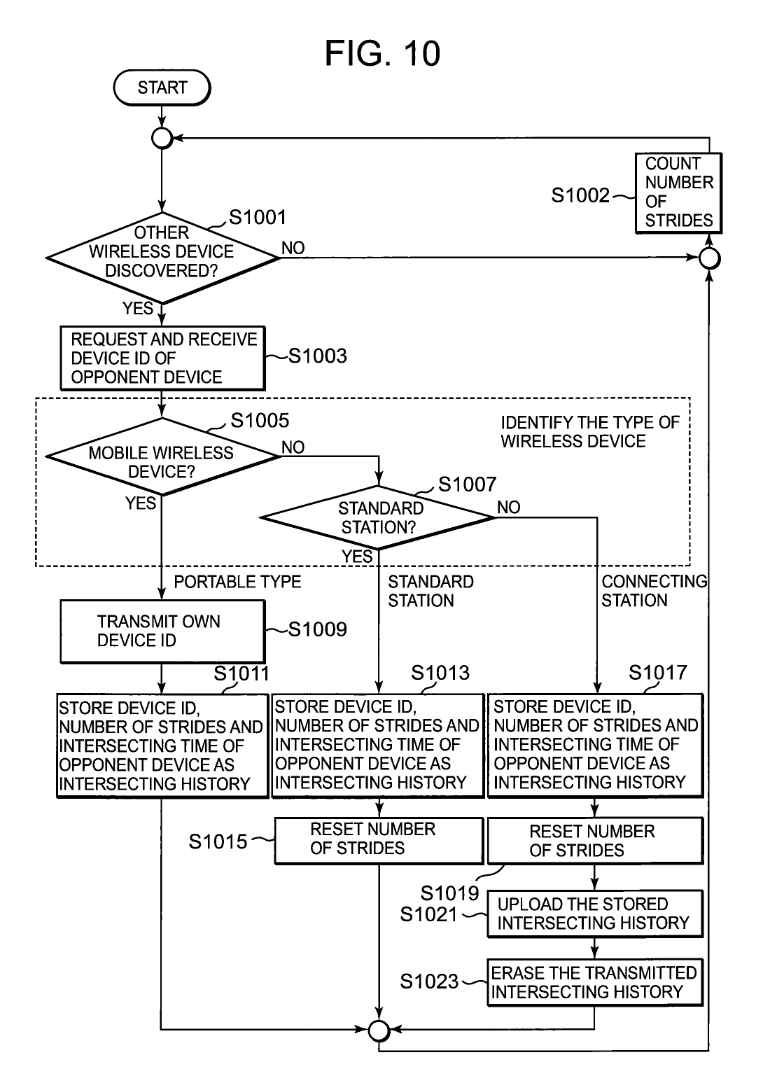

Next, referring to FIG. 10, description will be given on an example of a mobile wireless device in the second embodiment of the invention. FIG. 10 is a flowchart to show an example of operation of a mobile wireless device 100 in the second embodiment of the invention.

In FIG. 10, a mobile wireless device 100 monitors whether other wireless device (i.e. one of other mobile wireless device 100, the standard station 110, or the connecting station 120) is discovered or not (Step S1001). When the mobile wireless device 100 moves and has approached to a distance where it can perform communication with the other wireless device, or in case the other mobile wireless device 100 has approached to a distance where communication can be performed while the mobile wireless device remain without moving, the mobile wireless device 100 discovers the other wireless device. When the mobile wireless device 100 discovers the other wireless device, it requests the wireless device to inform the device ID and receives the device ID of the opponent device (i.e. the wireless device discovered). The mobile wireless device 100 always performs counting on the number of strides during the time it moves (Step S1002).

The mobile wireless device 100 identifies the type of the wireless device, which has approached to a position where communication can be made. That is, the mobile wireless device 100 judges as to which category of the mobile wireless device 100 or the standard station or the connecting station 120, the opponent device falls under (Steps S1005 and S1007). Any method may be used to identify the type of the opponent device. For instance, it may be so designed that a code to indicate any of the mobile wireless device 100 or the standard station 110 or the connecting station 120 is added to the device ID in advance so that the type can be identified from the device ID, which is received in Step S1003.

In case the opponent device is of portable type, the mobile wireless device 100 transmits its own device ID to the opponent device (Step S1009). Then, the mobile wireless device 100 associates the number of strides (i.e. current information on the number of strides as outputted from the stride number counting unit 905), the time of intersecting (current time information as outputted from the timing function unit 105) with the device ID received in Step S1003, and the result is stored in the intersecting history storage unit 104 as an intersecting history (Step S1011).

In case the opponent device is a standard station 110, the mobile wireless device 100 associates the device ID received in Step S1003 with the number of strides (i.e. current information on the number of strides as outputted from the stride number counting unit 905) and the time of intersecting (i.e. the current information on time as outputted from the timing function unit 105), and the result is stored in the intersecting history storage unit 104 as an intersecting history (Step S1013). Also, count value of the stride number counting unit 905 (i.e. the current number of strides) is reset (Step S1015).

In case the opponent device is a connecting station 120, the mobile wireless device 100 associates the device ID received in Step S1003 with the number of strides (i.e. current information on the number of strides as outputted from the stride number counting unit 905) and the time of intersecting (i.e. current information on time as outputted from the timing function unit 105) with the device ID received in Step S1003, and the result is stored in the intersecting history storage unit 104 as intersecting information (Step S1017). Also, counting number (current number of strides) of the stride number counting unit 905 is reset (Step S1019). Further, the mobile wireless device 100 uploads the intersecting history data stored in the intersecting history storage unit 104 to the position estimation device 150 on the data collecting network 130 via the connecting station 120 (Step S1021) and erases the transmitted intersecting history data as uploaded from the intersecting history storage unit 104 (Step S1023). When the intersecting history data is received and is stored in the intersecting history database 155, it is desirable that the position estimation device 150 specify uploading time from the mobile wireless device 100 by keeping the receiving time (or time of memorizing the information) at the same time so that time of uploading from the mobile wireless device 100 can be specified.

When one of the processings in either one of Steps S1011, S1015 or S1023 has been completed, the mobile wireless device 100 monitors the other wireless device, and it goes back to a state to count the number of strides (i.e. moving distance) (monitor processing in Step S1001 and processing of stride number counting in Step S1002).

Here, description has been on an example where the mobile wireless device 100 does not transmit the device ID to the standard station 110 or to the connecting station 120, while it may be so arranged that the mobile wireless device 100 performs the same processing as in Step S1009 and may transmit its own device ID to the standard station 110 or to the connecting station 120. In this case, the history of the mobile wireless device 100 passing near the standard station 110 or the connecting station 120 is accumulated when the standard station 110 or the connecting station 120 stores the received device ID and the receiving time is stored as the intersecting history. The connecting station 120 may transmit the accumulated intersecting history data to the position estimation device 150 at an arbitrary timing. Also, the processing by the mobile wireless device 100 to transmit its own device ID (Step S1009) may be carried out before or after of the processing to request and receive the opponent device ID (Step S1003).

The resetting of the number of strides in Steps S1015 and S1019 is carried out at the place where the position is identified in the standard station position information at the position estimation device 150 (i.e. at the standard station 110 and the connecting station 120 in the above operation). As a result, the number of strides can be used as information to express how far it has moved from the point of intersecting with the standard station 110 or the connecting station 120 nearby. By assuming that the mobile wireless device 100 is moving at equal velocity, the intersecting point where the device has intersected the other mobile wireless device 100 can be estimated from the ratio of the moving distance (to the standard station 110 or to the connecting station 120) to the moving distance when it has intersected the mobile wireless device 100.

Although the position estimation device 150 in the second embodiment of the invention differs in the feature in that the stride number information is used instead of time information, it estimates position basically by using the same algorithm as that of the position estimation device 150 in the first embodiment of the invention. Specifically, the processing of position estimation in the second embodiment of the invention is the same as what is obtained by re-reading the parameter “time” as used in the first embodiment of the invention as “number of strides” (or the moving distance).

As described above, according to the second embodiment of the invention, the position estimation device 150 uploads the number of strides (or the moving distance) to a predetermined passing point and the number of strides to the point (i.e. the moving distance) and identification information of the opponent wireless device, where the mobile wireless devices 100 pass each other and number of strides (i.e. the moving distance) up to that point is uploaded to the position estimation device 150 via the connecting station 120 as the intersecting history data of each of the mobile wireless devices 100. As a result, the position estimation device 150 can estimate the position at an arbitrary time of each of the mobile wireless device 100.

Also, in the second embodiment of the invention, the mobile wireless devices 100 exchange own device IDs with each other, and the occurrence of intersecting or passing each other of the mobile wireless devices 100 remain as the intersecting history of both sides. Thus, it is possible to identify the time and the position of the same intersecting even (an event that they have intersected) by using two intersecting history data.

Next, description will be given below on a third and a fourth embodiments of the invention.

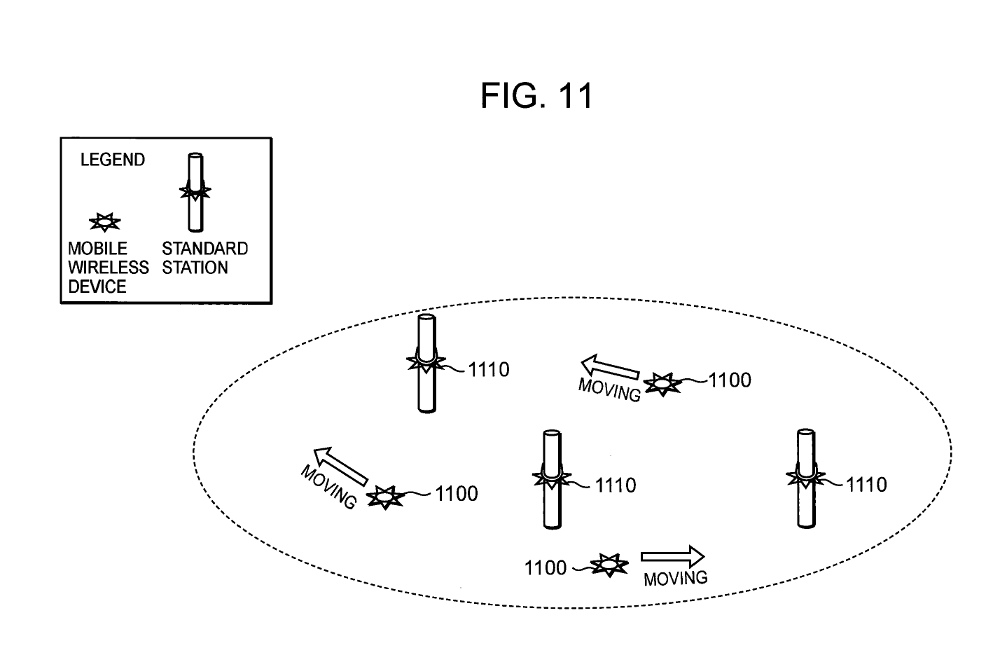

First, referring to FIG. 11, description will be given on the third and the fourth embodiments of the invention. FIG. 11 is a drawing to schematically show a system configuration common to the third and the fourth embodiments.

FIG. 11 shows a plurality of mobile wireless devices (portable type mobile wireless devices) 1100 and a plurality of standard stations 1110.

The mobile wireless device 110 has the function to exchange device ID (identification information to identify own device) with an opponent device (the other mobile wireless device 1100 or a standard station 1110). That is, the mobile wireless device 1100 can transmit its own device ID to the opponent device and also can receive the device ID of the opponent device. The mobile wireless device 110 can be moved together with a person or a moving object (such as a vehicle) and can exchange the device ID with the other mobile wireless device 1100 or the standard station 1110. Further, the mobile wireless device 1100 can deliver the device ID or position information of the standard station nearby where it has passed to the other mobile wireless device 110 where it intersects, and can receive device ID or position information of the standard station 1110 nearby where it passes nearby, and also can estimate its own position according to the device ID or the position information of the nearby standard station 1110 as received. When the mobile wireless device 110 receives the device ID of the standard station 1110 nearby (where it passes) from another mobile wireless device 1100, it must specify the position of the standard station 1110, which corresponds to its device ID.

The standard station 1110 is a device, which is fixedly installed at a predetermined place and it can perform the short distance wireless communication. The standard station 1110 has the function to transmit at least its own device ID to the mobile wireless device 110 passing nearby by the short distance wireless communication, and it may be so designed that, similarly to the case of the mobile wireless device 1100, it can receive and store the device ID of the opponent device (a mobile wireless device 110 passing nearby) by the short distance wireless communication and can store it.

It must be so arranged that the points to install all of the standard stations 1110 are placed under control so that the mobile wireless device 1100 can identify the places of installation of the standard stations 1110, which may be necessary to estimate its own position. The mobile wireless device 1100 may hold standard station position information including the places of installation of all of the standard stations 1110, and by performing communication with the standard station position information control unit, which grasps the places of installation of all of the standard stations 1110 via an arbitrary communication medium, necessary information (i.e. the place of installation of the standard station 1110 as desired) may be acquired. Also, it may be so designed that position information to indicate the place of installation can be acquired from the device ID of the standard station 1110 by placing a type of information to specify each of the places of installation to the device ID of each of the standard stations 1110, e.g. by setting numeral values to indicate latitude and longitude of the place of installation in the device ID of each of the standard stations 1110.

The place of installation of the standard station 1110 is expressed as a position data of an arbitrary form such as two-dimensional coordinates (i.e. latitude and longitude) or three-dimensional coordinates. Also, the standard stations 1110 need not be installed densely so that the communication ranges are overlapped with each other, and it would suffice if the stations are arranged in sparse condition where the communication ranges are separated from each other in a predetermined area (i.e. the range where the position of the mobile wireless device 1100 is to be estimated).

As described above, according to the present invention, the standard stations 1110 (with the places of installation fixed or known) to transmit own device IDs are arranged within a predetermined area. The mobile wireless device 1100 moving within the predetermined area passes near the standard station 1110, and it receives the device ID of the standard station 1110 and stores it as an intersecting history data. Further, when the mobile wireless device 1100 intersects another mobile wireless device 1100, it exchanges own device IDs or device ID of the standard station close nearby or position information on a position of the intersecting point with another mobile wireless device 1100 (the current position when position identification is immediately performed after the intersecting) based on position information of the standard station 1110 close nearby where it has passed or position information of the standard stations as received from another mobile wireless device 1100 (i.e. information of the standard station close nearby where the other mobile wireless device 1100 has intersected).

Based on the system configuration as described above, description will be given below on each of the third and the fourth embodiments of the invention.

### The Third Embodiment

First, description will be given on the third embodiment. In the third embodiment of the invention, description will be given on a case where a mobile wireless device 110 identifies its own position according to the time required when it has moved from a standard station 1110, of which the position is already known.

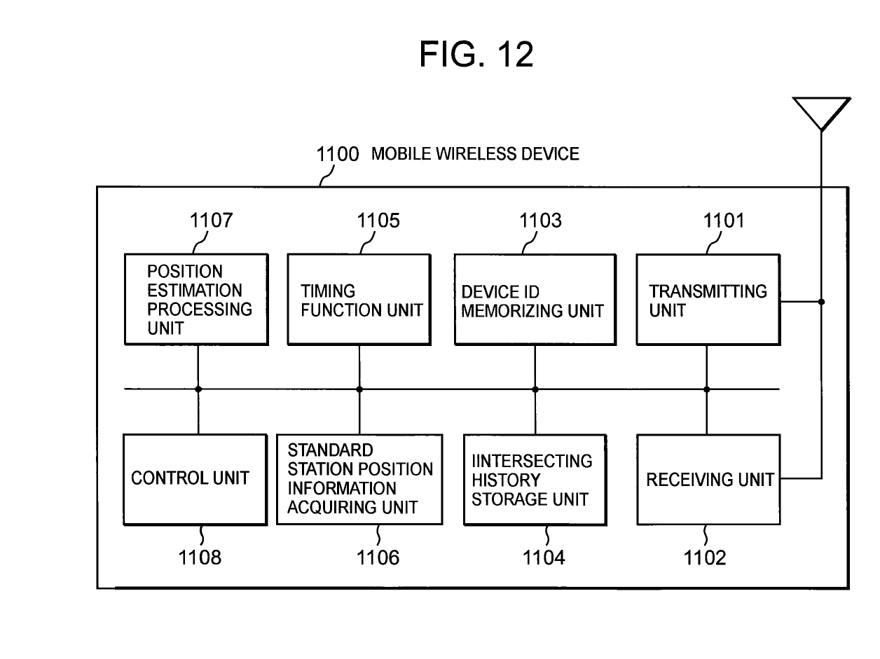

FIG. 12 shows an example of an arrangement of a mobile wireless device 1100 in the third embodiment of the invention. The mobile wireless device 1100 as shown in FIG. 12 comprises a transmitting unit 1101, a receiving unit 1102, a device ID memorizing unit 1103, an intersecting history storage unit 1104, a timing function unit 1105, a standard position information acquiring unit 1106, a position estimation processing unit 1107, and a control unit 1108. FIG. 12 shows a condition where these functional blocks are connected via internal bus.

The transmitting unit 1101 and the receiving unit 1102 have the functions to perform wireless communication with other wireless devices (other mobile wireless devices 1100 and standard stations 1110). In the present invention, the short distance wireless communication is applied to wireless communication technique to be used in the transmitting unit 1101 and the receiving unit 1102. The short distance wireless communication is a mode of wireless communication for short communication range of several tens of centimeters to several meters. For instance, communication technique of RFID (Radio Frequency Identification) can be used.

Also, in the device ID memorizing unit 1103, a device ID (identification information) specific to the mobile wireless device 1100 to identify the mobile wireless device 110 is stored in advance.

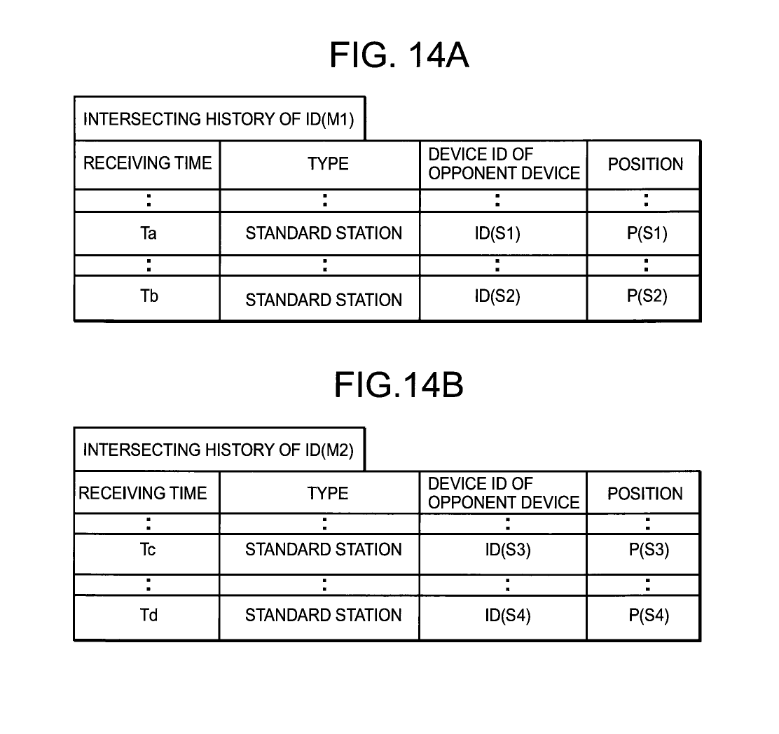

The intersecting history storage unit 1104 has the function to store the data received from another mobile wireless device 1100 or the standard station 1110, which it intersected, as an intersecting intersected history data. When passing nearby the standard station 1110, device ID or position information received from the standard station 1110, or device ID received from the mobile wireless device 1100 when it intersects another mobile wireless device 1100 or device ID or position information of a standard station 1110 located nearby, to which the mobile wireless device 1100 has intersected, are associated with time information obtained from the timing function unit 1105, and the results are stored in the intersecting history storage unit 1104 as an intersecting history data. On an example of the intersecting history data as stored in the intersecting history storage unit 1104, description will be given later by referring to FIG. 14A and FIG. 14B.

The timing function unit 1105 has the function to output the current time as time information. The time information outputted from the timing function unit 1105 is used when the intersecting history data is stored in the intersecting history storage unit 1104.

The standard station position information acquiring unit 1106 has the function to acquire the place of installation (position information) of the standard station 1110, which is required when position estimation processing is performed at the position estimating processing unit 1107. Any arbitrary method may be used as a method to acquire position information of the standard station 1110 by the standard station position information acquiring unit 1106. For instance, the standard station position information acquiring unit 1106 may refer to standard station position information of each of the standard stations 1110 stored in the mobile wireless device 1100 in advance and may acquire position information of the standard station 1110 as desired using the device ID as a key from the standard station position information of each of the standard stations 1110. Also, by requesting position information to the standard station 1110, which can communicate by the short distance wireless communication, position information may be received from the standard station 1110. Or, by using any arbitrary communication means, an inquiry on position information of the standard station 1110 as desired may be made to a predetermined standard station position information management device on a network (e.g. Internet). Further, it may be so arranged that position information of the standard station 1110 is included in the device ID of each of the standard stations 1110, and that the standard station position information acquiring unit 1106 acquires the position information of the device ID of the standard station 1110 as desired.

The position estimation processing unit 1107 has the function to calculate the present position (position of intersecting point to intersect another mobile wireless device 1100) of the mobile wireless device 1100 by referring to the intersecting history data stored in the intersecting history storage unit 1104. On a method to estimate the position by the position estimation processing unit 1107, description will be given later.

The control unit 1108 has the function to control processing of the mobile wireless device 1100. More concretely, the control unit 1108 controls processings such as: a processing to transmit device ID and other necessary information to outside (to the other wireless device) from the transmitting unit 1101, a processing to store an intersecting history data to the intersecting history storage unit 1104 by associating the data received from other wireless device with time information outputted from the timing function unit 1105, and a processing to control position estimation of the position estimation processing unit 1107.

The standard station 1110 in the third embodiment of the invention has the function to transmit device ID or position information given to this standard station 1110 to a mobile wireless device 1100, which passes nearby (within communication range of the short-distance wireless communication). Similarly to the case of the mobile wireless device 1100, the standard station 1110 may receive and store the device ID from the mobile wireless device 1100 passing nearby. As a result, a passing history of the mobile wireless device 110 passing nearby remains and is held at the standard station 1110.

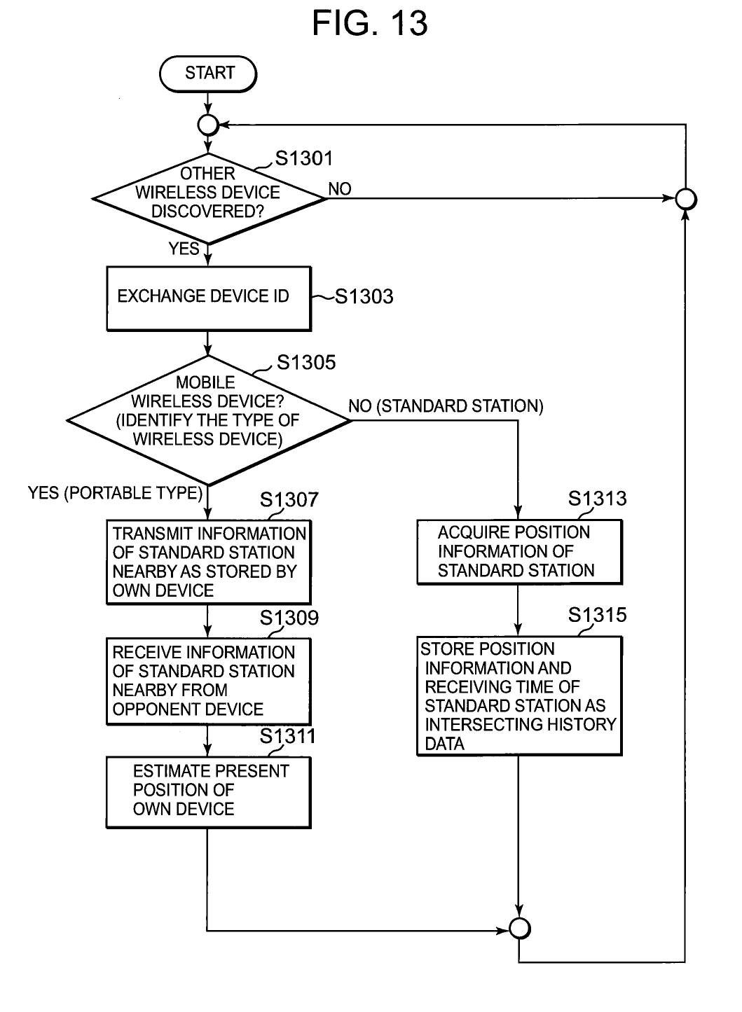

Next, referring to FIG. 13, description will be given on an example of operation of the mobile wireless device 1100 in the third embodiment of the invention. FIG. 13 is a flowchart to show an example of operation of a mobile wireless device 1100 in the third embodiment of the invention.

In FIG. 13, a mobile wireless device 1100 is monitoring whether the other wireless device (another mobile wireless device 1100 or a standard station 1110) is discovered or not (Step S1301). When the mobile wireless device 1100 moves and approaches to a point where communication can be performed with the other wireless device or when the other wireless device 110 approaches to a point where communication can be performed while this mobile wireless device 110 stops and does not move, the mobile wireless device 1100 discovers the other wireless device. Then, it requests the device ID to this wireless device and exchanges the device ID with the opponent device (the wireless device discovered) (Step S1303).

The mobile wireless device 1100 identifies the type of the wireless device, which has approached to the point where communication can be made. Specifically, the mobile wireless device 1100 identifies whether the opponent device is a portable type mobile wireless device 1100 or it is a standard station 1110, which is fixedly installed (Step S1305). Any method may be used to identify the type of the opponent device. For instance, it may so designed that a code to indicate type of each of the mobile wireless device 1100 and the standard station 1110 is included in the device ID so that the type can be identified from the device ID received in Step S1303.

In case the opponent device is of portable type, the mobile wireless device 1100 extracts information of the standard station close nearby (i.e. device ID or position information of the standard station close nearby) from its own intersecting history data and transmits this standard station information to the opponent device (Step S1307). The mobile wireless device 1100 receives the standard station information, which the opponent device has in memory (Step S1309). Then, the mobile wireless device 1100 performs processing to estimate the present position of own device (i.e. a point of intersecting with the opponent device) according to the standard station information close nearby as stored in its own intersecting history data (standard station information transmitted in Step S1307) and also according to the standard station information received from the opponent device (i.e. the standard station information received in Step S1309) (Step S1311). On an example of position estimation algorithm usable in Step 1311, detailed description will be given later. Here, the standard station information is received in Step S1309 after the standard station information is transmitted in Step S1307, while the order of transmission and receiving may be reverse.

On the other hand, in case the opponent device is a standard station 1110, the mobile wireless device 1100 acquires position information to indicate the place of installation of the standard station 1110 by the standard station position information acquiring unit 1107 (Step S1313). As described above, any method may be adopted to acquire position information by the standard station in the position information acquiring unit 1107. And, the data, which is acquired by associating the device ID and position information of this standard station 1110 with time information as outputted from the timing function unit 1104, is stored in the intersecting history storage unit 1105 as an intersecting history data (Step S1315). Of the intersecting history data stored in the intersecting history storage unit 1105, the data where the associated time information is the newest will be the information of the standard station close nearby.

When a processing of any of Steps S1311 or S1315 has been completed, the mobile wireless device 1100 returns to the state to monitor the other wireless device again (monitor processing in Step S1301).

Here, an example has been described on a case where the mobile wireless device 1100 does not transmit the device ID to the standard station 1110, while the mobile wireless device 1100 may transmit its own device ID to the standard station 1110 by carrying out the processing similar to the processing in Step S1307. In this case, the standard station 1110 stores the device ID received and the receiving time as an intersecting history. As a result, a history of the mobile wireless device 1100 passing in the vicinity of the standard station 1110 is stored.

In Step S1315, information elements as shown in FIG. 14A and FIG. 14B are included in the intersecting history data to be stored in the intersecting history storage unit 1105 of the mobile wireless device 1100. FIG. 14A and FIG. 14B show a first and a second examples of the intersecting history data respectively, which are maintained by the mobile wireless device in the third embodiment of the invention.

FIG. 14A shows intersecting history data of the mobile wireless device 1100, which has ID (M1) as the device ID. According to the moving history as shown in FIG. 14A, it is found that the mobile wireless device 1100, having ID (M1) as the device ID, has passed near the standard station 1110, which has ID (S1) as the device ID and its position is P (S1), at the time Ta, and it has passed near the standard station 1110, which has ID (S2) as the device ID and its position is P (S2) at the time Tb, and has received the device ID.

FIG. 14B shows intersecting history data of the mobile wireless device 1100 (which has ID (M2) as the device ID). According to the moving history shown in FIG. 14B, it is seen that the mobile wireless device 110, having ID (M2) as the device ID, has passed near the standard station 1110, which has ID (S3) as the device ID and its position is P (S3) at the time Tc and has received the device ID and has passed near the standard station 1110 (which has ID (S4) as the device ID) and at the position P (S4) and at the time Td, and has received the device ID.

In the intersecting history data shown in FIG. 14A and FIG. 14B, not only the information of the standard station 1110 close nearby but also the information of the standard station, which it has passes before, are stored. However, it would suffice that only the information relating to the standard station 1110 close nearby is stored. Also, the information acquired when it has intersected the mobile wireless device 1100 (i.e. the device ID of another mobile wireless device 1100, or the device ID or position information of the standard station 1110 close nearby where another mobile wireless device 1100 has passed) may be stored in the intersecting history data. In FIG. 14A and FIG. 14B, it is shown that device ID and position information are included as information elements stored in the intersecting history data, while it may be so designed that the matching relationship between the device ID and the position information can be identified by the standard station position information, to which the standard station position information acquiring unit 1106 can refer.

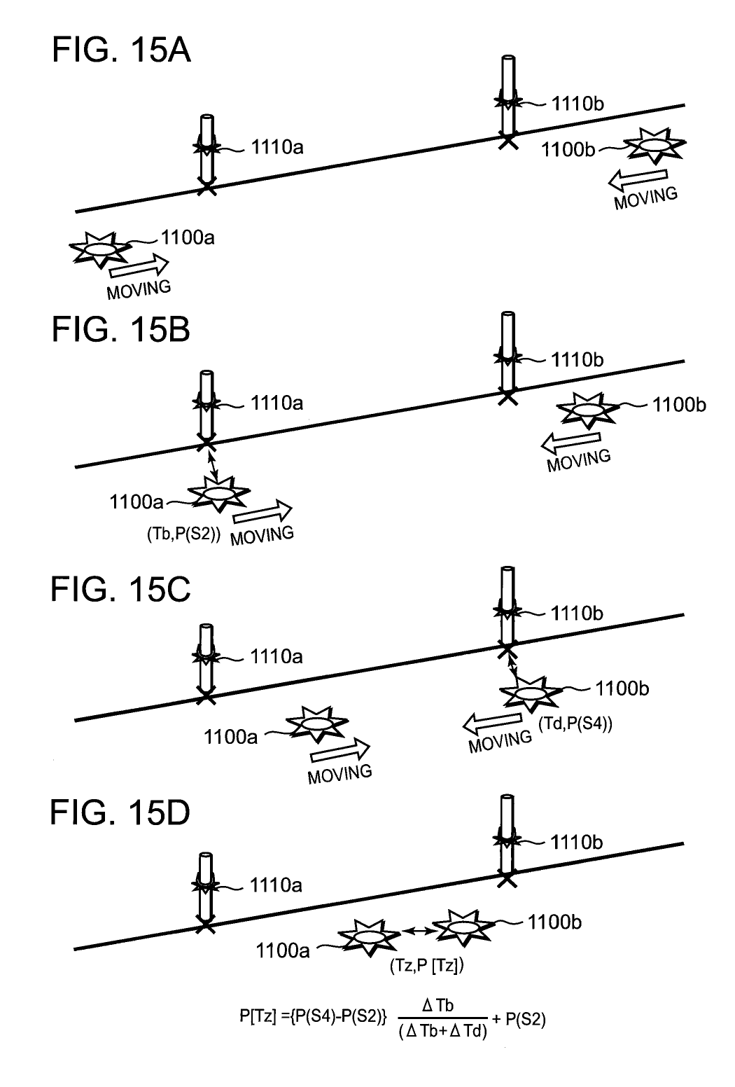

Next, referring FIG. 15A to FIG. 15D, description will be given on algorithm of position estimation processing (which corresponds to the processing in Step S1311 of FIG. 13) to be carried out by the position estimation processing unit 1107 in the third embodiment of the invention. In FIG. 15A to FIG. 15D, the condition where two mobile wireless devices 1100a and 1100b, which are moving separately, are positioned at separated places and in the conditions where these two pass each other are shown in time series.

FIG. 15A shows initial condition where two mobile wireless devices 1100a and 1100b are moving at the positions separated from each other. Also, FIG. 15B shows the condition where time has elapsed from the condition of FIG. 15A and one mobile wireless device 1100a passes near the standard station 1110a (which has ID (S2) as the device ID), and the intersecting history data regarding to the standard station 1110a is stored. In FIG. 15B, the mobile wireless device 1100a passes near the standard station 1110a (which has ID (S2) as the device ID) and has its position at P (S2) at the time Tb, and the intersecting history data is stored at the time Tb as shown in FIG. 14A.

FIG. 15C shows the condition where time has elapsed from the condition of FIG. 15B, and the other mobile wireless device 1100b has passed near the standard station, which has ID (S4) as the device ID, and stores the intersecting history data relating to the standard station 1110b. In FIG. 15C, the mobile wireless device 1100b passes near the standard station 1110b, which has ID (S4) as the device ID and has its position at P (S4), and the intersecting history data as specified at the time Td as shown in FIG. 14B is stored.

FIG. 15D shows the condition where time has elapsed from the condition of FIG. 15C, and two mobile wireless devices 1100a and 1100b come closer to each other and exchange the intersecting history data (information of the standard station close nearby). In FIG. 15D, the mobile wireless devices 1100a and 1100b intersect each other at the time Tz.

In this case, the mobile wireless device 1100a can calculate, for instance, its own position at the time Tz according to information of the standard station nearby as held by itself and also to information of the standard station nearby as received from another mobile wireless device 1100b. More concretely, it is possible to obtain a position P [Tz] of the mobile wireless device 1100a (or the mobile wireless device 1100b) at the time Tz according to the equation (1) as given below from the elapsed time ΔTb=Tz−Tb after it has passed the position P (S2) of the standard station where the mobile wireless device 1100a has passed nearby and the position P (S4) of the standard station where another mobile wireless device 1100b has passes nearby and from the time elapsed after the passing ΔTd=Tz−Td:

P[Tz]={P(S4)−P(S2)}×ΔTb/ΔTb+ΔTd)+P(S2) Equation (1)

In the mobile wireless device 1100b, it is also possible to obtain the position P [Tz] where it has intersected the mobile wireless device 1100b, similarly by using the above equation (1). Further, when the equation (2) as given below is used instead of the above equation (1), it is possible to obtain position P [Tz] of the mobile wireless device 1100a (or the mobile wireless device 1100b) at the time Tz.

P[Tz]={P(S2)−P(S4)}×ΔTd/(ΔTb+ΔTd)+P(S4) Equation (2)

In the equations (1) and (2) as given above, the intersecting point of the mobile wireless devices 1100a and 1100b is estimated by assuming that the mobile wireless devices 1100a and 1100b move at equal velocity along a straight line, which connects the positions of the standard stations close nearby. However, the intersecting point may be determined from the estimated loci of moving of the mobile wireless devices 1100a and 1100b by giving consideration not only on the positions of the standard stations close nearby but also on the positions of the standard station where the mobile wireless devices 1100a and 1100b have passed before. Also, by giving consideration on map data including information on roads, facilities, etc., the locus of moving may be estimated when two mobile wireless devices 1100a and 1100b move along roads or passages.

As described above, according to the third embodiment of the invention, by exchanging information to specify the position of the standard station 1110 passing nearby where the intersecting mobile wireless devices 1100 intersect or information of the time required from the standard station 1110 nearby to the present position, it is possible to estimate the position of the intersecting point with another mobile wireless device 1100 (the present position in case the position is identified promptly after intersecting).

### The Fourth Embodiment

Next, description will be given on the fourth embodiment of the invention. In the fourth embodiment, description will be given on a case where the mobile wireless device 1100 identifies its own position according to the number of strides required in the moving from the standard station 1110, of which the position is already known.

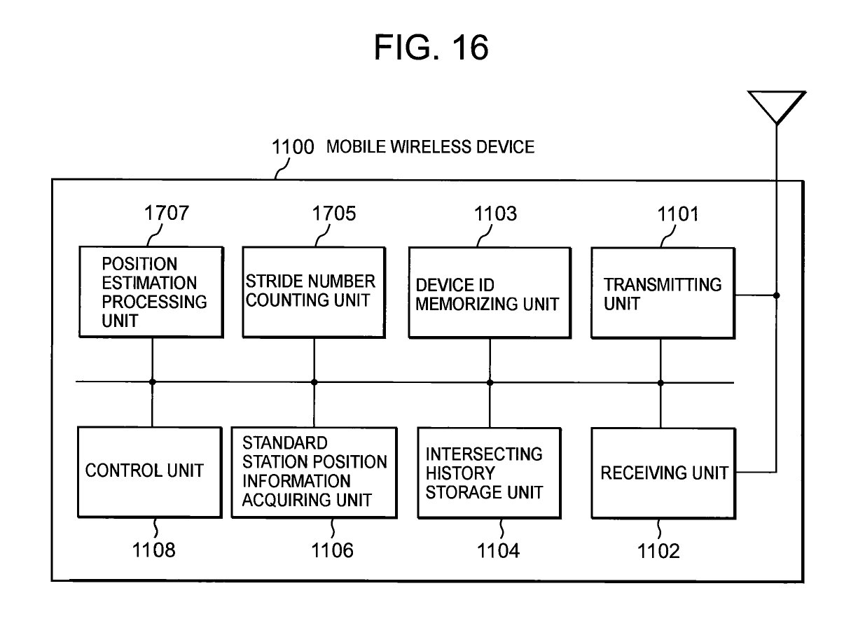

FIG. 16 shows an example of an arrangement of a mobile wireless device 1100 in the fourth embodiment of the invention. The mobile wireless device 1100 as shown in FIG. 16 comprises a transmitting unit 1101, a receiving unit 1102, a device ID memorizing unit 1103, an intersecting history storage unit 1104, a stride number counting unit 1605, a standard station position information acquiring unit 1106, a position estimation processing unit 1607, and a control unit 1108. FIG. 16 schematically shows the condition where these functional blocks are connected via internal bus.

As it is evident by comparing this with the arrangement shown in FIG. 12, the mobile wireless device 1100 in the fourth embodiment of the invention has a stride number counting unit 1605 instead of the timing function unit 1105. The stride number counting unit 1605 has the function to count the number of strides of a person, who moves with the mobile wireless device 1100. By adding up average length of stride of the moving person to the number of strides as counted, approximate moving distance can be calculated. The number of strides (corresponding to the moving distance) as counted by the stride number counting unit is used when the intersecting history is recorded. Specifically, according to the fourth embodiment of the invention, the number of strides (or the moving distance) is associated instead of the time (receiving time) and stored in the intersecting history data to be stored when device ID is received from the standard station 1110.

Here, as the means to obtain the moving distance, the stride number counting unit 1605 is used, which is simple in construction and easy to install, while any means for the measurement of the moving distance can be provided. For instance, a functional device to measure the moving distance such as the one installed on a vehicle or the like can be used for the measurement of the moving distance.

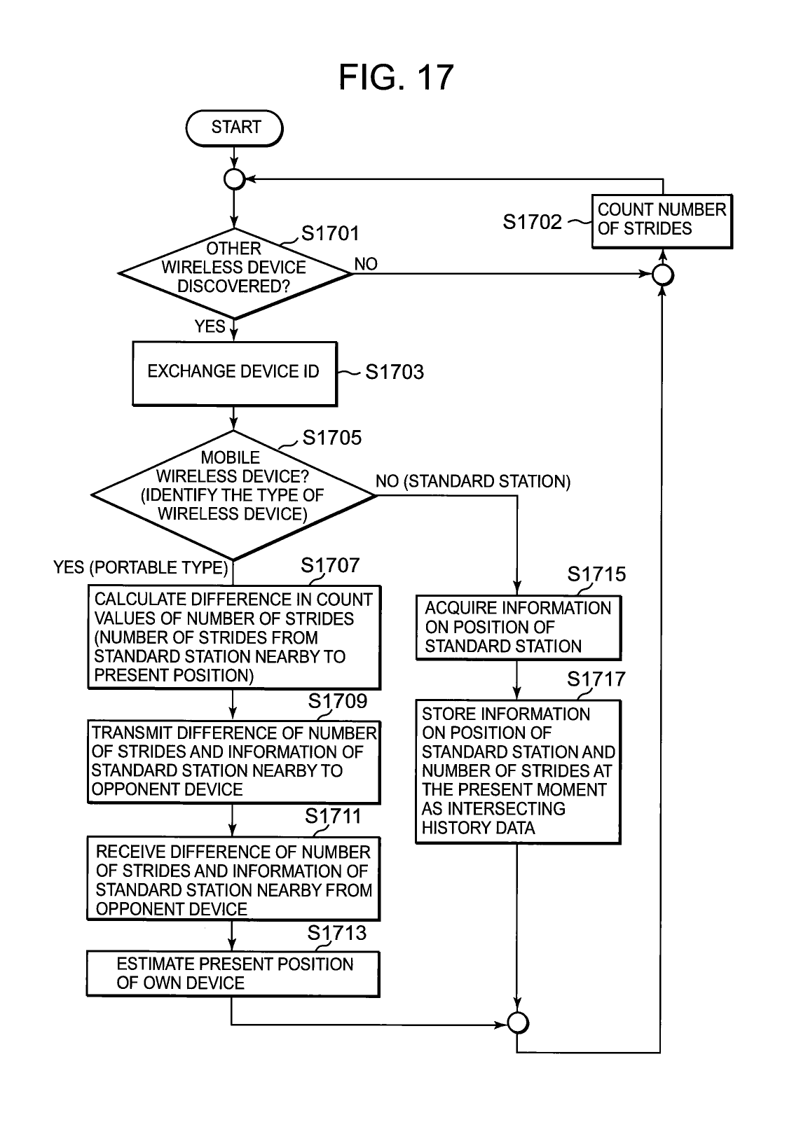

Similarly to the third embodiment of the invention, the position estimation processing unit 1607 has the function to calculate a position of an intersecting point with another mobile wireless device 1100 (the present position when the position is identified promptly after the intersecting) by referring to the intersecting history data stored in the intersecting history storage unit 1104. However, in the fourth embodiment, the position estimation algorithm to be used is different because information of the number of strides (or the moving distance) is associated with the intersecting history data. On the position estimation algorithm in the fourth embodiment of the present invention, description will be given later by referring to FIG. 17.

The other functions shown in FIG. 16 (i.e. the functions of the transmitting unit 1101, the receiving unit 1102, the device ID memorizing unit 1103, the intersecting history storage unit 1104, the standard station position information acquiring unit 1106, and the control unit 1108) are basically the same as those shown in FIG. 12, and detailed description is not given here.

Next, referring to FIG. 17, description will be given on an example of operation of the mobile wireless device 1100 in the fourth embodiment of the invention. FIG. 17 is a flowchart to show an example of operation of the mobile wireless device 1100 in the fourth embodiment of the invention.

In FIG. 17, the mobile wireless device 1100 monitors whether the other wireless device (other mobile wireless device 1100 or the standard station 1110) is discovered or not (Step S1701). When the mobile wireless device 110 moves and approaches to a point where communication can be made with the other wireless device or when the mobile wireless device 1100 approaches to a point where communication can be performed while the mobile wireless device 110 does not move and stops, the mobile wireless device 1100 discovers the other wireless device and requests this wireless device to give the device ID and exchanges the device ID with the opponent device (i.e. the wireless device discovered) (Step S1703). The mobile wireless device 1100 constantly counts the number of strides (the moving distance) while it is moving (Step S1702).

The mobile wireless device 1100 identifies the type of the wireless device, which approaches to the point where communication can be performed. That is, the mobile wireless device 1100 identifies whether the opponent device is a portable type mobile wireless device 1100 or it is a standard station 1110, which is fixedly installed (Step S1705). Any method may be adopted to identify the type of the opponent device. For instance, it may so arranged that a code, which indicates the type of each of the mobile wireless device 1100, the standard station 1110 or the connecting station 1120, is included in the device ID so that the type can be identified from the device ID received in Step S1703.

In case the opponent device is of portable type, the mobile wireless device 1100 extracts a count value of the number of strides associated with the information of the standard station nearby (i.e. device ID or position information of the standard station 1110 close nearby) from its own intersecting history data (i.e. a count value of the number of strides associated in Step S1717 as to be described later). Then, it acquires the count value of the number of strides outputted from the stride number counting unit 1605 at the current moment, and calculates the difference of these count values (Step S1707). The difference of the number of strides calculated in Step S1707 can be used as information on the number of strides (information on the moving distance) from the standard station close nearby 1110 (which the mobile wireless device 110 has passed) to the present position.

The mobile wireless device 1100 transmits the difference of the number of stride as calculated in Step S1707 and standard station information of the standard station close nearby 1110 to the opponent device (Step S1709). Also, the mobile wireless device 1100 receives the difference of the number of strides and the standard station information as transmitted from the opponent device in similar manner (Step S1711). Then, the mobile wireless device 1100 performs processing to estimate the present position of own device (i.e. the point where it has intersected the opponent device) according to information of the standard station nearby as stored in its own intersecting history data and the number of strides counted in Step S1709 (i.e. standard station information and the number of strides transmitted in Step S1709) and also to the standard station information and the number of strides received from the opponent device (i.e. the standard station information and the number of strides received in Step S1711) (Step S1713). On an example of position estimation algorithm usable in Step S1713, detailed description will be given later.

On the other hand, in case the opponent device is the standard station 1110, the mobile wireless device 1100 acquires position information to indicate the place of installation of the standard station 1110 by the standard station position information acquiring unit 1107 (Step S1715). As described above, any method may be adopted to acquire position information by the standard station position information acquiring unit 1107. Then, the data associated with the device ID and position information of this standard station 1110 and information on the number of strides outputted from the stride number counting unit 1604 at the current moment are stored in the intersecting history storage unit 1105 as an intersecting history data (Step S1717). Among the intersecting history data stored in the intersecting history storage unit 1105, the data with the highest count value of the number of strides is the information on the standard station close nearby. When the intersecting history data is stored, by recording the time of this moment at the same time, the information of the standard station nearby (with the newest time information) can be easily identified.

When the processing of either one of Steps S1713 or S1717 has been completed, the mobile wireless device 110 returns to the condition where it monitors the other wireless device (i.e. monitoring processing in Step S1701; processing to count the number of strides in Step S1702) again.

Here, an example is taken on a case where the mobile wireless device 1100 does not transmit the device ID to the standard station 1110, while it may so arranged that the mobile wireless device 1100 performs processing similar to the processing of Step S1709 so that its own device ID is transmitted to the standard station 1110. In this case, by storing the device ID and the receiving time as received by the standard station 1110 as an intersecting history, the history of the mobile wireless device 110 passing near the standard station 1110 is stored.

Next, description will be given on an algorithm of position estimation processing (corresponding to the processing in Step S1713 of FIG. 17) to be performed at the position estimation processing unit 1607 in the fourth embodiment of the invention. The position estimating processing is basically the same as the case where parameters used in the third embodiment of the invention, i.e. “time” and “number of strides (or the moving distance)” are re-read as appropriate.

Description will be given below on a case where the conditions shown in FIG. 15A to FIG. 15D are applied to the fourth embodiment of the invention. Here, it is supposed that the position of the standard station where the mobile wireless device 1100a has passed close nearby is P (S2), that a count value of the number of strides when it has passed by is Cb, and that a count value of the number of strides when the other mobile wireless device 1100b has intersected is Cv. Further, it is supposed that position of a standard station where the mobile wireless device 1100b has passed nearby is P (S4), that a count value of the number of strides when it has passed nearby is Cd, and that a count value of the number of strides when it has intersected another mobile wireless device 1100a is Cw, and these are expressed as: ΔCb=Cv−Cb; and ΔCd=Cw−Cd. Then, a position P of the intersecting point of each of the mobile wireless devices 1100a and 1100b can be obtained from the equation (3) or the equation (4) as given below:

P={P(S4)−P(S2)}×ΔCb/(ΔCb+ΔCd)+P(S2) Equation (3)

P={P(S2)−P(S4)}×ΔCd/(ΔCb+ΔCd)+P(S4) Equation (4)

In the equations (3) and (4), the intersecting point of each of the mobile wireless devices 1100a and 1100b is estimated by assuming that the mobile wireless devices 1100a and 1100b move at the same velocity along a straight line, which connects positions of the standard stations located close nearby, while it may so arranged that loci of moving of the mobile wireless devices 1100a and 1100b are estimated and the intersecting point is obtained from the estimated loci of moving by giving consideration on the position of the standard station where not only the standard station close nearby but also the mobile wireless devices 110a and 1100b have passed before that moment. By taking map data including information such as roads, facilities, etc. into account, the loci of moving may be estimated so that the two mobile wireless devices 1100a and 1100b move along the roads or passages.

As described in the above, according to the fourth embodiment of the invention, the mobile wireless devices 100 passing each other exchange the information to identify the position of the standard station 1110 passing close nearby or information on the number of strides when moving from the standard station nearby 1110 to the present position (i.e. information on the moving distance), a position of the intersecting point with another mobile wireless device 1100 (the current position in case the position is identified promptly after the intersecting) can be estimated.

### The Fifth Embodiment

Next, description will be given on a fifth embodiment of the invention.

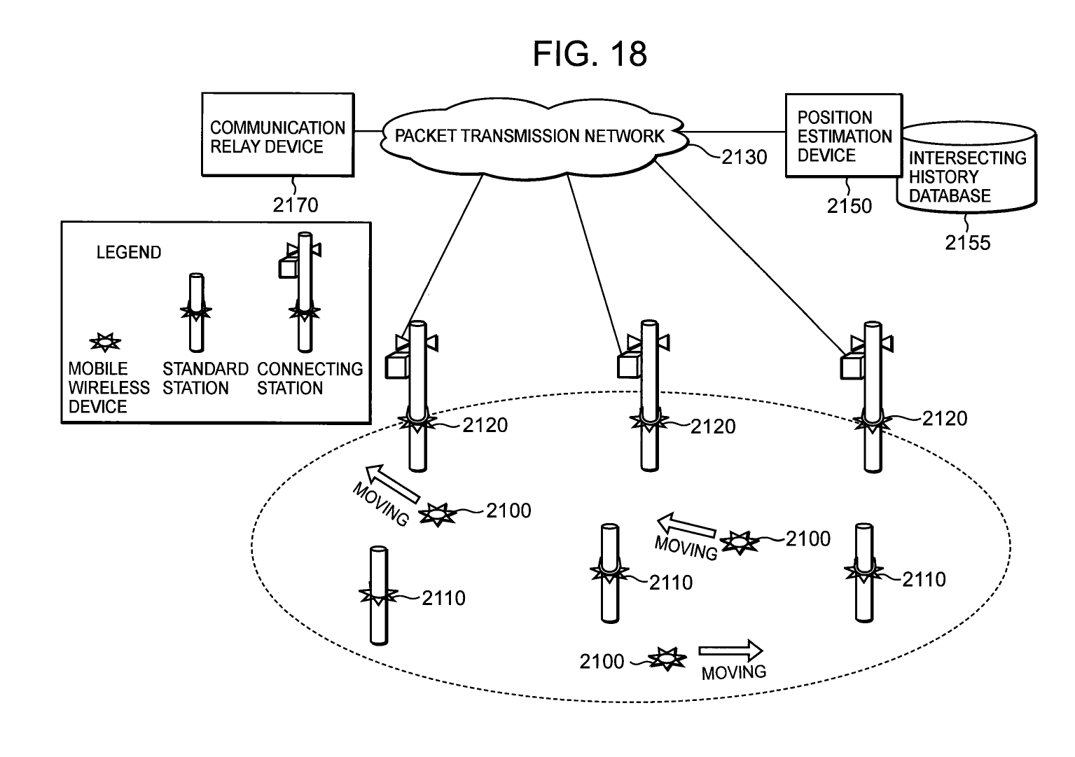

First, referring to FIG. 18, description will be given on a system configuration in the fifth embodiment of the invention. FIG. 18 is a schematical drawing to show the system configuration in the fifth embodiment of the invention.

FIG. 18 shows a plurality of mobile wireless devices (portable type mobile wireless devices) 2100, a plurality of standard stations 2110, a plurality of connecting stations 2120, a packet transmission network 2130, a position estimation device 2150, an intersecting history database 2155, and a communication relay device 2170.

The mobile wireless device 2100 has the function to exchange device ID (identification information to identify own device) by performing the short distance wireless communication to and from an opponent device (the other wireless device). Specifically, the mobile wireless device 2100 transmits its own device ID to the opponent device and can receive the device ID of the opponent device and store it. The mobile wireless device 2100 moves together with a person or a moving object (such as a vehicle) and can exchange the device ID with another mobile wireless device, the other standard station 2110 or the connecting station 2120, which it has intersected at the mobile destination. Further, when it is possible to perform communication with the connecting station 2120, the mobile wireless device 2100 has the function to upload the intersecting history data including the history of intersecting with the other wireless device in the position estimation device 2150 on a packet transmission network 2130, to which it can gain access via the connecting station 2120. Also, the mobile wireless device 2100 can perform communication to and from the other communication device (e.g. other mobile wireless device 2100). In this case, the mobile wireless device 2100 describes the device ID of the communication correspondent on a packet, which it wants to transmit to the other communication device.

The standard station 2110 is a device, which is fixedly installed at a predetermined position. The standard station has the function to transmit at least its own device ID to an opponent device (i.e. a mobile wireless device 2100 passing nearby). Further, it may be so designed that, similarly to the mobile wireless device, the device ID of the opponent device (i.e. a mobile wireless device 2100 passing nearby) can be received and stored. An operator for controlling the entire system must be able to identify places of installation of all of the standard stations 2110. The place of installation of the standard station 2110 is stored in the standard station position information storage unit 2153 of the position estimation device 2150 (to be described later) as position data in any arbitrary form such as two-dimensional coordinates (e.g. latitude and longitude) or three-dimensional coordinates. The standard stations 2110 need not be installed densely so that the communication ranges are overlapped on each other, and these standard stations may be positioned in the condition that they have communication ranges separated from each other (in sparse condition) within a predetermined area (i.e. a range where positions of the mobile wireless devices 21 are to be estimated).

The connecting station 2120 is a device, which is connected to a predetermined external network (shown as a packet transmission network 2130 in FIG. 18), and it has the function as a relay device when the mobile wireless device 2100 uploads data to the position estimation device 2150 on the packet transmission network 2130. The connecting station 2120 may have the function as a standard station—not only to have the function as a gateway to transmit its own device ID, but also the function as a standard station to transmit its own device ID (and further, to receive the device ID from the opponent device and to store it). The connecting station 2120 also has the function as a relay device to relay a packet, which is transmitted and received in the communication between the mobile wireless devices 2100 themselves or between the mobile wireless device 2100 and other communication device.

The position estimation device 2150 has the function to receive data to be transferred from the connecting station 2120 via the packet transmission network 2130 (i.e. the intersecting history data uploaded by the mobile wireless device 2100) and stores the data in the received data in the intersecting history database 2155, and if necessary, to perform position estimation processing by using the data stored in the intersecting history database 2155. The position estimation processing is performed upon inquiry from the communication relay device 2170, for instance. Using the device ID of the mobile wireless device 2100 including an inquiry message from the communication relay device 2170 as a key, the present position of the mobile wireless device 2100 as specified by the device ID is estimated by using the data stored in the intersecting history database 2155, and the present position thus estimated is sent to the communication relay device 2170. Also, the packet transmission network 2130 can use any arbitrary network such as a special-purpose network or a public network (e.g. Internet).

As described above, according to the present invention, the standard station 2110 to transmit its own device ID is installed within a predetermined network (the place of installation fixed and known) and the connecting station 2120 is disposed, which is connected to the packet transmission network 2130, through which communication can be performed to and from the position estimation device 2150. On the other hand, the mobile wireless device 2100 moving within the predetermined area exchanges its own device ID when it intersects the other mobile wireless device 2100, and when it passes nearby the standard station 2110, it receives and stores the device ID of the standard station 2110. As a result, the device ID of the other mobile wireless device 2100, which it has intersected, or the device ID of the standard station 2110 where it has passed nearby, is stored as the intersecting history data.

When the mobile wireless device 2100 passes near the connecting station 2120, intersecting history data of a plurality of mobile wireless devices 2100 moving within the predetermined area are stored in the intersecting history database 2155 of the position estimation device 2150 by uploading the intersecting history data to the position estimation device 2150 via the connecting station 2120. Then, by using the intersecting history data, the position of the mobile wireless device 2100 moving within the predetermined area can be estimated.

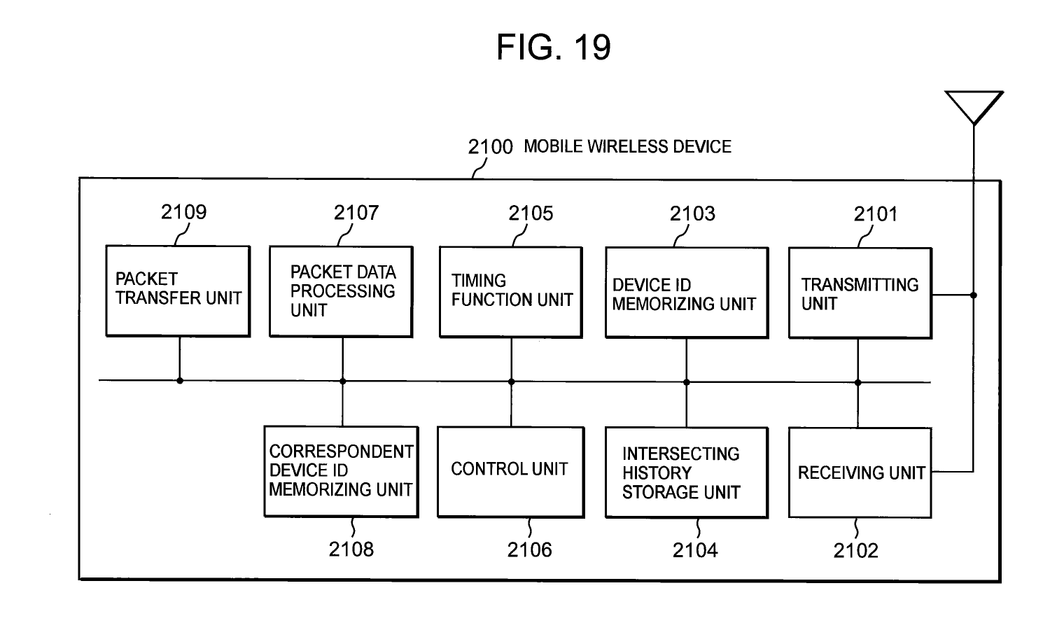

FIG. 19 shows an example of an arrangement of the mobile wireless device 2100 in the fifth embodiment of the invention. The mobile wireless device 2100 shown in FIG. 19 comprises a transmitting unit 2101, a receiving unit 2102, a device ID memorizing unit 2103, an intersecting history storage unit 2104, a timing function unit 2105, a control unit 2106, a packet data processing unit 2107, a communication correspondent device ID memorizing unit 2108, and a packet transfer unit 2109. FIG. 19 schematically shows the conditions where these functional blocks are connected via internal bus.

The transmitting unit 2101 and the receiving unit 2102 have the functions to perform wireless communication to and from other wireless devices (i.e. another mobile wireless device 2100, a standard station 2110, and a connecting station 2120). In the present invention, the short distance wireless communication is applied to wireless communication technique used at the transmitting unit 2101 and the receiving unit 2102. The short distance wireless communication is a wireless communication having short distance communication range of several tens of centimeters to several meters. For example, communication technique of RFID (Radio Frequency Identification) can be used.

In the device ID memorizing unit 2103, a device ID (identification information) specific to each mobile wireless device 2100 is stored to identify the mobile wireless device 2100.

The intersecting history storage unit 2104 has the function to store the device ID received from another mobile wireless device 2100, which it has intersected, or the device ID received from a standard station 2110. In the fifth embodiment of the present invention, these device IDs are associated with time information obtained from the timing function unit 2105 and are stored.

The timing function unit 2105 has the function to output the current time as time information. The time information outputted from the timing function unit 2105 is associated with a device ID received from another mobile wireless device 2100, which has intersected, or with the device ID received from a standard station 2110.

The control unit 2106 has the function to control processing of the mobile wireless device 2100. More concretely, the control unit 2106 controls the following types of processing: a processing to transmit device ID from the transmitting unit 2101 to outside (the other wireless device), a processing to store the device ID received from the other wireless device by associating with time information outputted from the timing function unit 210 and to store the device ID in the intersecting history storage unit 2104, and a processing to transmit intersecting history data to the position estimation device 2150 via the connecting station 2120.

The packet data processing unit 2107 has the function to generate a packet to be transmitted or to perform processing on the received packet when communication is performed with a correspondent communication device (e.g. the other mobile wireless device 2100). The packet data processing unit 2107 carries out processing to read a device ID to identify the corresponding mobile wireless device 2100 from the correspondent device ID memorizing unit 2108 and adds it to the packet to be transmitted to the other mobile wireless device 2100.

In the correspondent device ID memorizing unit 2108, a device ID (identification information) to identify the correspondent mobile wireless device 2100 is stored. The device ID to identify the correspondent mobile wireless device 2100 may be stored at any timing as desired. For instance, the device ID of the correspondent mobile wireless device 2100 may be stored in advance, or the device ID of the correspondent mobile wireless device 210 may be acquired and stored at the moment when communication to and from the mobile wireless device 210 has been started.

The packet transfer unit 2109 has the function to temporarily keep a packet, which is to be transmitted and received by the other mobile wireless device 2100 and to transfer the packet by delivering it to another mobile wireless device 2109 or to a connecting station 2120.

The standard station 2110 in the fifth embodiment of the present invention has the function to transmit a device ID given to the standard station 2100 to a mobile wireless device 2100, which passes nearby. Similarly to the case of the mobile wireless device 2100, the device ID may be received from the mobile wireless device 2100 passing nearby and may be stored. As a result, the passing history of the mobile wireless device 2100, which passed nearby, remains and is kept at the standard station 2110.

The connecting station 2120 in the fifth embodiment of the invention has the function to relay the intersecting history data to be transmitted to the position estimation device 2150 on the packet transmission network 2130 from a mobile wireless device 2100, which is present in the vicinity. The connecting station 2120 may have the function similar to that of the standard station 2110 as given above. That is, the connecting station 2120 may have the function to transmit its own device ID, or further, it may have the function to receive the device ID from the mobile wireless device 2100 and to store it. When the connecting station 2120 transmits its own device ID similarly to the case of the standard station 2110, the place of installation of this connecting station 2120 must be identified at the position estimation device 2150.

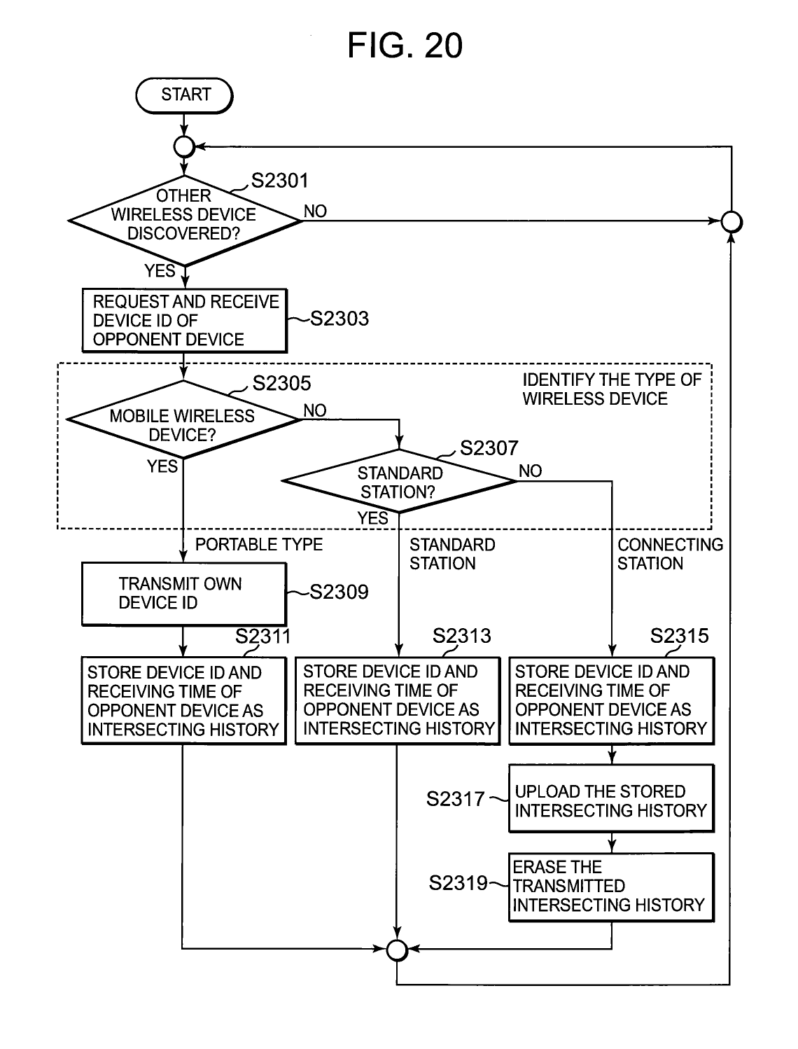

Next, referring to FIG. 20, description will be given on an example of position registering operation of the mobile wireless device 2100 in the fifth embodiment of the invention. FIG. 20 is a flowchart to show an example of position registering operation of the mobile wireless device 2100 in the fifth embodiment of the invention.

In FIG. 20, the mobile wireless device 2100 monitors whether the other wireless device (either one of another mobile wireless device 2100, a standard station 2110, or a connecting station 2120) is discovered or not (Step S2301). When the mobile wireless device 2100 moves and approaches to a point where communication can be performed to and from the other wireless device, or when another mobile wireless device 2100 has approached to a point where communication can be performed while the mobile wireless device 2100 does not move and stops at the same position, the mobile wireless device 2100 discovers the other wireless device, requests this wireless device to inform the device ID and receives the device ID of opponent device (i.e. the wireless device discovered) (Step S2303).

The mobile wireless device 2100 identifies the type of the wireless device, which has approached to a point where communication can be performed. Specifically, the mobile wireless device 2100 identifies as to which category of either a portable type mobile wireless device 2100 or a standard station 2110 or a connecting station 2120 the opponent device belongs (Steps S2305 and S2307). Any method may be adopted to identify the type of the opponent device. For instance, it may be so arranged that a code to indicate the type of either the mobile wireless device 2100, or the standard station 2110, or the connecting station 2120 is included in the device ID so that the type can be identified from the device ID received in Step S2303.

When the opponent device is of portable type, the mobile wireless device 2100 transmits its own device ID to the opponent device (Step S2309). The mobile wireless device 2100 associates the device ID received in Step S2303 with the receiving time (i.e. information of the current time as outputted from the timing function unit 2105), and the result is stored in the intersecting history storage unit 2104 as an intersecting history data (Step S2311).

In case the opponent device is a standard station 2110, the mobile wireless device 2100 associates the device ID received in Step S2303 with the time of receiving (i.e. information on the current time as outputted from the timing function unit 2105) and the result is stored in the intersecting history storage unit 2104 as an intersecting history data (Step S2313).

When the opponent device is a connecting station 2120, the mobile wireless device 2100 associates the device ID received in Step S2303 with the time of receiving (i.e. information on the current time as outputted from the timing function unit 2105), and the result is stored in the intersecting history storage unit 2104 as an intersecting history data (Step S2315). Further, the mobile wireless device 2100 uploads the intersecting history data stored in the intersecting history storage unit 2104 to the position estimation device 2150 on the packet transmission network 2130 via a connecting station 2120 (Step S2317), and erases the uploaded and transmitted intersecting history data from the intersecting history storage unit 2104 (Step S2319).

When the processing in either one of Steps S2311, S2313, or S2319 has been completed, the mobile wireless device 2100 returns to the condition to monitor the other wireless devices (monitor processing in Step S2301).

In the above, an example is taken on a case where the mobile wireless device 2100 does not transmit the device ID to the standard station 2110 or to the connecting station 2120, while the mobile wireless device 2100 may perform the same processing as in Step S2309 and may transmit its own device ID to the standard station 2110 or to the connecting station 2120. In this case, the standard station 2110 or the connecting station 2120 stores the received device ID or the time of receiving as an intersecting history data. As a result, the history data of the mobile wireless device 2100, which has passed near the standard station 2110 or the connecting station 2120 is stored. The connecting station 2120 may transmit the stored intersecting history data to the position estimation device 2150 at any timing (Step S2309). The processing of the mobile wireless device 2100 to transmit its own device ID (Step S2309) may be performed before or after the processing to request and receive the opponent device ID (Step S2303).

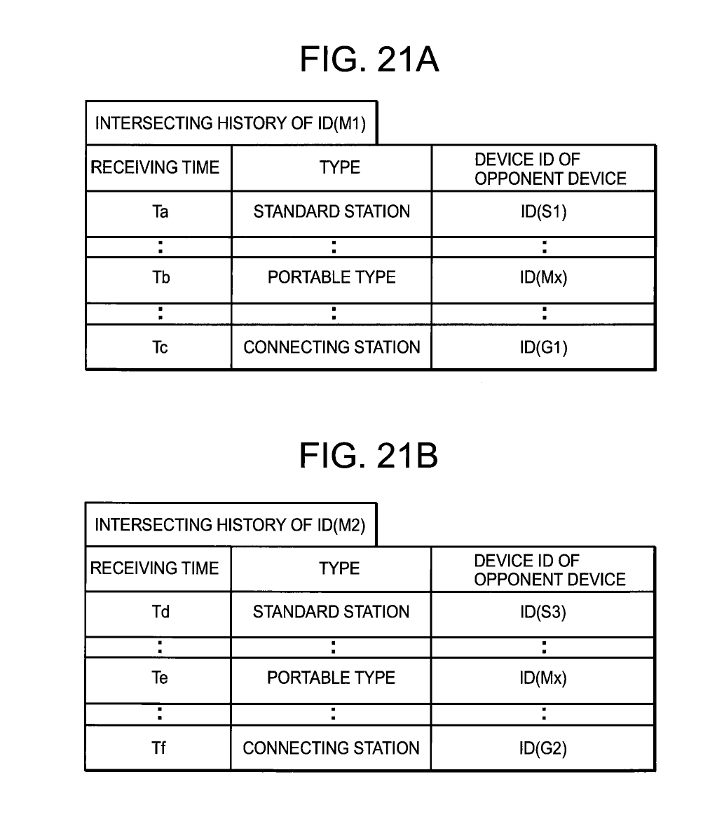

In the intersecting history data uploaded to the position estimation device 2150 from the mobile wireless device 2100 in Step S2317, information elements as shown in FIG. 21A or FIG. 21B are included. FIG. 21A and FIG. 21B represent a first example and a second example respectively of the intersecting history data received from the mobile wireless device by the position estimation device in the fifth embodiment of the invention.

FIG. 21A shows the intersecting history data of the mobile wireless device 2100 (which has ID (M1) as the device ID). From the moving history shown in FIG. 21A, it can be seen that a mobile wireless device 2100 (which has ID (M1) as the device ID) has passed near a standard station 2110 (which has ID (S1) as the device ID) at the time Ta and receives the device ID. It has intersected a mobile wireless device (portable type) 2100 (which has ID (Mx) as the device ID) at the time Tb and receives the device ID. Then, it can be seen that it has passed near a connecting station 2120 (which has ID (G1) as the device ID) at the time Tc and has received the device ID, and that it has uploaded the intersecting history data via the connecting station 2120.

FIG. 21B shows intersecting history data of a mobile wireless device 2100 (which has ID (M2) as the device ID). According to the moving history shown in FIG. 21B, it is seen that a mobile wireless device 2100 (which has ID (M2) as the device ID) has passed near a standard station 2110 (which has ID (S3) as the device ID) at the time Td and has received the device ID. Then, it can be seen that it has intersected a mobile wireless device (portable type) 2100 (which has ID (Mx) as the device ID) at the time Te and has received the device ID, and has passed near the connecting station 2120 (which has ID (G2) as the device ID) at the time Tf and has received the device ID and has uploaded the intersecting history data via the connecting station 2120.

In FIG. 21A and FIG. 21B, the items for the types are also given to facilitate explanation. In the position registering operation in the fifth embodiment of the invention, it would suffice if the time of receiving of the intersecting history data and the device ID of the opponent device are included. As described above, a code to indicate the type may be included in the device ID so that the type is represented by a part of the device ID.

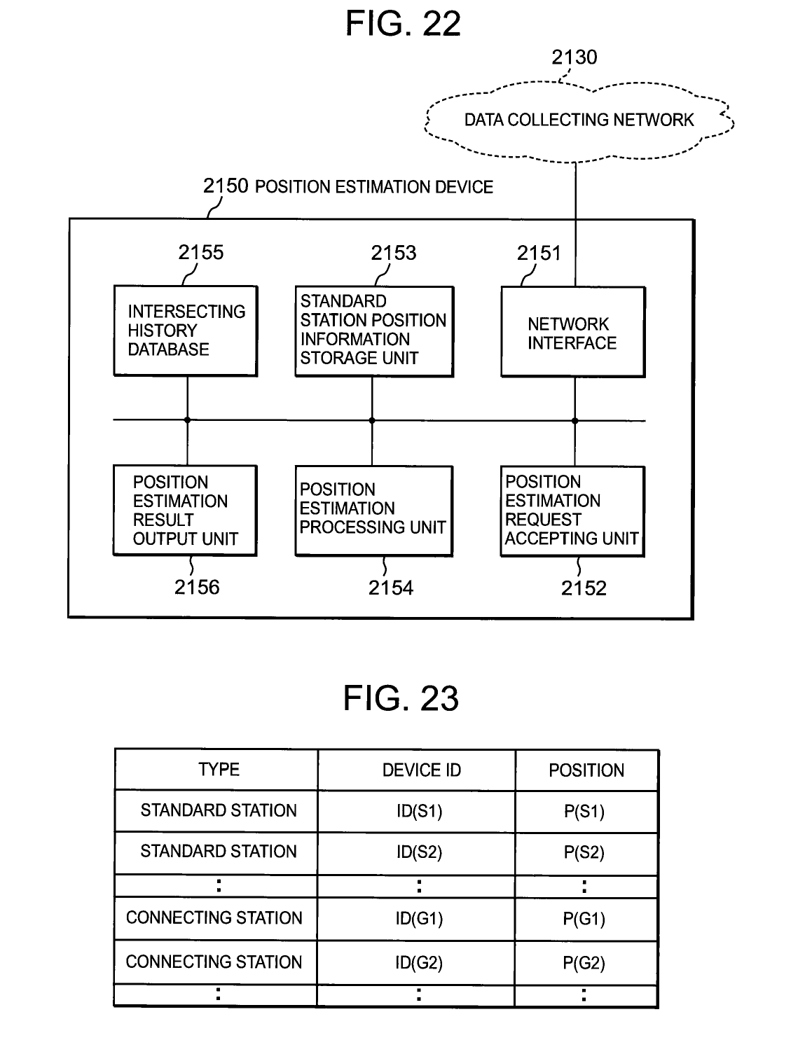

Next, referring to FIG. 22, description will be given on an arrangement of the position estimation device in the fifth embodiment of the invention. FIG. 22 shows an example of an arrangement of the position estimation device 2150 in the fifth embodiment of the invention. The position estimation device 2150 shown in FIG. 22 comprises a network interface 2151, a position estimation request accepting unit 2152, a standard station position information storage unit 2153, a position estimation processing unit 2154, an intersecting history database 155, and a position estimation result output unit 2156. In FIG. 22, the conditions where these functional blocks are connected via internal bus are schematically shown.

The network interface 2151 has the function to connect the position estimation device 2150 to a packet transmission network 2130, and to receive the intersecting history data transmitted from a mobile wireless device 2100 via the packet transmission network 2130 or to transmit and receive a position estimation request or response to and from a communication relay device 2170.

The position estimation request accepting unit 2152 has the function to accept a request of position estimation. The request of position estimation may be inputted by an operator, who can operate the position estimation device 2150, by means of an operation interface such as a mouse or a keyboard, or it may be inputted from an arbitrary device via a network (e.g. the packet transmission network 2130). In the present invention, the request of position estimation is basically carried out through inquiry from the communication relay device 2170.

In case the position estimation is requested, a mobile wireless device 2100 (for which the position is to be estimated) must be designated. Also, it is desirable that the time when the position relating to the mobile wireless device 2100 (i.e. the object of position estimation) is to be estimated (at any arbitrary time at present, in the past or in future).

In the standard station position information storage unit 2153, information relating to the place of installation of each of the standard stations 2110 installed in a predetermined area (i.e. standard station position information) is stored in advance. The connecting station 2120 has not only the function to relay the intersecting history data uploaded from the mobile wireless device 2100 to the position estimation device 2150 but also the function to control position information of the connecting station 2120 in the standard station position information to be stored in the standard station position information storage unit 2153 when it has the function as the standard station 2110.

The position estimation processing unit 2154 has the function to refer to the standard station position information in the standard station position information storage unit 2153 and to the intersecting history data in the intersecting history database 2155 when a request is received to estimate position estimation relating to a certain mobile wireless device 2100, and also to calculate the estimated position at a specific time of the mobile wireless device 2100, which is an object of the position estimation. Also, the position estimation processing unit 2154 can estimate the present position of the mobile wireless device 2100 (for which the position is to be estimated), or it can estimate position at any time point in the past or in future. In the present invention, according to the device ID received from the communication relay device 2170 together with the inquiry from the communication relay device 2170 in the position estimation, a processing is performed to estimate the present position of the mobile wireless device 2100 corresponding to the device ID.

As described above, the intersecting history database 2155 has the function to store the intersecting history data, which is uploaded from the mobile wireless device 2100.

The position estimation result output unit 156 has the function to output the result of position estimation as calculated at the position estimation processing unit 154. For instance, the position estimation result output unit 2156 may output the result of position estimation on a display screen, which an operator can see and check, of the position estimation device 2150. Or, when a request of position estimation is received via a network, the result of position estimation may be transmitted to the device, which has requested position estimation via a network interface 2151. In the present invention, the result of position estimation is basically transmitted as a response to the inquiry from the communication relay device 2170.

FIG. 23 shows an example of the standard station position information stored in the standard station position information storage unit 2153. According to the standard station position information shown in FIG. 23, it is seen that a station 2110 (which has ID (S1) as the device ID) is disposed at a position P (S1), and that a standard station 21 (which has ID (S2) as the device ID) is disposed at a position P (S2). Further, it is seen that a connecting station (which has ID (G1) as the device ID) is disposed at a position P (G1), and a connecting station 2120 (which has ID (G2) as the device ID) is disposed at a position P (G2).

In FIG. 23, the items for the types are also shown to facilitate the explanation, while it would suffice if the information to associate the device ID of the standard station (and the connecting station) with the position where the device is disposed is included. If a code to indicate the type is included in the device ID as described above, the type can be indicated by a part of the device ID. Although it is not shown in FIG. 23, the device ID and the position of each of the standard stations 2110 (or the connecting stations 2120) as disposed in the predetermined area are included in the standard station position information.

Next, description will be given on position estimation processing to be conducted at the position estimation device 2150 in the fifth embodiment of the invention. The position estimation device 2150 can calculate approximate position of the mobile wireless device 2100 at any arbitrary time from the intersecting history data of a specific mobile wireless device 2100 stored in the intersecting history database 2155, for instance.

For example, when a request is received to estimate a position of a mobile wireless device 211, for which the position is to be estimated, at a time Tz, the position estimation device 2150 selects at least two standard stations 2110 by referring to the intersecting history data of the mobile wireless device 2100, and extracts a receiving time when the mobile wireless device 2100 has received the device ID from these standard stations 2110. Also, by referring to the standard station position information storage unit 2153, information on the position of installation of the standard station 2110 as selected is acquired. Then, from the information (time and position) of each of these two standard stations 2110, information on the mobile wireless device 2100, which passes between these two standard stations 2110, is estimated. For instance, by assuming that the mobile wireless device 2100 moves at equal velocity along a straight line, which connects these two standard stations 2110, from the information (time and position) relating to each of these two standard stations, it is possible to identify an approximate position of the mobile wireless device 2100, for which the position is to be estimated at an arbitrary time.

Detailed description will be given below on a case where a position of a mobile wireless device 2100 (which has ID (M1) as the device ID) at an arbitrary time is estimated by using the intersecting history data shown in FIG. 21A and the standard station position information shown in FIG. 23.

When a request to estimate a position of the mobile wireless device 2100 (which has ID (M1) as the device ID) at a time Tz, is received, the position estimation device 2150 refers to the intersecting history data of the mobile wireless device 2100 (i.e. the intersecting history data shown in FIG. 21A). From the intersecting history data shown in FIG. 21A, it is known that the connecting station 2120 (which has ID (G1) as the device ID) fulfills also the function of the standard station 2110.

Then, the position estimation device 2150 selects a standard station 2100 (which has ID (S1) as the device ID) (at the time Ta when it has passed near the standard station 2100), and selects a connecting station 2120 (which has ID (G1) as the device ID) (at the time Tc when it has passed near this connecting station 2120). Then, referring to the standard station position information in the standard station position information storage unit 2153, the position P (S1) of the standard station 2110 (which has ID (S1) as the device ID), and the position P (G1) of the connecting station 2120 (which has ID (G1) as the device ID) are identified.

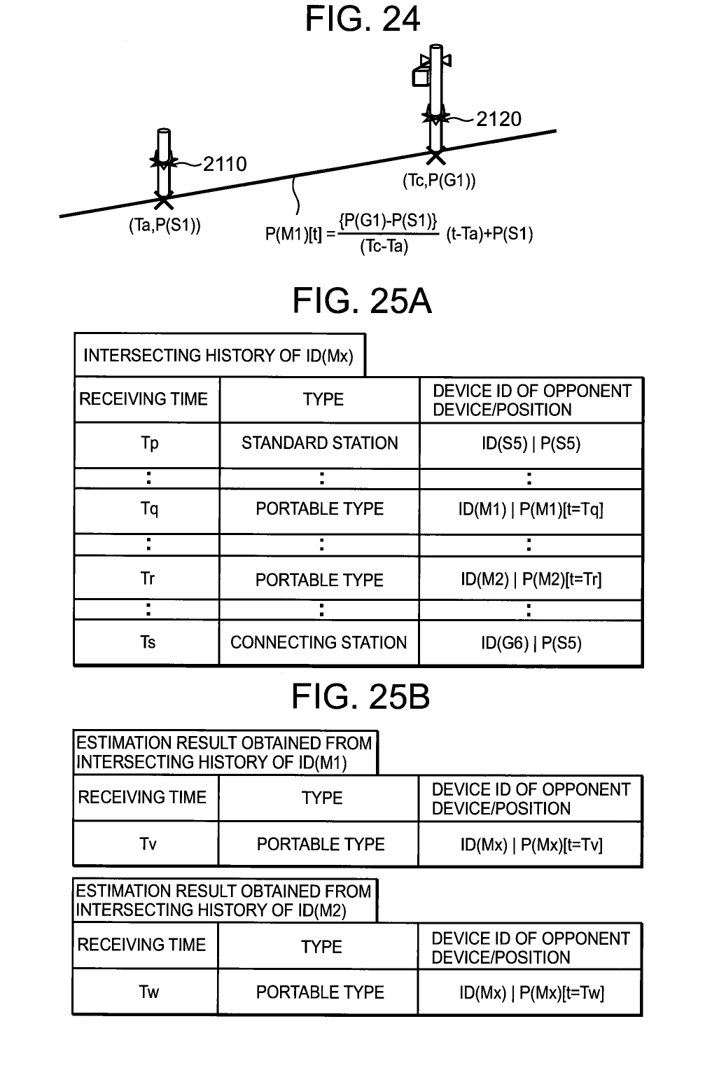

By obtaining a straight line, which connects coordinates (T, P (S1)) relating to the standard station 2110 and coordinates (Tc, P (G1)) relating to the connecting station 2120, the following equation (1) is obtained, which gives a position P (M1) [t] of the mobile wireless device 2100 at the time as shown in FIG. 24:

P(M1)[t]={P(G1)−P(S1)}×(t−Ta)/(Tc−Ta)+P(S1) Equation (1)

By substituting the time Tz of position estimation to the time “t” in the equation (1) as given above, the estimated position of the mobile wireless device 2100 (for which the position is to be estimated) at the time Tz can be calculated.

In the above equation (1), the time Tz of position estimation may be limited to the range of: Ta≦Tz≦Tc, while it is also possible to apply this to the position estimation of the mobile wireless device 2100 in the range of Tz<Ta or in the range of Tz>Tc.

In the equation (1) as given above, it is assumed that the mobile wireless device 2100 (which has ID (M1) as the device ID) moves at equal velocity along a straight line, which connects positions of two standard stations 2110 (and the connecting stations 2120) included in the interconnecting history data of the mobile wireless device 2100, while a locus to give the position of the mobile wireless device 2100 at an arbitrary time “t” may be obtained by applying the method of multivariate analysis on the positions of three or more standard stations 2110 (and the connecting stations 2120). Also, by giving consideration on map data including information such as roads, facilities, etc., it may be so arranged that the moving route of the mobile wireless device 2100 concurs with the road or the passage, which connects the standard stations 2110 (and the connecting stations 2120), instead of expressing the moving route of the mobile wireless device 2100 by a mere straight line.

When the position estimation device 2150 can find the intersecting history data of the mobile wireless device 2100, for which the position is to be estimated, it is possible to estimate the position based on the intersecting history data of the mobile wireless device 2100, for which the position is to be estimated, as described above.

However, there may be a case where the intersecting history data of the mobile wireless device 2100, for which the position is to be estimated, is not found in the intersecting history database 2155, or a case where there remains only old information (information in the past) although the data is present in the database. Such case may happen when the mobile wireless device 210, for which the position is to be estimated, has not uploaded the intersecting history data to the position estimation device 2150 via the connecting station 2120, i.e. the data was never uploaded or not uploaded for long time.

Even when a valid intersecting history data directly uploaded by the mobile wireless device (for which the position is to be estimated) cannot be found in the intersecting history database 2155, there may be the case where the position estimation device 2150 can estimate the position of the mobile wireless device 2100 (for which the positions to be estimated) can be estimated.

When a valid intersecting history data directly uploaded by the mobile wireless device 2100 (for which the position is to be estimated) is not found in the intersecting history database 2155, the position estimation device 2150 retrieves from the intersecting history data of the other mobile wireless device 2100 as to whether there is information or not on the exchange of the device ID with the mobile wireless device 2100 (for which the position is to be estimated).

For instance, it is supposed here that the mobile wireless device 2100 (for which the position is to be estimated) is a mobile wireless device 2100 (which has ID (Mx) as the device ID). When the position estimation device 2150 could not find a valid intersecting history data of the mobile wireless device 2100 (which has ID (Mx) as the device ID), it is checked whether the mobile wireless device 2100 (which has ID (Mx) as the device ID) is included or not as an opponent device, which have exchanged the device ID, in the intersecting history data of the other mobile wireless devices 2100 (e.g. intersecting history data of the mobile wireless device 2100 (which has ID (M1) as the device ID) as shown in FIG. 21A, or the intersecting history data of the mobile wireless device 2100 which has ID (M2) as the device ID) as shown in FIG. 21B.

As a result, from the intersecting history data of the mobile wireless device 2100 (which has ID (M1) as the device ID), the position estimation device 2150 can acquire such information that the mobile wireless device 2100 (which has ID (M1) as the device ID) has intersected the mobile wireless device 2100 (which has ID (Mx) as the device ID) at the time Tb. In this case, by using an algorithm based on the above equation (1), it is possible to calculate the position P (M1) [t=Tb] at the time Tb. The position P (M1) [t=Tb] is an estimated position where the mobile wireless device 2100 (which has ID (M1) as the device ID) was present at the time Tb, and it is also the point where the mobile wireless device 2100 (which has ID (M1) as the device ID) has intersected the mobile wireless device 2100 (which has ID (Mx) as the device ID), and also, it is an estimated position where the mobile wireless device 2100 (which has ID (Mx) as the device ID) was present at the time Tb.

Also, from the intersecting history data of the mobile wireless device 2100 (which has ID (M2) as the device ID) the position estimation device 2150 can acquire such information that the mobile wireless device 2100 (which has ID (M2) as the device ID) has intersected the mobile wireless device 2100 (which has ID (Mx) as the device ID) at the time Te. In this case, also, an estimated position P (M2) [t=Te], where the mobile wireless device 2100 (which has ID (Mx) as the device ID) was present at the time Te, can be calculated. As a result, even though a valid intersecting history data is not received from the mobile wireless device 2100 (which has ID (Mx) as the device ID), it is possible to identify the position where the mobile wireless device 2100 (which has ID (Mx) as the device ID) was parent.

As described above, from the intersecting history data of the mobile wireless device 2100 (which has ID (M1) or ID (M2) as the device ID) it is possible to estimate the intersecting history data of the mobile wireless device 2100 (which has ID (Mx) as the device ID) (i.e. time and position of intersecting with the mobile wireless device 2100 (which has ID (M1) or ID (M2) as the device ID).

Further, even when the mobile wireless device 2100 (which has ID (Mx) as the device ID) has found the intersecting history data directly uploaded from the mobile wireless device 2100, the position estimation device 2150 can acquire time and position of intersecting from the intersecting history data of the other mobile wireless device 2100, which has intersected a mobile wireless device 2100 (which has ID (Mx) as the device ID), and can use the intersecting history data of the other mobile wireless device 2100 as a secondary data (data for compensation). (for which the position is to be estimated).

For instance, it is supposed here that the mobile wireless device 2100 (for which the position is to be estimated) is a mobile wireless device (which has ID (Mx) as the device ID). The position estimation device 2150 reads a valid intersecting history data directly uploaded from the mobile wireless device 2100 (which has ID (Mx) as the device ID), and as a result, it acquires the intersecting history with a standard station 2110 or a connecting station 2120 or with a mobile wireless device, (which has ID (M1) or ID (M2) as the device ID) as shown in FIG. 25A. Although the position of intersecting is also given in FIG. 25A, this position can be obtained from standard station position information (in case of the standard station 2110) or from the calculation by multivariate analysis (in case of the mobile wireless device 2100). According to the example shown in FIG. 25A, it is seen that the mobile wireless device (which has ID (Mx) as the device ID) has intersected the mobile wireless device 2100 (which has ID (M1) as the device ID) at the time Tq and at the position (M1) [t=Tq], and it has intersected the mobile wireless device 2100 (which has ID (M2) as the device ID) at the time Tr and at the position P (M2) [t=Tr].

On the other hand, from the intersecting history data of the mobile wireless device (which has ID (M1) or ID (M2) as the device ID) the position estimation device 2150 estimates the intersecting history data of the mobile wireless device (which has ID (Mx) as the device ID) (i.e. time and position of intersecting with the mobile wireless device (which has ID (M1) or ID (M2) as the device ID). By this operation, as shown in FIG. 25B, it is possible to obtain such information that the mobile wireless device 2100 (which has ID (M1) as the device ID) has intersected the mobile wireless device 2100 (which has ID (Mx) as the device ID) at the time Tv and at the position P (Mx) [t=Tv], and also such information that the mobile wireless device (which has ID (M2) as the device ID) has intersected the mobile wireless device 2100 (which has ID (Mx) as the device ID) at the time Tw and at the position P (Mx) [t=Tw].

To the valid intersecting history data directly uploaded from the mobile wireless device (which has ID (Mx) as the device ID) by carrying out compensation based on the data obtained from the intersecting history data of the mobile wireless device 2100 (which has ID (M1) and ID (M2) as the device ID), the position estimation device 2150 can perform more adequate position estimation processing. More concretely, the position P (M1) [t=Tq] and the position P (Mx) [t=Tv] is originally equal to each other, but there is high possibility that deviation may have occurred due to error or to the influence from the factors inherent to the estimation method such as stirring or shaking. Therefore, it is possible to compensate the position P (M1) [t=Tq] by the position P (Mx) [t=Tv] by determining the intersecting position at the middle between the two positions. It is also possible to perform compensation in similar manner to the position P (M2) [t=Tr] and the position P (Mx) [t=Tw].

By the operation as described above, when each of the mobile wireless devices 2100 uploads a predetermined passing point and a passing time and identification information and the time of intersecting of the opponent wireless device, which the mobile wireless devices 2100 have intersected, to the position estimation device 2150 via the connecting station 2120, and the position estimation device 2150 can estimate the position of each of the mobile wireless devices 2100 at an arbitrary time.

Also, when the mobile wireless devices 2100 exchange own device IDs with each other, an event (occurrence) that the mobile wireless devices 2100 intersected each other remains as the intersecting history of both sides. Specifically, the intersecting history that a first mobile wireless device 2100 has intersected a second mobile wireless device 2100 is recorded in the intersecting history data on both sides, i.e. in the intersecting history data of the first and the second mobile wireless devices 2100. By compensating one of the intersecting history data with the other intersecting history data, the time and the position of the same intersecting event (the event of intersecting) can be identified by using two intersecting history data.

In the description as given above, it is so arranged that the intersecting history data including the events of intersecting of both of the mobile wireless devices 2100 are used when the position estimation device 2150 calculates the position of each of the mobile wireless devices 2100, while the position estimation algorithm of the position estimation device 2150 is not limited to this. The position estimation device 2150 may use any position estimation algorithm, by which it is possible to induce the position of the mobile wireless device 2100 (the position may not necessarily be an accurate position) from the device ID of the mobile wireless device 2100.

For instance, in the description as given above, the intersecting history data including the event of intersecting between the mobile wireless devices 2100 are uploaded to the position estimation device 2150, while it may be so arranged that the mobile wireless device 2100 does not uploads the event of the intersecting of the mobile wireless devices 2100 and own ID may be uploaded only to the position estimation device 2150 at the time when it has come in the range where communication can be made with the connecting station 2120, or that the connecting station 2120 acquires the device ID of the mobile wireless device 2100, which has moved in the range where communication can be made and may upload it to the position estimation device 2150. Or, it may be so arranged that the standard station 2110 is not installed and only the connecting station 2120 is installed, and matching relationship between the position of the mobile wireless device 2100 and the connecting station 2120 may be uploaded to the position estimation device 2150.

In these cases, a connecting station 2120, with which each of the mobile wireless devices 2100 has performed communication most recently, is registered in the intersecting history database 2155, and this makes it possible to identify the connecting station 2120, which seems to be present close nearby of each of the mobile wireless devices 2100. In these cases, however, the accuracy of position estimation will be lower in comparison with the case where the position of each of the mobile wireless devices 2100 is estimated by using the intersecting history data including the event of intersecting of the mobile wireless devices 2100 with each other. However, by carrying out speculative packet transfer as to be described later, it is possible to prevent aggravation of the accuracy of reaching of the packet, which may be aggravated due to low accuracy in position estimation.

In the position registering operation as described above, the device ID to be stored is associated with time information, while it may be associated with information of the moving distance of the mobile wireless device 2100 so that the position where the mobile wireless devices 2100 have intersected each other can be calculated from the information on the moving distance.

In the above, description has been given on the position registering operation where information for the purpose of estimating position of each of the mobile wireless devices 2100 is registered in the intersecting history database 2155 or on position estimation processing at the position estimation device 2150 so that the position estimation device would be able to estimate the position of each of the mobile wireless devices 2100. Description will be given below on a position registering operation or on a packet transfer operation by using position estimation processing at the position estimation device 2150.

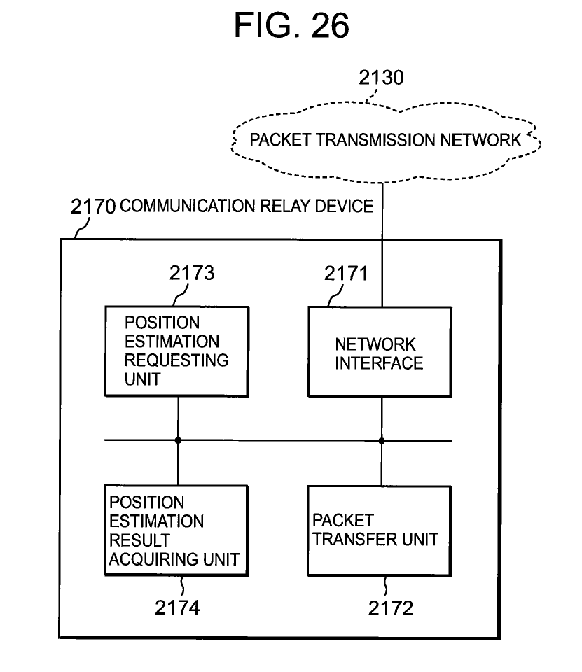

First, referring to FIG. 26, description will be given on an arrangement of a communication relay device in the fifth embodiment of the invention. FIG. 26 shows an example of an arrangement of the communication relay device 2170 in the fifth embodiment of the invention. The communication relay device 2170 shown in FIG. 26 comprises, a network interface 2171, a packet transfer unit 2172, a position estimation requesting unit 2173, and a position estimation result acquiring unit 2174. FIG. 26 schematically shows the condition where these functional blocks are connected via internal bus.

The network interface 2171 has the function to connect the communication relay device 2170 to a packet transmission network 2130, to transmit and receive a packet to be transmitted or received by the mobile wireless device 2100, and to transmit and receive a request or a response of position estimation to and from the position estimation device 2150.

The packet transfer unit 2172 has the function to determine a transfer destination of the packet to be transmitted or received by the mobile wireless device 2100. As the transfer destination of the packet, a connecting station 2120 is determined, which corresponds to a position acquired at the position estimation result acquiring unit 2174 (i.e. a position where it is estimated that the mobile wireless device 2100 of packet destination is present). It is desirable that the packet transfer unit 2172 can promptly identify an adequate connecting station 2120 as the transfer destination by finding a matching relationship between the position acquired at the position estimation result acquiring unit 2174 and an adequate connecting station 2120 as the transfer destination of the position, or by making inquiry to a device, which maintains this matching relationship in advance.

The position estimation requesting unit 2173 has the function to make inquiry on a position where it is estimated that a mobile wireless device 2100 of packet destination to be transferred by the packet transfer unit 2172 (i.e. a correspondent) is present. The position estimation result acquiring unit 2174 has the function to receive the result of inquiry from the position estimation device 2150 (i.e. a position where it is estimated that the mobile wireless device 2100 of packet destination is present).

When a request is made to the position estimation device 2150 to carry out position estimation, the position estimation requesting unit 2173 can specify a position where it is estimated that the mobile wireless device 2100 of packet destination is present and to identify an adequate connecting station 2120, which can transmit the packet to this position by transmitting the device ID added to the packet (i.e. the device ID to identify the mobile wireless device 2100 of packet destination) to the position estimation device 2150 at the same time.

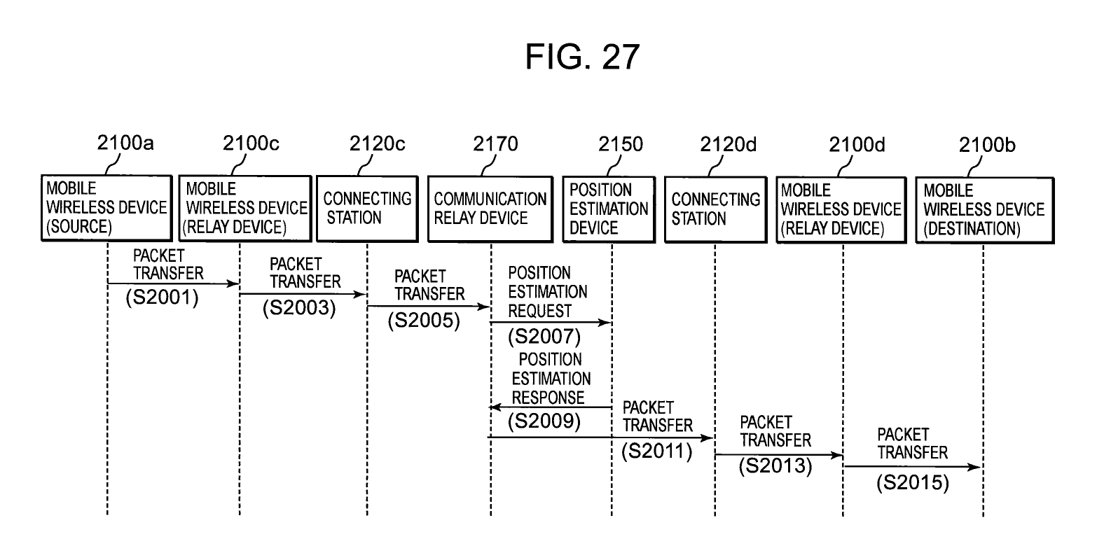

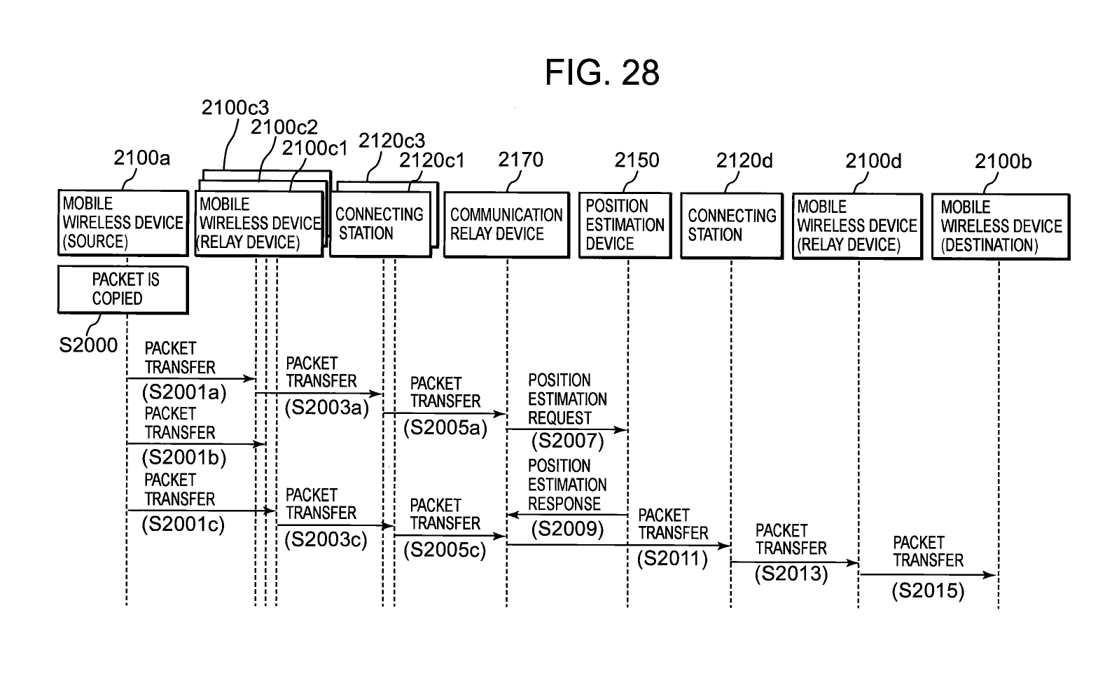

Next, referring to FIG. 27, description will be given on basic operation of a packet transmission operation in the fifth embodiment of the invention. FIG. 27 is a sequence chart to show an example of basic operation of the packet transmission operation in the fifth embodiment of the invention. Each of the sequence chart as shown in FIG. 27 and FIG. 28 to FIG. 30 is based on the system arrangement shown in FIG. 18 as preposition, and each of the sequence charts shows a case where a packet transmitted by a certain mobile wireless device (transmission source) 2100a to another mobile wireless device (transmission destination) 2100b. In FIG. 27, and also in FIG. 28 to FIG. 30 as to be given later, a mobile wireless device 2100, which is present in the vicinity of the mobile wireless device (transmission source) 2100a is described as a mobile wireless device (a relay device) 2100c, and a mobile wireless device 2100, which is present in the vicinity of the mobile wireless device (destination) 2100b fulfills the function as a relay device, and is described as a mobile wireless device (relay device) 2100d. Further, in FIG. 27, and also in FIG. 28 to FIG. 30 as to be given later, a connecting station 2120 to receive a packet from the mobile wireless device (relay device) 2100c is described as a connecting station 2120c, and a connecting station 2120, which transfers the packet to the mobile wireless device (relay device) 2100d, is described as a connecting station 2120d.

In FIG. 27, when the mobile wireless device (source) 2100a transmits a packet to another mobile wireless device (destination) 2100b, the mobile wireless device (source) 2100a first searches a mobile wireless device 2100, which is present within its own communicable range. When the mobile wireless device 2100 has been found in its own communicable range, the mobile wireless device (source) 2100a adds the device ID of the correspondent of the packet to be transmitted, and the packet is transferred to the mobile wireless device (relay device) 2100c thus found (Step S2001).

When the packet is received in Step S2001, the mobile wireless device (relay device) 2100c is a mobile wireless device 2100, which was present in the vicinity of the mobile wireless device (source) 2100a by mere chance, for instance. When this mobile wireless device (relay device) 2100c is moves and passes nearby the connecting station 2120c, the packet received from the mobile wireless device (source) 2100a is transferred to the connecting station 2120c (Step S2003). The mobile wireless device (source) 2100a may transfer the packet by selecting the mobile wireless device (relay device) 2100c according to any arbitrary condition such as a moving direction or a moving velocity. Also, the mobile wireless device (relay device) 2100c may deliver the packet to the connecting station 2120 when it has come in the vicinity of the connecting station 2120c, or may deliver the packet positively to the connecting station 2120 by searching the connecting station 2120 as soon as it has received the packet from the mobile wireless device (source) 2100a.

When the packet is received from the mobile wireless device (relay device) 2100c, the connecting station 2120c transfers this packet to the communication relay device 2170 on the packet transmission network 2130 (Step S2005). When the packet transferred from the connecting station 2120c is received, the communication relay device 2170 extracts the device ID of the correspondent added to this packet from the packet and transmits a position estimation requesting message including this device ID to the position estimation device 2150 (Step S2007).

When the position estimation requesting message is received from the communication relay device 2170, the position estimation device 2150 estimates the present position of the mobile wireless device 2100, which is the correspondent (destination of the packet) according to the device ID included in the position estimation requesting message. For the position estimation processing to be carried out in this case, a method using the position estimation algorithm as described above is used, while it is not specifically limited to the position estimation algorithm used in the present invention. The position estimation device 2150 sends back a position estimation reply message including the position estimation result (i.e. the present position of the mobile wireless device 2100, which is the correspondent) (Step S2009).

When the position estimation reply message is received, the communication relay device 2170 identifies the connecting station 2120d, which is present in the vicinity of the mobile wireless device 2100 (i.e. the correspondent) based on the position estimation result including in the position estimation reply message, and the packet is transferred to this connecting station 2120d (Step S2011). Here, the communication relay device 2170 identifies the connecting station 2120d in the vicinity of the mobile wireless device 2100, which is the correspondent, from its present position, while the position estimation device 2150 may send back the connecting station 2120d as the result of the position estimation after performing the searching on the connecting station 2120 by the position, or the communication relay device 2170 may ask another communication device to perform searching of the connecting station 2120.

When the packet is received, the connecting station 2120d searches a mobile wireless device 2100, which is present in its own communication range. When the mobile wireless device 2100 is found in its own communication range, the connecting station 2120d transfers the packet to the mobile wireless device (relay device) 2100d thus found (Step S2013). This mobile wireless device (relay device) 2100d is a mobile wireless device 2100, which is present in the vicinity of the connecting station 2120d by mere chance, for instance. When this mobile wireless device (relay device) 2100d moves and passes in the vicinity of the mobile wireless device (destination) 2100b, the packet received from the connecting station 2120d is transferred to the mobile wireless device (destination) 2100b (Step S2015). The connecting station 2120d may select the mobile wireless device (relay device) 2100d according to any arbitrary condition such as a moving direction or a moving speed. Also, the mobile wireless device (relay device) 2100d may deliver the packet to the mobile wireless device (destination) 2100b when it has passed in the vicinity of the mobile wireless device (destination) 2100b, or it may search the mobile wireless device (destination) 2100b as soon as it receives the packet from the connecting station 2120d and may deliver the packet positively to the mobile wireless device (destination) 2100b.

The mobile wireless device (relay device) 2100c or the mobile wireless device (relay device) 2100d may refuse to transfer the packet based on the reasons such as there is no sufficient resources or there is no movement almost at all, or it is apparent that shutdown may occur soon. In the description as given above, the packet transfer from the mobile wireless device (source) 2100a to the connecting station 2120c and the packet transfer from the connecting station 2120d to the mobile wireless device (destination) 2100b is carried out by a mobile wireless device (relay device) 2100c and by a mobile wireless device (relay device) 2100d respectively, while the packet may be transferred via a plurality of relay devices (multi-hop).

In the packet transmitting operation as shown in FIG. 27, there may be a case where a packet transmission route from the mobile wireless device (source) 2100a to the mobile wireless device (destination) 2100b is not found, and it is not completely guaranteed that a packet transmitted from the mobile wireless device (source) 2100a reliably reaches the mobile wireless device (destination) 2100b. In first to third application examples as to be given below, it is tried to carry out speculative transmission of the packet to improve the reachability of the packet and to ensure more stable communication.

Referring to FIG. 28, description will be given on a first application example of packet transmitting operation in the fifth embodiment of the invention. FIG. 28 is a sequence chart to show the first application example of the packet transmitting operation in the fifth embodiment of the invention.

In FIG. 28, a mobile wireless device (source) 2100a, which is the transmission source of the packet, copies the packet (Step S2000), generates a plurality of the same packets (three packets in FIG. 28), and transmits these packets to different mobile wireless devices (relay devices) 2100c1, 2100c2 and 2100c3 (Steps S2001a, 52001b and 52001c). Some of these packets are to be transferred to connecting stations 2120c1 and 2120c3 by the mobile wireless devices (relay devices) 2100c1 and 2100c3 respectively (Steps S2003a and S2003c), while there may be a case where the connecting station 2120 cannot be found as in the case of the mobile wireless device (relay device) 2100c2, and the transfer is not carried out further.

As described above, if the mobile wireless device (source) 2100a copies the packet and transmits a plurality of the same packets, the mobile wireless device (source) 2100a can ask the plurality of mobile wireless devices 2100 to relay the communication speculatively, and this makes it possible to improve the possibility of the packet to reach the packet transmission network 2130.

When a plurality of the same packets are sent after confirming sequence number of each packet, it is desirable that the communication relay device 2170 performs the processing only to the packet received first (e.g. a packet received in Step S2005a), and that no processing is performed on the subsequent series of the same packets (e.g. the packets received in Step S2005c). In FIG. 28, the processing in Step S2007 and after is the same as the processing in FIG. 27, and detailed description is not given here.

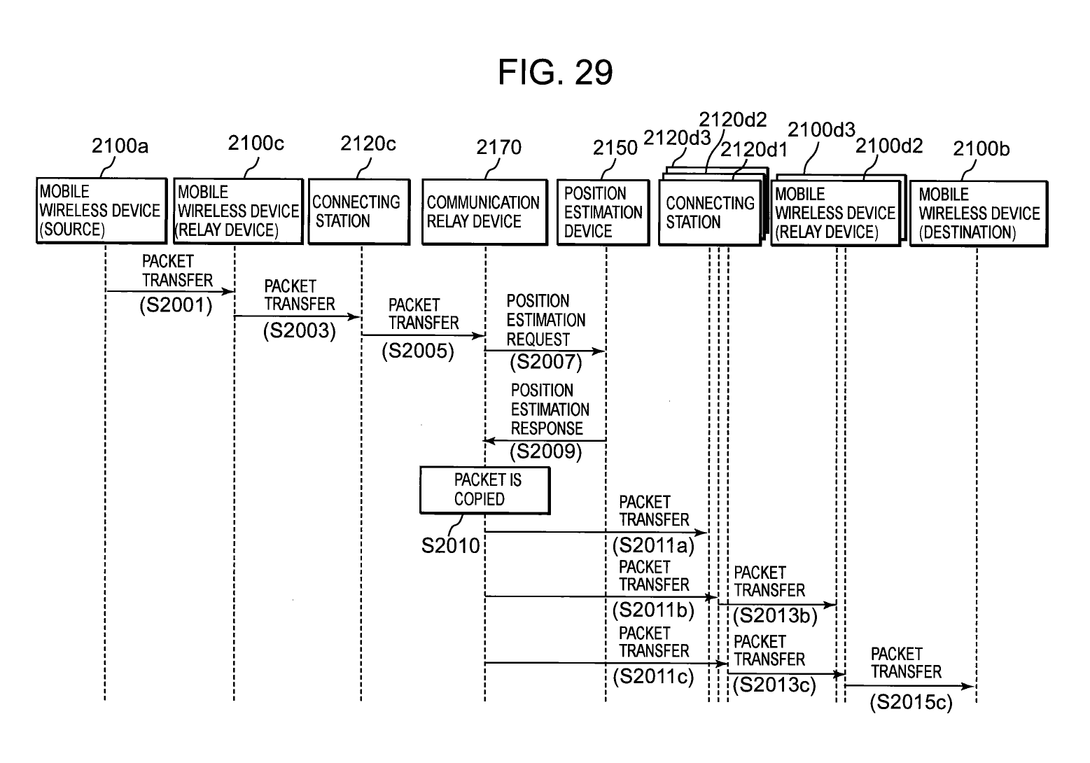

Next, referring to FIG. 29, description will be given on a second application example of the packet transmitting operation in the fifth embodiment of the invention. FIG. 29 is a sequence chart to show the second application example of the packet transmitting operation in the fifth embodiment of the invention.

In FIG. 29, the processings in Steps S2001 to S1009 are the same as those shown in FIG. 27, and detailed description is not given here. On the other hand, after the transfer destination of the packet is identified in Step S2009, the communication relay device 2170 copies the packet (Step S2010), generates a plurality of the same packets (three packets in FIG. 29), and transmits these packets to different connecting stations 2120d1, 2120d2 and 2120d3 respectively (Steps S2011a, S2011b and S2011c). It is desirable that, as a plurality of the connecting stations 2120d1, 2120d2 and 2120d3, those installed in the area are selected, where there is high possibility that the mobile wireless device (destination) 2100b is currently present.

Some of these packets may be transferred by the connecting stations 2120d1 and 2120d3 to the mobile wireless devices (relay devices) 2100d1 and 2100d3, which are under the control of these connecting stations respectively (Steps S2013b and S2013c), while there may be a case where an adequate mobile wireless device (relay device) 2100d such as the connecting station 2120d2 cannot be found, and the transfer is not carried out further. Also, there may a case where the mobile wireless device (destination) 2100b can be found as in the case of the mobile wireless device (relay device) 2100d3, and the packet can be transferred (Step S2015c), or there may be a case where the mobile wireless device (destination) 2100b such as the mobile wireless device (relay device) 2100d1 cannot be found and the packet cannot be transferred.

Although it is shown in FIG. 29 that the packet finally reaches the mobile wireless device (destination) 2100b via only one route, while there is the possibility that a plurality of the same packets reach the mobile wireless device (destination) 2100b via a plurality of routes. In this case, it is desirable that the mobile wireless device (destination) 2100b processes only the packet, which has reached first, as a valid packet, and the subsequent series of the same packets are neglected (abandoned).

As described above, when the communication relay device 2170 to transfer the packet copies the packet and transmits a plurality of the same packets, the communication relay device 2170 can ask a plurality of connecting stations 2120d to relay the communication speculatively, and this makes it possible to improve the possibility of the packets to reach the mobile wireless device (destination) 2100b via one of these routes from the packet transmission network 2130.

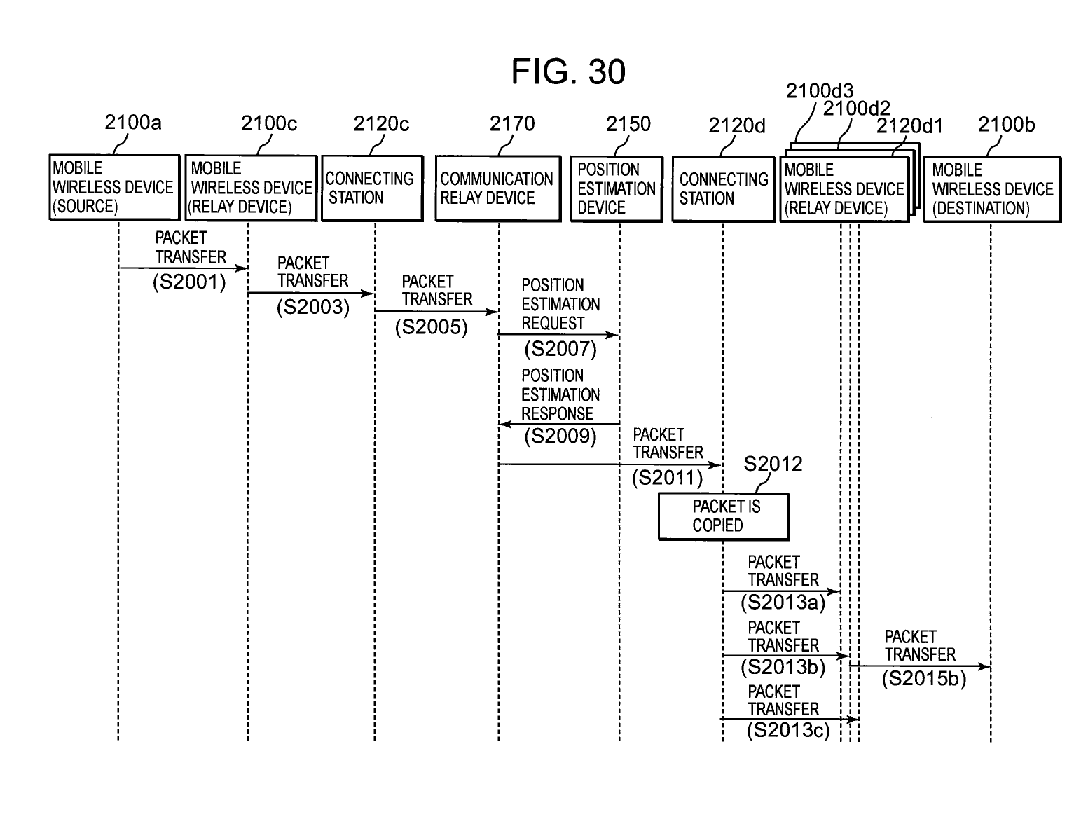

Next, referring to FIG. 30, description will be given on the third application example of the packet transmitting operation in the fifth embodiment of the invention. FIG. 30 is a sequence chart to show the third application example of the packet transmitting operation in the fifth embodiment of the invention.

In FIG. 30, processings in Steps S2001 to S2011 are the same as the processings in FIG. 27, and detailed description is not given here. On the other hand, when the packet is received in Step S2011 and packet transfer is performed, the connecting station 2120d copies the packets (Step S2012), generates a plurality of the same packets (three packets in FIG. 30), and transmits these packets to different mobile wireless devices (relay devices) 2100d1, 2100d2 and 2100d3 respectively (Steps S2013a, S2013b and S2013c). Then, the mobile wireless devices (relay devices) 2100d1, 2100d2 and 2100d3 move respectively, and one or more in a plurality of these mobile wireless devices (relay devices) 2100d1, 2100d2 and 2100d3 (only the mobile wireless device (relay device) 2100d2 is shown in FIG. 30) find the mobile wireless device (destination) 2100b and transfer the packet (Step S2015b).

Even in this case, there is a possibility that a plurality of the same packets reach the mobile wireless device (destination) 2100b, but it is desirable that the mobile wireless device (destination) 2100b processes only the packet, which reached first, as a valid packet, and neglects (abandons) the subsequent series of the same packets.

As describe above, when the connecting station 2120d to transfer the packet copies the packet and transmits a plurality of the same packets, the connecting station 2120d can ask the plurality of mobile wireless devices to relay the communication speculatively, and the possibility that the packet reaches the mobile wireless device (destination) 2100b from the connecting station 2120d via one of various routes can be improved.

It is also possible to combine the first to the third application examples of the packet transmitting operation in the fifth embodiment of the invention as shown in FIG. 28 to FIG. 30. Specifically, when the packet, which is to be transmitted from the mobile wireless device (source) 2100a to the mobile wireless device (destination) 2100b is copied to a plurality of the same packets at an arbitrary point of the connecting station 2120d and these are sent via different routes, it is possible to improve the possibility of the packets to reach the mobile wireless device (destination) 2100b.

In the fifth embodiment as described above, the packet to be sent from the mobile wireless device (source) 2100a to the connecting station 2120c is relayed via the mobile wireless device (relay device) 2100c and the packet to be sent from the connecting station 2120d to the mobile wireless device (destination) 2100b is relayed via the mobile wireless device (relay device) 2100d. If possible, however, it is desirable that the packet is sent directly from the mobile wireless device (source) 2100a to the connecting station 2120c or from the connecting station 2120d to the mobile wireless device (destination) 2100b.

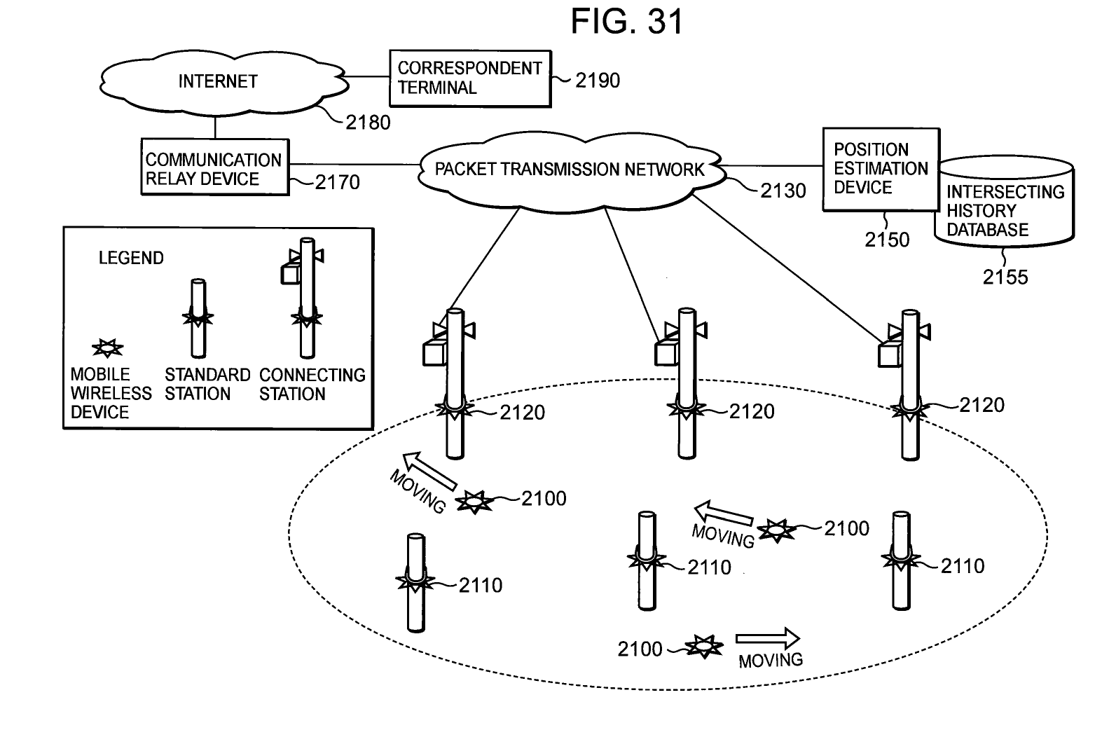

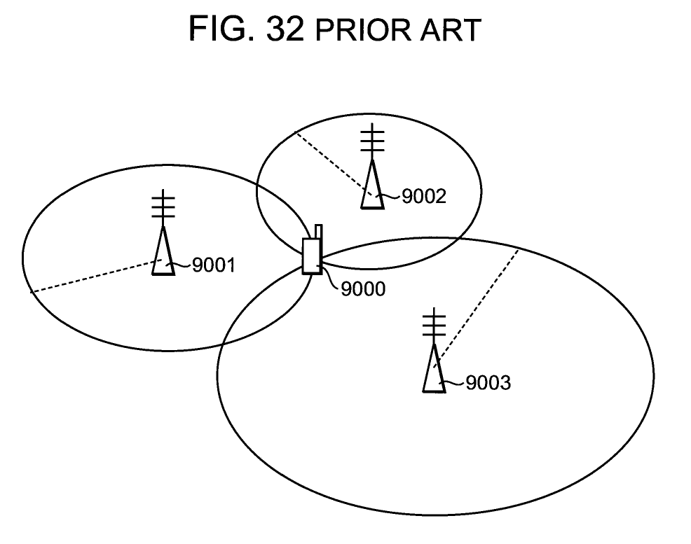

Also, as shown in the system configuration of FIG. 18, in the fifth embodiment as described above, it is presupposed that communication is performed between the mobile wireless devices 2100, which are present in a predetermined area, while it is also possible to apply the present invention to a communication between the mobile wireless device 2100 and an arbitrary correspondent terminal 2190 connected to an external network (e.g. an IP (Internet protocol) network such as Internet 2180) as shown in the system configuration in FIG. 31. In this case, it would suffice that the communication relay device 2170 may identify the matching relationship between address information used when the packet is transmitted on Internet 2180, and that the device ID of this specific mobile wireless device 2100 is added to the packet destined to a specific mobile wireless device from the correspondent terminal 2190.

### INDUSTRIAL APPLICABILITY

The present invention provides an effect to accomplish position estimation with high accuracy by a simple system configuration using short distance communication functions, an effect to realize the position estimation with high accuracy by utilizing bidirectionality of communication on short distance wireless devices, and also an effect to improve the reliability of the communication using the short distance communication functions by using mobile wireless devices (wireless communication terminals) on a wide area network. The present invention can be applied to the position estimation technique to estimate positions of wireless communication terminals and to the technique relating to the wide area network connected by the short distance wireless communication. In particular, the invention can be applied to the position estimation technique for estimating a position of a short distance wireless device with the function to perform the short distance wireless communication.

1. A communication system, provided with position estimation function to estimate a position of a wireless communication terminal according to history of receiving of information as transmitted from the wireless communication terminal having short distance wireless communication function while moving in a predetermined area.

2. The communication system according to claim 1, wherein said communication system comprises a plurality of wireless communication terminals moving in said predetermined area, a plurality of standard stations fixedly installed within said predetermined area, connecting stations located within said predetermined area and connected to a predetermined network, and a position estimation device connected to said predetermined network, wherein said wireless communication terminal comprises:
short distance wireless communication means for performing communication with another wireless communication terminal located in the vicinity, and with said standard stations and said connecting stations;
device identification information storage means for storing device identification information specific to each wireless communication terminal;
device identification information transmitting means for transmitting said device identification information of own terminal to said another wireless communication terminal in case communication can be performed with said another wireless communication terminal via said short distance wireless communication means;
device identification information receiving means for receiving said device identification information of said another wireless communication terminal or said standard station from said another wireless communication terminal in case communication can be performed to and from said another wireless communication terminal or said standard station via said short distance wireless communication means;
timing means for outputting the current time information;
intersecting history data memorizing means for memorizing said device identification information of said another wireless communication terminal or said standard station as received by said device identification information receiving means by associating with said time information as outputted from said timing means as an intersecting history data; and
intersecting history data transmitting means for transmitting said intersecting history data to said position estimation device via said connecting station and said predetermined network in case it is possible to communicate with said connecting station via said short distance wireless communication means;
said standard station comprises:
short distance wireless communication means for performing communication to and from said wireless communication terminal located in the vicinity;
device identification information storage means for storing device identification information specific to each standard station; and
device identification information transmitting means for transmitting said device identification information of own station to said wireless communication terminal in case it is possible to perform communication to and from said wireless communication terminal via said short distance wireless communication means;
said connecting station comprises:
short distance wireless communication means for performing communication to and from said wireless communication terminal located in the vicinity;
a network interface connected to said predetermined network; and
intersecting history data transfer means for transferring said intersecting history data, received from said wireless communication terminal via said short distance wireless communication means, to said position estimation device via said network interface;
said position estimation device comprises:
a network interface connected to said predetermined network;
standard station position information storage means for storing standard station position information to indicate a position of installation of each of said standard stations;
intersecting history data receiving means for receiving said intersecting history data as transmitted from said wireless communication terminal via said network interface;
an intersecting history database for storing said intersecting history data received from each of a plurality of said wireless communication terminals; and
position estimation processing means for estimating position of any of said wireless communication terminal at an arbitrary time by using said intersecting history data stored in said intersecting history database.

3. The communication system according to claim 1, wherein said communication system comprises a plurality of wireless communication terminals moving in said predetermined area, a plurality of standard stations fixedly installed within said predetermined area, connecting stations located within said predetermined area and connected to a predetermined network, and a position estimation device connected to said predetermined network, wherein said wireless communication terminal comprises:
short distance wireless communication means for performing communication with another wireless communication terminal located in the vicinity, and with said standard stations and said connecting stations;
device identification information storage means for storing device identification information specific to each wireless communication terminal;
device identification information transmitting means for transmitting said device identification information of own terminal to said another wireless communication terminal in case communication can be performed with said another wireless communication terminal via said short distance wireless communication means;
device identification information receiving means for receiving said device identification information of said another wireless communication terminal or said standard station from said another wireless communication terminal in case communication can be performed to and from said another wireless communication terminal or said standard station via said short distance wireless communication means;
timing means for outputting the current time information;
moving distance information output means for outputting moving distance information to represent a distance of moving of own terminal;
intersecting history data memorizing means for memorizing said device identification information of said another wireless communication terminal or said standard station as received by said device identification information receiving means, by associating said device identification information with said moving distance information as outputted from said moving distance information output means and with said timing information as outputted from said timing means as an intersecting history data;
intersecting history data transmitting means for transmitting said intersecting history data to said position estimation device via said connecting station and said predetermined network in case it is possible to communicate with said connecting station via said short distance wireless communication means;
said standard station comprises:
short distance wireless communication means for performing communication to and from said wireless communication terminal located in the vicinity;
device identification information storage means for storing device identification information specific to each standard station; and
device identification information transmitting means for transmitting said device identification information of own station in case it is possible to perform communication to and from said wireless communication terminal via said short distance wireless communication means;
said connecting station comprises:
short distance wireless communication means for performing communication to and from said wireless communication terminal located in the vicinity;
a network interface connected to said predetermined network; and
intersecting history data transfer means for transferring said intersecting history data, received from said wireless communication terminal via said short distance wireless communication means, to said position estimation device via said network interface;
said position estimation device comprises:
a network interface connected to said predetermined network;
standard station position information storage means for storing standard station position information to indicate a position of installation of each of said standard stations;
intersecting history data receiving means for receiving said intersecting history data as transmitted from said wireless communication terminal via said network interface;
an intersecting history database for storing said intersecting history data received from each of a plurality of said wireless communication terminals; and
position estimation processing means for estimating position of any of said wireless communication terminal at an arbitrary time by using said intersecting history data stored in said intersecting history database.

4. The communication system according to claim 1, wherein said communication system comprises a plurality of said wireless communication terminals moving within said predetermined area, a plurality of standard stations fixedly installed within said predetermined area, wherein said wireless communication terminal comprises:
short distance wireless communication means for performing communication with another wireless communication terminal located in the vicinity and with said standard station;
standard station information receiving means for receiving position specifying information for specifying a position of said standard station from said standard station in case communication can be performed with said standard station via said short distance wireless communication means;
timing means for outputting the current time information;
intersecting history data memorizing means for memorizing an intersecting history data obtained by associating said position specifying information received at the standard station information receiving means with said timing information outputted from said timing means;
intersecting history data exchange means for transmitting said intersecting history data memorized in said intersecting history data memorizing means to said another wireless communication terminal and for receiving said intersecting history data of said another wireless communication terminal from said another wireless communication terminal; and
position estimation processing means for estimating a position where communication was performed with said another wireless communication terminal via said short distance wireless communication means by using said intersecting history data memorized in said intersecting history data memorizing means, said intersecting history data of said another wireless communication terminal received from said another wireless communication terminal and the current time information as outputted from said timing means;
said standard station comprises:
short distance wireless communication means for performing communication with said wireless communication terminal located in the vicinity;
position specifying information storage means for storing position specifying information to specify a position of said standard station; and
position specifying information transmitting means for transmitting said position specifying information stored in said position specifying information storage means to said wireless communication terminal in case communication can be performed to and from said wireless communication terminal via said short distance wireless communication means.

5. The communication system according to claim 1, wherein said communication system comprises a plurality of said wireless communication terminals moving within said predetermined area, a plurality of standard stations fixedly installed within said predetermined area, said wireless communication terminal comprises:
short distance wireless communication means for performing communication with another wireless communication terminal located in the vicinity and with said standard station;
standard station information receiving means for receiving position specifying information for specifying a position of said standard station from said standard station in case communication can be performed with said standard station via said short distance wireless communication means;
moving distance information output means for outputting moving distance information to give a moving distance of own terminal;
intersecting history data memorizing means for memorizing an intersecting history data obtained by associating said position specifying information as received by said standard station information receiving means with said moving distance information outputted from said moving distance information output means;
difference calculating means for calculating a difference between moving distance information at the current time moment as outputted from said moving distance information output means and said moving distance information of said intersecting history data as memorized in said intersecting history data memorizing means in case communication can be made with said another wireless communication terminal via said short distance wireless communication means by coming close to said another wireless communication terminal;
intersecting history data exchange means for transmitting said position specifying information of said intersecting history data as memorized in said intersecting history data memorizing means and said difference information calculated by said difference calculating means, and for receiving position specifying information of said another wireless communication terminal and the difference information from said another wireless communication terminal; and
position estimation processing means for estimating a position where communication has been performed to and from said another wireless communication terminal via said short distance wireless communication means by using said position specifying information of said intersecting history data memorized in said intersecting history data memorizing means and said difference information calculated by said difference calculating means, position specifying information and difference information of intersecting history data of said another wireless communication terminal as received from said another wireless communication terminal, and current moving distance information as outputted from said moving distance information output means;
said standard station comprises:
short distance wireless communication means for performing communication with said wireless communication terminal located in the vicinity;
position specifying information storage means for storing position specifying information to specify a position of said standard station; and
position specifying information transmitting means for transmitting said position specifying information stored in said position specifying information storage means to said wireless communication terminal in case communication can be performed to and from said wireless communication terminal via said short distance wireless communication means.

6. The communication system according to claim 1, wherein said communication system comprises a plurality of said wireless communication terminals moving within said predetermined area, a plurality of connecting stations located within said predetermined area and connected to a predetermined network, a communication relay device connected to said predetermined network, and a position estimation device connected to said predetermined network, wherein:
a wireless communication terminal of data transmission source to transmit a data packet to a wireless communication terminal of data transmission destination comprises:
short distance wireless communication means for performing communication to and from another wireless communication terminal and said connecting station located in the vicinity;
device identification information storage means for storing device identification information specific to each wireless communication terminal;
communication correspondent identification information storage means for storing device identification information of said wireless communication terminal of data transmission destination;
data packet generating means for generating said data packet to be sent to the wireless communication terminal of data transmission destination, and for adding the device identification information wireless communication terminal of data transmission destination to said data packet; and
data packet transmitting means for transmitting said data packet generated by said data packet generating means to said connecting station or said another wireless communication terminal, with which communication can be performed via said short distance wireless communication means;
a wireless communication terminal receiving said data packet from said wireless communication terminal of data transmission destination comprises:
short distance wireless communication means for performing communication to and from another wireless communication terminal and said connecting station located in the vicinity;
data packet holding means for temporarily holding said data packet; and
data packet transmitting means for transmitting said data packet as held by said data packet holding means to said connecting station in case communication can be performed to and from said connecting station via said short distance wireless communication means;
a connecting station receiving said data packet from said wireless communication terminal comprises:
short distance wireless communication means for performing communication to and from said wireless communication terminal located in the vicinity;
a network interface connected to said predetermined network; and
data packet transfer means for transferring said data packet received via said short distance wireless communication means to said communication relay device via said network interface;
said communication relay device comprises:
a network interface connected to said predetermined network;
device identification information extracting means for extracting device identification information of said wireless communication terminal of data transmission destination added to said data packet received from said connecting station;
position inquiring means for making inquiry on a position of said wireless communication terminal of data transmission destination by delivering the device identification information of said wireless communication terminal of data transmission destination to said position estimation device capable to estimate a position of a wireless communication terminal located within said predetermined area;
position estimation result receiving means for receiving estimation result of the current position of said wireless communication terminal of data transmission destination from said position management device as a response to said position inquiry by said position inquiring means; and
data packet transmitting means for transmitting said data packet to a connecting station estimated as located in the vicinity of said wireless communication terminal of data transmission destination as specified according to the result of position estimation on the current position of said wireless communication terminal of data transmission destination;
said position estimation device comprises:
information storage unit for holding information to estimate position information of each wireless communication terminal;
estimation means for estimating the current position of said wireless communication terminal of data transmission destination according to the information in said information storage unit in response to an inquiry of a position of said wireless communication terminal of data transmission destination from said communication relay device; and
position estimation result transmitting means for transmitting estimation result of the current position of said wireless communication terminal of data transmission destination to said communication relay device by said estimating means;
a connecting station receiving said data packet from said communication relay device comprises:
short distance wireless communication means for performing communication to and from said wireless communication terminal located in the vicinity;
a network interface connected to said predetermined network;
data packet transmitting means for transmitting said data packet received via said network interface to said wireless communication terminal capable to communicate via said short distance wireless communication means or to said wireless communication terminal of data transmission destination; and
a wireless communication terminal receiving said data packet from said connecting station comprises:
short distance wireless communication means for performing communication to and from another wireless communication terminal and said connecting station located in the vicinity;
data packet holding means for temporarily holding said data packet; and
data packet transmitting means for transmitting said data packet as held by said data packet holding means to said wireless communication terminal of data transmission destination in case communication can be made to and from said wireless communication terminal of data transmission destination via said short distance wireless communication means.

7. (canceled)

8. (canceled)

9. (canceled)

10. A wireless communication terminal moving within a predetermined area, wherein said wireless communication terminal comprises:
short distance wireless communication means for performing communication with another wireless communication terminal located in the vicinity, with a standard station fixedly installed within said predetermined area, and with a connecting station located within said predetermined area and connected to said predetermined network;
device identification information storage means for storing device identification information specific to each wireless communication terminal;
device identification information transmitting means for transmitting said device identification information of own terminal to said another wireless communication terminal in case communication can be performed with said another wireless communication terminal via said short distance wireless communication means;
device identification information receiving means for receiving said device identification information of said another wireless communication terminal or said standard station from said another wireless communication terminal in case communication can be performed with said another wireless communication terminal or said standard station via said short distance wireless communication means;
timing means for outputting the current time information;
intersecting history data memorizing means for memorizing an intersecting history data obtained by associating said device identification information of said another wireless communication terminal or said standard station as received via the device identification information receiving means with said time information as outputted from said timing means; and
intersecting history data transmitting means for transmitting said intersecting history data to said position estimation device via said connecting station and via said predetermined network in case communication can be performed with said connecting station via said short distance wireless communication means.

11. A wireless communication terminal moving within a predetermined area, wherein said wireless communication terminal comprises:
short distance wireless communication means for performing communication with another wireless communication terminal located in the vicinity, with a standard station fixedly installed within said predetermined area, and with a connecting station located within said predetermined area and connected to said predetermined network;
device identification information storage means for storing device identification information specific to each wireless communication terminal;
device identification information transmitting means for transmitting said device identification information of own terminal to said another wireless communication terminal in case communication can be performed with said another wireless communication terminal via said short distance wireless communication means;
device identification information receiving means for receiving said device identification information of said another wireless communication terminal or said standard station from said another wireless communication terminal in case communication can be performed with said another wireless communication terminal or said standard station via said short distance wireless communication means;
timing means for outputting the current time information;
moving distance information output means for outputting moving distance information to give a moving distance of own terminal;
intersecting history data memorizing means for memorizing an intersecting history data obtained by associating said device identification information of said another wireless communication terminal or said standard station as received via said device identification information receiving means with said timing information outputted from said moving distance information output means; and
intersecting history data transmitting means for transmitting said intersecting history data to said position estimation device via said connecting station and via said predetermined network in case communication can be performed with said connecting station via said short distance wireless communication means.

12. A wireless communication terminal moving within a predetermined area, wherein said wireless communication terminal comprises:
short distance wireless communication means for performing communication to and from another wireless communication terminal located in the vicinity and said standard station fixedly installed within said predetermined area;
standard station information receiving means for receiving position specifying information for specifying a position of said standard station in case communication can be performed with said standard station via said short distance wireless communication means;
timing means for outputting the current time information;
intersecting history data memorizing means for memorizing said information specifying information received via said standard station information receiving means by associating with said time information as outputted from said timing information;
intersecting history data exchange means for transmitting said intersecting history data memorized in said intersecting history data memorizing means to said another wireless communication terminal and for receiving intersecting history data of said another wireless communication terminal from said another wireless communication terminal when it comes close to said another wireless communication terminal and in case communication can be performed with said another wireless communication terminal via said short distance wireless communication means; and
position estimation processing means for estimating a position where communication was performed with said another wireless communication terminal via said short distance wireless communication means by using said intersecting history data memorized in the intersecting history data memorizing means, said intersecting history data of said another wireless communication terminal received from said another wireless communication terminal, and the current time information as outputted from said timing means.

13. (canceled)

14. A wireless communication terminal moving within a predetermined area, wherein said wireless communication terminal comprises:
short distance wireless communication means for performing communication with another wireless communication terminal located in the vicinity and with a standard station fixedly installed within said predetermined area;
standard station information receiving means for receiving position specifying information for specifying a position of said standard station in case communication can be performed to and from said standard station via said short distance wireless communication means;
moving distance information output means for outputting moving distance information to give a moving distance of own terminal;
intersecting history data memorizing means for memorizing said position specifying information received via the standard station information receiving means by associating with said moving distance information as outputted from said moving distance information output means;
difference calculating means for calculating a difference between a moving distance information at the present time point as outputted from said moving distance information output means and said moving distance information of said intersecting history data memorized in said intersecting history data memorizing means in case it comes close to said another wireless communication terminal and communication can be performed to and from said another wireless communication terminal via said short distance wireless communication means;
intersecting history data exchange means for transmitting said position specifying information of said intersecting history data memorized in said intersecting history data memorizing means and said difference information calculated by said difference calculating means to said another wireless communication terminal, and for receiving position specifying information of intersecting history of said another wireless communication terminal and difference information from said another wireless communication terminal; and
position estimation processing means for estimating a position where communication has been performed with said another wireless communication terminal via said short distance wireless communication means by using said position specifying information of said intersecting history data memorized by the intersecting history data memorizing means, by using position specifying information and difference information of intersecting history data of said another wireless communication terminal received from said another wireless communication terminal, and by using the current moving distance information as outputted from said moving distance information output means.

15. (canceled)

16. A wireless communication terminal of data transmission source for transmitting a data packet to a wireless communication terminal of data transmission destination in a communication system, which comprises a wireless communication terminal moving within a predetermined area, a plurality of connecting stations located within said predetermined area and connected to a predetermined network, a communication relay device connected to said predetermined network, and a position estimation device connected to said predetermined network, wherein said wireless communication comprises:
short distance communication means for performing communication to and from another wireless communication terminal and to and from said connecting station located in the vicinity;
device identification information storage means for storing device identification information specific to each wireless communication terminal;
correspondent identification information storage means for storing device identification information of said wireless communication terminal of data transmission destination;
data packet generating means for generating said data packet to be transmitted to said wireless communication terminal of data transmission destination, and for adding device identification information of said wireless communication terminal of data transmission destination to said data packet; and
data packet transmitting means for transmitting said data packet generated by said data packet generating means to said connecting stations or to said another wireless communication terminal communicable via said short distance wireless communication means.

17. (canceled)

18. A wireless communication terminal receiving a data packet from a wireless communication terminal of data transmission source to transmit the data packet to a wireless communication terminal of data transmission destination in a communication system, which comprises a wireless communication terminal moving within a predetermined area, a plurality of connecting stations located within said predetermined area and connected to a predetermined network, a communication relay device connected to said predetermined network, and a position estimation device connected to said predetermined network, wherein said wireless communication terminal comprises:
short distance wireless communication means for performing communication to and from another wireless communication terminal and said connecting station located in the vicinity;
data packet holding means for temporarily holding said data packet; and
data packet transmitting means for transmitting said data packet held by said data packet holding means to said connecting station in case communication can be performed to and from said connecting means via said short distance wireless communication means.

19. A wireless communication terminal receiving a data packet transmitted from a wireless communication terminal of data transmission source to a wireless communication terminal of data transmission destination in a communication system, which comprises a wireless communication terminal moving within a predetermined area, a plurality of connecting stations located within said predetermined area and connected to a predetermined network, a communication relay device connected to said predetermined network, and a position estimation device connected to said predetermined network, wherein said wireless communication terminal comprises:
short distance wireless communication means for performing communication to and from another wireless communication terminal located in the vicinity and to and from said connecting station;
data packet holding means for temporarily holding said data packet; and
data packet transmitting means for transmitting said data packet held by said data packet holding means to said wireless communication terminal of data transmission destination in case communication can be performed to and from said wireless communication terminal of data transmission destination via said short distance wireless communication means.

20. A position estimation device for estimating a position of a wireless communication terminal within a predetermined area at an arbitrary time, wherein said position estimation device comprises:
a network interface connected to a predetermined network;
standard station position information storage means for storing standard station position information to indicate a position of installation on each of the standard stations fixedly installed within said predetermined area;
intersecting history data receiving means for receiving an intersecting history data including device identification information received when said wireless communication terminal passes close by another wireless communication terminal or said standard station from said wireless communication terminal via said network interface;
an intersecting history database for storing said intersecting history data received from each of said plurality of wireless communication terminals; and
position estimation processing means for estimating a position of any one of said wireless communication terminals at an arbitrary time by using said intersecting history data stored in said intersecting history database.

21. (canceled)

22. (canceled)

23. (canceled)

24. (canceled)

25. A communication relay device for receiving a data packet transmitted by a wireless communication terminal of data transmission source to a wireless communication terminal of data transmission destination in a communication system, which comprises a wireless communication terminal moving within a predetermined area, a plurality of connecting stations located within said predetermined area and connected to a predetermined network, a communication relay device connected to said predetermined network, and a position estimation device connected to said predetermined network, wherein said communication relay device comprises:
a network interface connected to said predetermined network;
device identification information extracting means for extracting device identification information of said wireless communication terminal of data transmission destination added to said data packet received from said connecting station;
position inquiring means for inquiring a position of said wireless communication terminal of data transmission destination by delivering device identification information of said wireless communication terminal of data transmission destination to said position estimation device capable to estimate a position of the wireless communication terminal located within said predetermined area;
position estimation result receiving means for receiving a result of estimation of a current position of said wireless communication terminal of data transmission destination as a response to said position inquiry by said position inquiring means; and
data packet transmitting means for transmitting said data packet to a connecting station as estimated to be located in the vicinity of said wireless communication terminal of data transmission destination as specified according to the result of estimation of a current position of said wireless communication terminal of data transmission destination.

26. (canceled)

27. A connecting station, receiving a data packet transmitted by a wireless communication terminal of data transmission source to a wireless communication terminal of data transmission destination from said communication relay device in a communication system, which comprises a wireless communication terminal moving within a predetermined area, a plurality of connecting stations located within said predetermined area and connected to a predetermined network, a communication relay device connected to said predetermined network, and a position estimation device connected to said predetermined network, wherein said connecting station comprises:
short distance wireless communication means for performing communication to and from said wireless communication terminal located in the vicinity;
a network interface connected to said predetermined network; and
data packet transmitting means for transmitting said data packet received at said network interface to said wireless communication terminal capable to perform communication via said short distance wireless communication means or to said wireless communication terminal of data transmission destination.

28. (canceled)
